(19) United States
(12) Patent Application Publication
(10) Pub. No.: US 2026/0174148 A1
(43) Pub. Date: Jun. 25, 2026

(54) Heat Not Burn Vaporizer Devices

(71) Applicant: JUUL Labs, Inc., Washington, DC (US)

(72) Inventors: Ariel Atkins, San Francisco, CA (US); Christopher L. Belisle, Somerset, WI (US); Orville F. Buenaventura, San Bruno, CA (US); Brandon Cheung, San Francisco, CA (US); Steven Christensen, Burlingame, CA (US); Andrew S. Harmon, Tulsa, OK (US); Alexander M. Hoopai, San Francisco, CA (US); Eric Joseph Johnson, San Francisco, CA (US); Wayne A. Jordan, Castro Valley, CA (US); Jason King, San Francisco, CA (US); Justine M. Knight-Hawley, San Bruno, CA (US); Joshua A. Kurzman, San Francisco, CA (US); Esteban Leon Duque, Berkeley, CA (US); Kevin Lomeli, San Francisco, CA (US); Johnathan A. Marquez, San Francisco, CA (US); Andrew L. Murphy, San Francisco, CA (US); John R. Pelochino, Portland, OR (US); Jason G. Schray, San Francisco, CA (US); Val Valentine, San Francisco, CA (US); Eric Wu, San Francisco, CA (US); Wing W. Yee, San Francisco, CA (US)

(21) Appl. No.: 19/545,504

(22) Filed: Feb. 20, 2026

Related U.S. Application Data
(63) Continuation of application No. PCT/US24/43692, filed on Aug. 23, 2024.
(60) Provisional application No. 63/534,346, filed on Aug. 23, 2023.
(60) Provisional application No. 63/645,095, filed on May 9, 2024.
(60) Provisional application No. 63/661,527, filed on Jun. 18, 2024.
(60) Provisional application No. 63/684,831, filed on Aug. 19, 2024.

(51) Int. Cl. A24F 40/465; A24D 1/02; A24D 1/20; A24F 40/20; A24F 40/70; H05B 6/10

(52) U.S. Cl. CPC A24F 40/465; A24D 1/027; A24D 1/20; A24F 40/20; A24F 40/70; H05B 6/10

(57) ABSTRACT

Heating elements, cartridges for use with a vaporizer device, vaporizer devices for generating an inhalable aerosol, and methods of manufacturing thereof, are provided. The heating element can include a substrate configured to heat a vaporizable material. The substrate can include a first region, a second region, and a third region. The third region can be disposed between the first region and the second region, and the third region can include a first plurality of break structures configured to direct a thermal path, an electric current path, or both across the third region in a predetermined direction. Vaporizer cartridges and devices and methods of manufacturing thereof are also provided.

### CROSS REFERENCE TO RELATED APPLICATIONS

This application is related to U.S. Provisional Application No. 63/534,346 filed Aug. 23, 2023 and entitled “HEAT NOT BURN VAPORIZER DEVICES,”, to U.S. Provisional Application No. 63/645,095 filed May 9, 2024 and entitled “HEAT NOT BURN VAPORIZER DEVICES,” to U.S. Provisional Application No. 63/661,527 filed Jun. 18, 2024 and entitled “HEAT NOT BURN VAPORIZER DEVICES. ,” and to U.S. Provisional Application No. 63/684,831 filed on Aug, 19, 2024 and entitled “HEAT NOT BURN VAPORIZER DEVICES.” The disclosures of the foregoing applications are incorporated herein by reference in their entirety.

### TECHNICAL FIELD

The subject matter described herein relates to vaporizer devices, including vaporizer devices comprising a vaporizer body configured to heat a cartridge containing vaporizable material.

### BACKGROUND

Vaporizer devices, which can also be referred to as vaporizers, electronic vaporizer devices, or e-vaporizer devices, can be used for delivery of an aerosol (for example, a gas-phase and/or a condensed-phase material suspended in a stationary or moving mass of air or some other gas carrier) containing one or more active ingredients by inhalation of the aerosol by a user of the vaporizer device. For example, electronic nicotine delivery systems (ENDS) include a class of vaporizer devices that are battery powered and that can be used to simulate the experience of smoking, but without burning of tobacco or other substances. Vaporizer devices are gaining increasing popularity both for prescriptive medical use, in delivering medicaments, and for consumption of tobacco, nicotine, and other plant-based materials. Vaporizer devices can be portable, self-contained, and/or convenient for use.

In use of a vaporizer device, the user inhales an aerosol, colloquially referred to as “vapor,” which can be generated by a heating element that vaporizes (e.g., causes a liquid or solid to at least partially transition to the gas phase) a vaporizable material, which can be liquid, a solution, a solid, a paste, a wax, and/or any other form compatible for use with a specific vaporizer device. The vaporizable material used with a vaporizer device can be provided within a cartridge (e.g., a separable part of the vaporizer device that contains vaporizable material) that includes an outlet (e.g., a mouthpiece or an outlet in fluid communication with a mouthpiece) for inhalation of the aerosol by a user.

To receive an inhalable aerosol generated by a vaporizer device, a user can, in certain examples, activate the vaporizer device by taking a puff, by pressing a button, and/or by some other approach. A puff as used herein can refer to inhalation by the user in a manner that causes a volume of air to be drawn into the vaporizer device such that the inhalable aerosol is generated by a combination of vaporized material (e.g., gas-phase material) with the volume of air.

An approach by which a vaporizer device generates an inhalable aerosol from a vaporizable material involves heating the vaporizable material (e.g., within a cartridge, an insert, a vaporization chamber, a heater chamber, an oven, and/or a compartment associated with a heating element) to cause at least a portion of the vaporizable material to be converted to vaporized material (e.g., gas-phase material). A vaporization chamber, heater chamber, oven, or the like can refer to an area or volume in the vaporizer device within which a heat source (for example, a conductive, convective, and/or radiative heat source) causes heating of a vaporizable material to produce a vaporized material and allow the vaporized material to mix with air to form an aerosol for inhalation by a user of the vaporizer device.

Vaporizer devices can be controlled by one or more controllers, electronic circuits (for example, sensors, heating elements, buttons, switches), and/or the like on or in the vaporizer device. Vaporizer devices can also wirelessly communicate with an external controller (e.g., a computing device such as a personal computer or smartphone).

In some implementations, cartridges that contain solid vaporizable material (e.g., comprising plant material such as tobacco leaves and/or parts of tobacco leaves) must be heated to undesirably high temperatures in order to cause inner regions of the vaporizable material to be heated to a minimum temperature required for vaporization. As a result, portions of the solid vaporizable material contained within a cartridge can burn or char at these high temperatures and produce combustion or partial combustion byproducts (e.g., chemical elements or chemical compounds) that can have undesirable characteristics, such as unpleasant smells or tastes, negative health impacts, etc. Furthermore, uniform heating of the vaporizable material in current conduction-based vaporizers may be difficult to achieve due to the low thermal conductivity of certain vaporizable materials (e.g., plant materials, such as tobacco). Accordingly, controlled and even distribution of heat is desirable in such devices.

Some issues with current vaporizer devices include the inability to efficiently and effectively heat the vaporizable material without wasting a significant amount of energy. For example, some vaporizer devices include a heater body surrounding a tobacco consumable, requiring the entire heater body to be heated to create an oven. Such a configuration requires additional energy to maintain a sufficiently high temperature in an area that is exposed to the airstream, thereby losing at least a portion of thermal energy produced by the heater that could have been used to heat the tobacco material. As such, energy can be wasted as the generated heat is not effectively utilized.

Vaporizer devices configured to embed some or part of a heater apparatus inside of the tobacco material can include airflow passing through the tobacco material thereby prohibiting tight tobacco compaction around the heater, thus diminishing heat transfer from the heater to the tobacco material. Furthermore, vaporizer devices with a heater element embedded within or at least partially surrounded by the tobacco can also experience cleaning and hygiene issues. For example, as the heater pierces the tobacco, residue can be left on the heater element after use, thereby requiring the user to clean the heater element before continued use.

### SUMMARY

Aspects of the current subject matter relate to vaporizer devices including various implementation of a vaporizer body and/or cartridge of vaporizable material configured to generate an inhalable aerosol. For purposes of summarizing, certain aspects, advantages, and novel features have been described herein. It is to be understood that not all such advantages can be achieved in accordance with any one particular implementation. Thus, the disclosed subject matter can be implemented, embodied, or carried out in a manner that achieves or optimizes one advantage or group of advantages without achieving all advantages as taught or suggested herein. The various features and items described herein can be incorporated together or separable, except as would not be feasible based on the current disclosure and what a skilled artisan would understand from it.

In various implementations, a vaporizer device, vaporizer body, and/or cartridge can include the vaporizer devices, vaporizer bodies, and/or cartridges described herein. Further, a vaporizer device and/or a cartridge can include the heating elements described herein. In particular, various implementations are provided in the independent claims that follow, with various aspects defined in the dependent claims.

In various implementations, a heating element is disclosed. The heating element includes a substrate configured to heat a vaporizable material, the substrate includes a first region, a second region, and a third region disposed between the first region and the second region, wherein the third region comprises a first plurality of break structures configured to direct a thermal path, an electric current path, or both across the third region in a predetermined direction.

In some implementations, the first plurality of break structures can include one or more cuts. In certain implementations, at least one cut of the one or more cuts can extend completely through the substrate. In other implementations, at least one cut of the one or more cuts can extend partially through the substrate.

In some implementations, the substrate can include a first longitudinal end and an opposing, second longitudinal end and a first lateral end and an opposing, second lateral end. Each of the first plurality of break structures can at least partially extend between the first longitudinal end and the second longitudinal end of the substrate.

In some implementations, a first break structure of the first plurality of break structures includes a first end, an opposing, second end and a first length extending from the first end to the second end. A second break structure of the first plurality of break structures includes a third end and a fourth, opposing end and a second length extending therebetween, the second length being different than the first length.

In some implementations, a first break structure of the first plurality of break structures includes a first end, an opposing, second end and a first length extending from the first end to the second end. A second break structure of the first plurality of break structures includes a third end and a fourth end and a second length extending therebetween, the second length is equal to the first length.

In some implementations, at least one break structure of the first plurality of break structures can be 180 degrees when the substrate is in a flat configuration.

In some implementations, at least one break structure of the first plurality of break structures can be a curved shape when the substrate is in a flat configuration.

In some implementations, at least one break structure of the first plurality of break structures can extend in a direction that is nonparallel with a longitudinal axis of the substrate, the longitudinal axis extending from the first lateral end to the second lateral end.

In some implementations, at least one break structure of the first plurality of break structures can extend in a direction that is parallel with a longitudinal axis of the substrate, the longitudinal axis extending from the first lateral end to the second lateral end.

In some implementations, at least one break structure of the first plurality of break structures can extend at an angle when the substrate is in a flat configuration.

In some implementations, the first plurality of break structures can be arranged in a chevron pattern.

In some implementations, at least one break structure of the first plurality of break structures can be a polygram. Further, the polygram can be a triangle.

In some implementations, the first plurality of break structures can be arranged in a plurality of rows.

In some implementations, the plurality of rows includes a first row and a second row positioned adjacent to and offset from each other. In some certain implementations, the first row, the second row, or both can extend in a direction that is nonparallel with a longitudinal axis of the substrate, the longitudinal axis extending from a first lateral end to a second lateral end of the substrate. In other implementations, the first row, the second row, or both can extend in a direction that is parallel with a longitudinal axis of the substrate, the longitudinal axis extending from a first lateral end to a second lateral end of the substrate.

In some implementations, each row of the plurality of rows can be equally spaced apart from a respective adjacent row of the plurality of rows. In other implementations, each row of the plurality of rows cannot be equally spaced apart from a respective adjacent row of the plurality of rows.

In some implementations, the heating element can include a second plurality of break structures. Each of the second plurality of break structures can at least partially extend between the first longitudinal end and the second longitudinal end of the substrate.

In some implementations, the first plurality of break structures can be different than the second plurality of break structures. In some certain implementations, the first region can have the second plurality of break structures. In other implementations, the third region can have the first plurality of break structures and the second plurality of break structures.

In some implementations, the second plurality of break structures can have one or more cuts laterally aligned with each other relative to a longitudinal axis of the substrate, the longitudinal axis extending from a first lateral end to a second lateral end of the substrate.

In some implementations, the first plurality of break structures can include cuts having an oblong shape.

In some implementations, the first plurality of break structures can be the same as the second plurality of break structures.

In some implementations, the heating element can include a channel between the first plurality of break structures and the second plurality of break structures.

In some implementations, the heating element can include a third plurality of break structures. Each of the third plurality of break structures can at least partially extend between the first longitudinal end and the second longitudinal end of the substrate.

In some implementations, the second region can include the third plurality of break structures.

In some implementations, the substrate can be configured to generate heat via eddy currents.

In some implementations, the substrate can include one or more metals. One or more metals can include gold, chrome, aluminum, silver, nickel, copper, or any combination thereof.

In some implementations, the first region, the second region, or both may not comprise the first plurality of break structures, the second plurality of break structures, or both.

In some implementations, a first portion of the heating element proximate the first longitudinal end of the heating element can at least partially overlap with a second portion of the heating element proximate the second longitudinal end of the heating element.

In some implementations, the first portion can be on an exterior face of the heating element and the second portion can be on an interior face of the heating element.

In some implementations, the first portion and the second portion can be on an interior face of the heating element.

In some implementations, the first portion and the second portion can be connected.

In some implementations, the first portion and the second portion can be welded together, glued together, crimped together, interlocked together, pressed together, knurled, and/or folded over one another.

In some implementations, the substrate can have a tubular configuration.

In some implementations, the substrate can have an oblong configuration.

In various implementations, a cartridge for use with a vaporizer device for generating an inhalable aerosol is disclosed. The cartridge includes a heating as previously described herein. The cartridge includes a wrapper holding a vaporizable material disposed therein. The wrapper includes an inner surface facing the vaporizable material and an outer surface. The cartridge includes at least one airflow inlet configured to allow external air to enter the wrapper and entrain the vapor and at least one airflow outlet in fluid communication with the at least one airflow inlet and configured to allow egress of aerosol from the wrapper for inhalation by a user.

In some implementations, the cartridge can include a vaporizable material contained within the heating element. The heating element can include a sheet wrapped around the vaporizable material. The heating element can be disposed between the inner surface of the wrapper and the vaporizable material.

In some implementations, the heating element can wrap at least partially around the outer surface of the wrapper.

In some implementations, the cartridge can include an adhesive disposed at least between the heating element and the wrapper.

In some implementations, the cartridge can have an oblong configuration.

In some implementations, the wrapper can include paper.

In some implementations, the cartridge can include a divider having a first surface and an opposing, second surface. The divider can include a divider body extending between the first and second surfaces of the divider.

In some implementations, the cartridge can include one or more inserts.

In some implementations, the cartridge can include one or more bypass air inlets.

In some implementations, the heating element can be printed onto at least a portion of the wrapper.

In various implementations, a vaporizer device for generating an inhalable aerosol is disclosed. The cartridge includes a cartridge as previously described herein and a vaporizer body configured to receive at least a portion of the cartridge. The vaporizer body includes a heater configured to heat the heating element.

In some implementations, the heater can include at least one inductor configured to generate a magnetic and/or electromagnetic field.

In some implementations, the vaporizer device can include a flux concentrator configured to direct the magnetic and/or electromagnetic field toward the vaporizable material.

In some implementations, the at least one inductor can include a first inductor and a second inductor.

In some implementations, the first inductor and the second inductor can be inductive coils.

In some implementations, the vaporizer body can include one or more sensors configured to detect an external magnetic field relative to the vaporizer device.

In some implementations, the vaporizer device can include a receptacle configured to insertably receive at least a portion of the cartridge.

In various implementations, a method for creating a heating element for use in a vaporizer device is disclosed. The method includes cutting a substrate across a central region between a first longitudinal end and a second longitudinal end to create a plurality of break structures. The plurality of break structures is configured to direct a thermal path, an electric current path, or both across the central region in a predetermined direction. The method includes attaching the first longitudinal end to the second longitudinal end to create the heating element.

In some implementations, the method can include forming a substrate. Forming the substrate can include applying a metal layer to a base substrate.

In some implementations, the method can include printing one or more metals onto one or more portions of the substrate.

In some implementations, attaching the first longitudinal end to the second longitudinal end can include gluing the first longitudinal end of the substrate to the second longitudinal end of the substrate.

In some implementations, attaching the first longitudinal end to the second longitudinal end can include welding the first longitudinal end of the substrate to the second longitudinal end of the substrate.

In some implementations, attaching the first longitudinal end to the second longitudinal end can include welding the first longitudinal end of the substrate to the second longitudinal end of the substrate and folding and gluing the welded first longitudinal end and second longitudinal end of the substrate toward and onto an exterior surface of the heating element.

In some implementations, attaching the first longitudinal end to the second longitudinal end can form a loop.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. The patent or application file contains at least one drawing executed in color. Copies of this patent or patent application with color drawing(s) will be provided by the Office upon request and payment of the necessary fee. In the drawings:

FIG. 1A illustrates a block diagram of a vaporizer device, consistent with implementations of the current subject matter;

FIG. 1B illustrates a block diagram of a vaporizer device, consistent with implementations of the current subject matter;

FIG. 1C illustrates a block diagram of a vaporizer device, consistent with implementations of the current subject matter;

FIG. 2 illustrates a front perspective view of an implementation of a vaporizer device, consistent with implementations of the current subject matter;

FIG. 3 illustrates a front perspective exploded view of an implementation of a cartridge for use with a vaporizer device, consistent with implementations of the current subject matter;

FIG. 4A illustrates a cross-sectional view of a vaporizer device, consistent with implementations of the current subject matter;

FIG. 4B illustrates a front cross-sectional view of the vaporizer device of FIG. 4A, consistent with implementations of the current subject matter;

FIG. 5A illustrates a perspective view of a holder assembly for use in a vaporizer device, consistent with implementations of the current subject matter;

FIG. 5B illustrates a perspective view of a holder assembly for use in a vaporizer device, consistent with implementations of the current subject matter;

FIG. 5C illustrates a perspective view of a holder assembly for use in a vaporizer device, consistent with implementations of the current subject matter;

FIG. 5D illustrates a perspective view of a holder assembly for use in a vaporizer device, consistent with implementations of the current subject matter;

FIG. 6A illustrates an exemplary cross-section of a cartridge and/or receptacle of a vaporizer device, consistent with implementations of the current subject matter;

FIG. 6B illustrates an exemplary cross-section of a cartridge and/or receptacle of a vaporizer device, consistent with implementations of the current subject matter;

FIG. 6C illustrates an exemplary cross-section of a cartridge and/or receptacle of a vaporizer device, consistent with implementations of the current subject matter;

FIG. 6D illustrates an exemplary cross-section of a cartridge and/or receptacle of a vaporizer device, consistent with implementations of the current subject matter;

FIG. 6E illustrates an exemplary cross-section of a cartridge and/or receptacle of a vaporizer device, consistent with implementations of the current subject matter;

FIG. 6F illustrates an exemplary cross-section of a cartridge and/or receptacle of a vaporizer device, consistent with implementations of the current subject matter;

FIG. 7A illustrates and exemplary perspective view of a cartridge for use in a vaporizer device, consistent with implementations of the current subject matter;

FIG. 7B illustrates and exemplary transparent perspective view of the cartridge from FIG. 7A, consistent with implementations of the current subject matter;

FIG. 7C illustrates a perspective view of a cartridge for use in a vaporizer device, consistent with implementations of the current subject matter;

FIG. 7D illustrates a perspective view of a cartridge for use in a vaporizer device, consistent with implementations of the current subject matter;

FIG. 8A illustrates a schematic of an exemplary heating element for use in a vaporizer device, consistent with implementations of the current subject matter;

FIG. 8B illustrates a rolled configuration of the heating element of FIG. 8A, consistent with implementations of the current subject matter;

FIG. 9A illustrates a schematic of an exemplary heating element for use in a vaporizer device, consistent with implementations of the current subject matter;

FIG. 9B illustrates a rolled configuration of the heating element of FIG. 9A, consistent with implementations of the current subject matter;

FIG. 10A illustrates a schematic of an exemplary heating element for use in a vaporizer device, consistent with implementations of the current subject matter;

FIG. 10B illustrates a schematic of an exemplary heating element for use in a vaporizer device, consistent with implementations of the current subject matter;

FIG. 10C illustrates a schematic of an exemplary heating element for use in a vaporizer device, consistent with implementations of the current subject matter;

FIG. 10D illustrates a schematic of an exemplary heating element for use in a vaporizer device, consistent with implementations of the current subject matter;

FIG. 10E illustrates a schematic of an exemplary heating element for use in a vaporizer device, consistent with implementations of the current subject matter;

FIG. 10F illustrates a schematic of an exemplary heating element for use in a vaporizer device, consistent with implementations of the current subject matter;

FIG. 10G illustrates a schematic of an exemplary heating element for use in a vaporizer device, consistent with implementations of the current subject matter;

FIG. 10H illustrates a schematic of an exemplary heating element for use in a vaporizer device, consistent with implementations of the current subject matter;

FIG. 10I illustrates a schematic of an exemplary heating element for use in a vaporizer device, consistent with implementations of the current subject matter;

FIG. 10J illustrates a schematic of an exemplary heating element for use in a vaporizer device, consistent with implementations of the current subject matter;

FIG. 10K illustrates a schematic of an exemplary heating element for use in a vaporizer device, consistent with implementations of the current subject matter;

FIG. 10L illustrates a schematic of an exemplary heating element for use in a vaporizer device, consistent with implementations of the current subject matter;

FIG. 10M illustrates a schematic of an exemplary heating element for use in a vaporizer device, consistent with implementations of the current subject matter;

FIG. 10N illustrates a schematic of an exemplary heating element for use in a vaporizer device, consistent with implementations of the current subject matter;

FIG. 10O illustrates a rolled configuration of the heating element of FIG. 10N, consistent with implementations of the current subject matter;

FIG. 11 illustrates a perspective view of a cartridge for use in a vaporizer device, consistent with implementations of the current subject matter;

FIG. 12A illustrates a perspective view of a vaporizer device, consistent with implementations of the current subject matter;

FIG. 12B illustrates a cross-section view of the vaporizer device of FIG. 12A;

FIG. 12C illustrates an exploded perspective view of the vaporizer device of FIG. 12B; and

FIG. 12D illustrates a perspective view of a heating element of the vaporizer device of FIG. 12A, consistent with implementations of the current subject matter.

When practical, similar reference numbers denote similar structures, features, or elements.

### DETAILED DESCRIPTION

Implementations of the current subject matter include methods, apparatuses, articles of manufacture, and systems relating to vaporization of one or more materials for inhalation by a user. For example, various implementations of vaporizer devices are described herein that provide a number of benefits, including improved generation of controlled energy transfer to inductively heated cartridges. For example, by providing multiple inductors, a singular wrapped susceptor, and/or feedback loops with sensors, localized heat transfer can be controlled over the course of use (e.g., each complete use of a cartridge, from start to finish, referred to herein a vaporizing session).

An additional benefit that can be provided by various implementations of vaporizer devices described herein is improving contact between a heating element and/or heated surface of a heating system and a cartridge containing vaporizable material to ensure efficient and effective thermal transfer between the heating element and vaporizable material. For example, by maintaining intimate contact between the cartridge and the heating element and/or heated surface, thermal losses (e.g., to a surrounding housing of the vaporizer device) can be reduced, and heating efficiency (e.g., per amount of power consumption) can be increased. An additional benefit that can be provided by various implementations of vaporizer devices described herein is increased user satisfaction. For example, in some implementations, the proper mixing of relatively cool air (e.g., ambient temperature air) and heated air containing vaporized material can improve the formation of sub-micron sized aerosol particles, thereby reducing condensation of one or more compounds released during heating of the vaporized material onto internal surfaces (e.g., inhalation tubes and/or mouthpiece components) of the vaporizer device. Such condensates can ultimately be drawn into the mouth of a user in liquid form, thereby leading to unpleasant taste sensations, and are not available for inhalation, thereby reducing an amount of available inhalable product. Accordingly, by ensuring proper mixing and aerosol generation, implementations of the current subject matter can increase user satisfaction.

In some implementations, the vaporizable material can be placed within a location that is in direct contact with and/or in close proximity to a heating element of a heating system to allow for efficient and effective heat transfer from the heating element to the vaporizable material. In some implementations, a cartridge comprising the heating element and the vaporizable material (e.g., vaporizable material contained within an appropriately configured structure) can be placed within a vaporizer body that is configured to transfer energy to the heating element, such as by one or more inductors and/or completion of an electrical circuit that includes the heating element. In other implementations, a cartridge comprising the vaporizable material (e.g., vaporizable material contained within an appropriately configured structure) can be placed within a vaporization chamber, heater chamber, oven, or the like, in which case the area or volume in the vaporizer body within which a heating element causes heating of at least a portion of a vaporizable material includes an internal area or volume of the cartridge. Characteristics of an appropriately configured structure include being formed at least partially of metal and/or some other material that is durable under heating and that has a sufficient thermal conductivity, one or more openings through which air can enter the cartridge to aid in heating the vaporizable material and/or transfer of the vaporizable material as it is vaporized, one or more openings through which ambient air mixes with the vaporized material to form at least a portion of an inhalable aerosol, conveyance of the inhalable aerosol out of the cartridge, and/or the like. As such, the vaporizer devices, heating systems, cartridges, and vaporizable material described herein can provide more efficient heating of vaporizable material and formation of inhalable aerosol compared to some currently available vaporizer devices. Other benefits are described herein and are within the scope of this disclosure. It will be appreciated that aerosol formation can occur concurrently with (e.g., immediately after) vaporization of the vaporizable material, such as based on air that is present within or near the vaporizable material, and that the provision of ambient air can accelerate the formation of the inhalable aerosol.

The term “vaporizer device” as used in the following description and claims refers to any of a self-contained apparatus, an apparatus that includes two or more separable parts (e.g., a vaporizer body that includes a battery and other hardware, a cartridge and/or insert that includes a vaporizable material, and/or a mouthpiece (including a mouthpiece portion of the cartridge) configured to deliver an inhalable aerosol to a user), and/or the like. A “vaporizer system,” as used herein, can include one or more components, such as a vaporizer device, a charger for charging the vaporizer device, a wired or wireless communication device in communication with the vaporizer device, a remote server in communication with the communication device, and/or the like. Examples of vaporizer devices consistent with implementations of the current subject matter include electronic vaporizers, electronic nicotine delivery systems (ENDS), and/or the like. Such vaporizer devices can be hand-held devices that heat (such as by convection, conduction, radiation, induction, and/or some combination thereof) a vaporizable material to provide an inhalable dose of the material to a user. Vaporizer devices can be regarded as “generating” inhalable aerosols, as they provide the capabilities and/or functionality required to convert vaporizable material into inhalable aerosols (e.g., heat, airflow path(s), condensation chambers, etc.).

The vaporizable material used with a vaporizer device can optionally be provided within a cartridge (e.g., an insertable and removable part of the vaporizer device that contains the vaporizable material) which can be refillable when empty, or disposable such that a new cartridge containing additional vaporizable material of a same or different type can be used. A vaporizer device can be a cartridge-using vaporizer device, a cartridge-less vaporizer device, or a multi-use vaporizer device capable of use with or without a cartridge. Some cartridge implementations can include a vaporizable material, which can be packed to an appropriate density, as described herein. In some implementations, a vaporizer device can include a compartment (e.g., a receptacle, heater chamber, and/or the like) configured to receive a cartridge directly therein and heat the vaporizable material for forming an inhalable aerosol.

In some implementations, a vaporizer device can be configured for use with a liquid vaporizable material (for example, a carrier solution in which an active and/or inactive ingredient(s) are suspended or held in solution, or a liquid form of the vaporizable material itself) and/or a non-liquid vaporizable material (e.g., a paste, a wax, a gel, a solid, a plant material, and/or the like). A non-liquid vaporizable material can include a plant material that emits some part of the plant material as the vaporizable material (for example, some part of the plant material remains as waste after the material is vaporized for inhalation by a user) or optionally can be a solid form of the vaporizable material itself, such that all of the solid material can eventually be vaporized for inhalation. A liquid vaporizable material can likewise be capable of being completely vaporized, or can include some portion of the liquid material that remains after all of the material suitable for inhalation has been vaporized.

Implementations of vaporizable material can be partially made of a non-liquid vaporizable material, such as tobacco (e.g., leaves, stems, and/or the like), other plant substances, and/or other solids such as cotton. In such implementations, the vaporizable material further includes a humectant or other aerosol forming material or carrier, such as propylene glycol, vegetable glycerin, an acid (e.g., organic acid such as benzoic acid, citric acid, etc.), and/or the like. As such, some implementations of the vaporizer device can be configured to use a vaporizable material that is at least partly made of one or more vaporizable materials (e.g., that includes one or more compounds that can be converted to the gas phase when the vaporizable material is heated to a sufficient temperature) for heating and forming an inhalable aerosol, as described in greater detail herein.

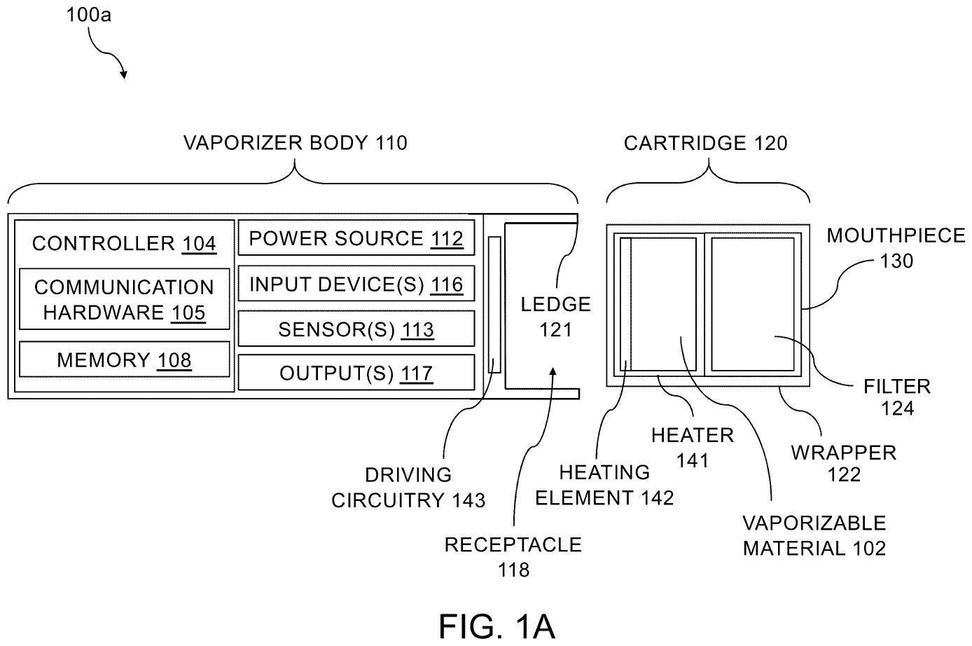

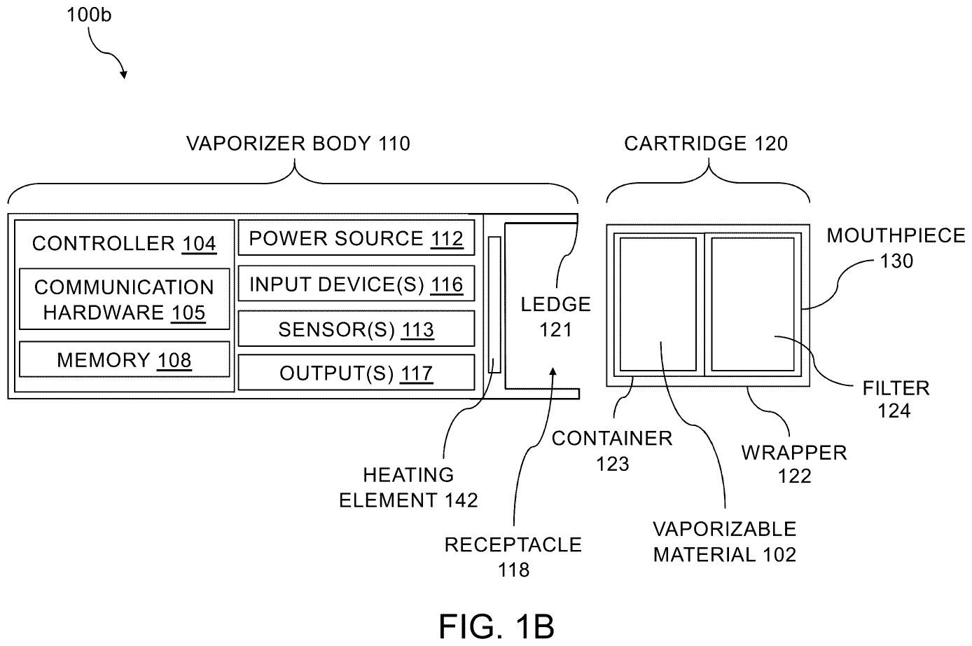

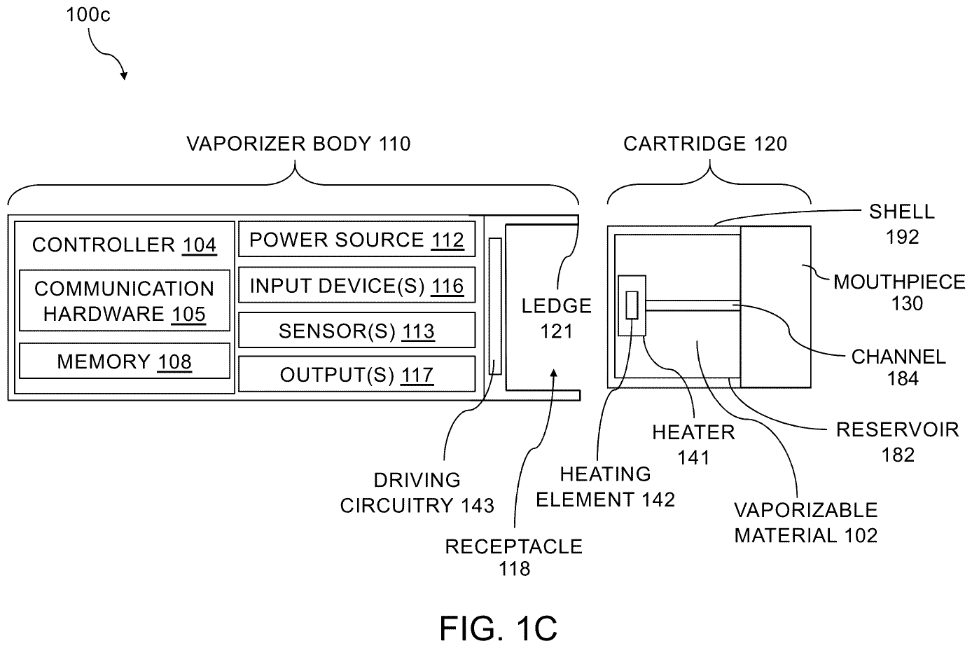

FIGS. 1A-1C depict block diagrams illustrating example vaporizer devices 100a, 100b, 100c (collectively referred to as vaporizer device 100) consistent with implementations of the current subject matter. The vaporizer device 100 can include a power source 112 (for example, a battery, which can be a rechargeable battery), and a controller 104 (for example, a processor, circuitry, etc. capable of executing logic) for controlling delivery of heat from one or more heating elements 142 (collectively referred to as heating element 142) to cause at least a portion of the vaporizable material 102 (such as a solid, a liquid, a solution, a suspension, a part of an at least partially unprocessed plant material, etc.) of a cartridge 120 to be converted to the gas-phase. The controller 104 can be part of one or more printed circuit boards (PCBs) consistent with certain implementations of the current subject matter.

After conversion of some amount of one or more compounds present in the vaporizable material 102 to the gas phase, at least some of those gas-phase compounds can condense to form particulate matter in at least a partial local equilibrium with the gas phase as part of an aerosol, which can form some or all of an inhalable dose provided by the vaporizer device 100 during a user's puff or draw on the vaporizer device 100. It should be appreciated that the interplay between gas and condensed phases in an aerosol generated by a vaporizer device 100 can be complex and dynamic, due to factors such as temperature (e.g., ambient or local at various points within the vaporizer device and/or cartridge), relative humidity, chemistry, vapor pressure of one or more vaporizable compounds, flow conditions in airflow paths (both inside the vaporizer device 100 and in the airways of a human or other animal), and/or mixing of the one or more compounds in the gas phase or in the aerosol phase with other air streams, which can affect one or more physical parameters of an aerosol. In some vaporizer devices, and particularly for vaporizer devices configured for delivery of relatively volatile compounds, the inhalable dose can exist predominantly in the gas phase (for example, formation of condensed phase particles can be very limited).

The heating element 142 can include one or more of a conductive heater, a radiative heater, inductive heater, and/or a convective heater. One type of heating element 142 is a resistive heating element, which can include a material (such as a metal or alloy, for example a nickel-chromium alloy, or a non-metallic resistor) configured to dissipate electrical power in the form of heat when electrical current is passed through one or more resistive segments of the resistive heating element. Another type of heating element 142 is a susceptor, which can include a material (such as a metal or alloy, for example an aluminum alloy and/or a ferritic material such as a stainless steel alloy) configured to absorb and convert energy into heat when magnetic and/or electromagnetic energy is radiated into one or more segments of the susceptor. In various implementations of the current subject matter, the heating element 142 (e.g., a resistive heating element, a susceptor, and/or the like) is configured to generate heat for converting, to the gas phase, one or more compounds present in the vaporizable material 102 to generate an inhalable dose of the one or more compounds present in the vaporizable material 102. As described herein, in some implementations, the vaporizable material 102 includes a non-liquid vaporizable material including, for example, a solid-phase material (such as a gel, a wax, or the like) or plant material (e.g., tobacco leaves and/or tobacco stems).

In some implementations, the heating element 142 can be a part of the cartridge 120 (e.g., part of the disposable part of the vaporizer 100), as shown in the vaporizer device 100a of FIG. 1A. As illustrated, the cartridge 120 can include a mouthpiece portion 130 that includes one or more inserts 124 (e.g., one or more filters, such as illustrated by way of an example implementation of the insert 124 in FIGS. 1A and 1B) and a heater portion 141 that includes vaporizable material 102 and one or more heating elements 142. In some implementations, the mouthpiece portion 130 can be releasably coupled to a part of the cartridge 120. In some implementations, the mouthpiece portion 130 can be integrated with the cartridge 120. In some implementations, the mouthpiece portion 130 can include one or more elements of the cartridge 120 (e.g., airflow pathway, insert, end cap, vaporizable material, etc.), such as described herein.

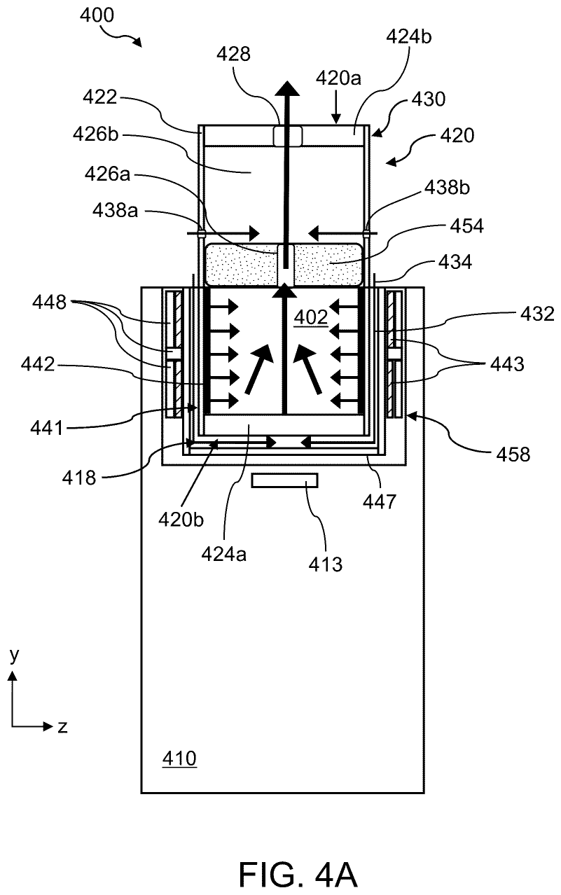

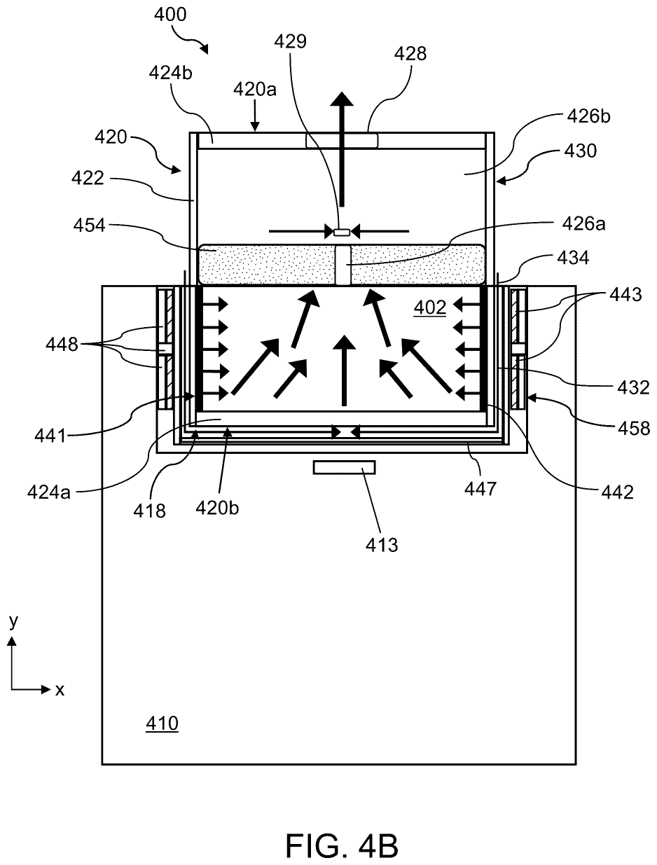

In some implementations, the cartridge 120 can include one or more inserts 124, and each insert 124 can include one or more filters and/or filter material. For example, the one or more inserts 124 can be made of material that is one or both of non-vapor permeable and moisture-resistant (e.g., resists damaging effects of water, at least to some extent). Such material can include one or more of metal, metal alloy, cotton, paper material such as cardstock, corrugated material such as cardboard or paper, tobacco paper, temperature-resistant plastic such as polyethylene terephthalate (PET), cellulose acetate, non-wood plant fibers such as flax, hemp, sisal, rice straw, and/or esparto, and/or the like. In some implementations, at least a part of the insert 124 can be inserted into and/or surrounded by one or more elements, including one or more elements associated with the cartridge 120 and/or vaporizer body 110. For example, one or more inserts 124 can be positioned adjacent to, in contact with, and/or offset (e.g., along the length or longitudinal axis) from one or more of a divider (e.g., dividers 454 in FIG. 4A-4B) a first end of the cartridge 120 (e.g., a distal or upstream end), a second end of the cartridge 120 (e.g., a proximal or downstream end), the vaporizable material 102, and/or the like, as described herein. In some implementations, at least a part of the insert 124 can be exposed (e.g., not inserted into or surrounded by one or more elements), including an entire length (as length is used and defined herein) of the insert 124 can be exposed. As used herein, an “end cap” can refer to at least one of a variety of materials and/or elements that are positioned adjacent an end of the cartridge 120, such as a first end or second end of the cartridge 120. In some implementations, the end cap can be positioned at an end of the cartridge 120. In some implementations, the end cap can be positioned offset (e.g., along the length of the cartridge 120) from an end of the cartridge 120, including not being a most distal or proximal element within an implementation of the cartridge 120. For example, the end cap can form a part of an outer surface of the cartridge 120 and/or the end cap can be fully contained within the outer surface of the cartridge 120.

In some implementations, the heater portion 141 can optionally include one or more inserts 124, such as at the end of the vaporizable material 102 (e.g., distal end of the cartridge 120) to help retain the vaporizable material 102 within the cartridge 120. The one or more inserts 124 can contain a plurality of openings, such as inlets, channels, and/or outlets. In some implementations, at least a portion of the one or more inserts 124 can be permeable, such that vapor and/or aerosol can pass through the inserts 124. In some implementations, the heater portion 141 can be releasably coupled to a part of the cartridge 120. In some implementations, the heater portion 141 can be integrated with the cartridge 120. In some implementations, the heater portion 141 can include one or more elements of the cartridge 120 (e.g., airflow pathway, insert, vaporizable material, etc.), such as described herein. In some implementations, the heater portion 141 can include more than one separable and/or releasably coupleable parts. For example, one part of the heating portion 141 can be integrated with the cartridge 120 and a second part of the heating portion 141 can be integrated with an element apart from and/or outside of the cartridge 120, such as integrated with the vaporizer body 110.

The mouthpiece portion 130 and the heater portion 141 can be joined together via an outer layer, such as one or more layers of material (e.g., wrappers 122, as shown by way of example in FIGS. 1A and 1B, shells, or other comparable structural material or materials). In some aspects, the heater portion 141 can be regarded as including at least a portion of the cartridge 120 that is insertably received in the receptacle 118 and the mouthpiece portion 130 can be regarded as at least some of a portion of the cartridge 120 that remains outside of the receptacle 118 when the cartridge 120 is insertably received in the receptacle 118. In some implementations, the receptacle 118 can be configured to insertably receive and couple to the cartridge 120 via a snap-fit, press-fit, friction fit, magnetic attachment, and/or the like. In some implementations, the vaporizer body 110 can include a ledge 121 that at least partially defines an opening into the receptacle 118. The ledge 121 can include features, such as a chamfered edge, that facilitate placement of the cartridge 120 into the receptacle 118. As the term is used herein, it is not required that the entirety of the mouthpiece portion 130 be designed for insertion into a user's mouth, only that the mouthpiece portion 130 is at or near the end of the cartridge 120 that is designed for the user to place into their mouth in use.

The heating element 142 can be wrapped around (at least in part), pressed into thermal contact with, or otherwise arranged to deliver heat to the vaporizable material 102 to cause release of one or more compounds into the gas phase. Within the vaporizer body, driving circuitry 143 (as shown in FIG. 1C) is provided for driving the heating element 142. For example, the driving circuitry 143 can include two or more electrical contacts (e.g., positioned at least partially within the receptacle 118) for providing an electrically conductive pathway between the power source 112 of the vaporizer body 110 and the heating element 142 of the cartridge 120, when the cartridge 120 is insertably received within the receptacle 118. In other implementations, the driving circuitry 143 can include one or more inductors, such as two or more inductive coils, configured to generate an electromagnetic field directed and positioned to affect the heating element 142, which can take the form of a susceptor, to cause the susceptor to generate heat.

In other implementations, the heating element 142 can be a part of the vaporizer body 110 (e.g., part of the durable or reusable part of the vaporizer 100), as shown in the vaporizer device 100b of FIG. 1B. As illustrated, the cartridge 120 can include a mouthpiece portion 130 that includes one or more inserts 124 and a container portion 123 that includes vaporizable material 102. The mouthpiece portion 130 and the container portion 123 can be joined together via an outer layer, such as one or more wrappers 122. The heating element 142 can be wrapped around (at least in part), pressed into thermal contact with, or otherwise arranged to deliver heat to the cartridge 120 containing the vaporizable material 102 to convert the one or more compounds from the vaporizable material 102 to the gas phase for subsequent inhalation by a user in a gas-phase and/or a condensed (for example, aerosol particles or droplets) phase. For example the heating element 142 can be positioned within the receptacle 118 and disposed to directly or indirectly heat the container portion 123 (e.g., by conductive, radiative, or convective heating), which in turn can heat the vaporizable material 102 contained therein. In related implementations, the heating element 142 can be positioned outside of the receptacle 118 and disposed to heat the receptacle 118 itself, so as to create an oven that provides convective and/or conductive heat. In either case, the heating element 142 can be at least partially or substantially wrapped around a perimeter of the receptacle 118. Such a heating element can be heated by one or more of a variety of mechanisms, such as for example electrical resistance, inductive heating, chemical or combustion-related heating (e.g., by burning or causing oxidation or other exothermic chemical conversion of a fuel material), thermal conduction from another heated element, radiative heating, convection, etc.

In other implementations, the heating element 142 can be a part of a cartridge 120 containing a liquid vaporizable material 102 in a liquid reservoir 182, as shown in the vaporizer device 100c of FIG. 1C. As illustrated, the cartridge 120 can include a mouthpiece portion 130 and a shell portion 192 containing a heater portion 141 and a reservoir 182 configured to hold a liquid vaporizable material 102. The mouthpiece portion 130 and the shell portion 192 can be integrally formed (e.g., manufactured as a single piece) or can be joined together via mechanical coupling means, such as snap fit, press fit, friction fit, adhesive, and/or the like. The heater portion 141 can include a heating element 142 and a wicking material (not shown) configured to transfer the liquid vaporizable material 102 from the reservoir 182 to be in contact with the heating element 142 via capillary action. In some implementations, the heating element 142 can be in direct contact with the wicking material, such as by being pressed against one or more sides of the wicking material, wrapped at least partially around the wicking material, and/or the like. The heating element 142 can be configured to generate heat to convert the one or more compounds from the vaporizable material 102 to the gas phase for subsequent inhalation by a user in a gas-phase and/or a condensed (for example, aerosol particles or droplets) phase. For example, the heater portion 141 can include circuitry configured to receive and/or convert an applied electromagnetic field into an electrical current that is used to power, and thereby heat, the heating element 142. In some implementations, the heating element 142 itself can be configured to generate heat based on having a structure (e.g., material and shape) configured to receive and convert an applied electromagnetic field into an electrical current that is used to power, and thereby heat, the heating element 142. Accordingly, the heater portion 141 and/or heating element 142 can be powered via the driving circuitry 143, as described herein.

Where the vaporizable material 102 includes a non-liquid vaporizable material, the heating element 142 can be part of, or otherwise incorporated into or in thermal contact with, the walls of a heating chamber or compartment (e.g., receptacle 118) into which the cartridge 120 and/or the vaporizable material 102 is placed. Additionally or alternatively, the heating element 142 can be used to heat air passing into, through, or past the cartridge 120, to cause convective heating of the vaporizable material 102 (e.g., within the cartridge 120). In still other examples, the heating element 142 can be disposed in intimate contact with the vaporizable material 102 such that direct conductive heating of the vaporizable material 102 of the cartridge 120 occurs from within a mass of the vaporizable material 102, as opposed to only by conduction inward from walls of the heating chamber (e.g., an oven and/or the like). Convective heating of air passing through or past the cartridge 120 can also occur in such configurations. Additionally, conductive heating can occur by means of inductively heating the heating element 142. That is, the heating element 142 can generate heat based on conversion of electromagnetic energy into heat, and this heat can be thermally transmitted (e.g., conducted) to other parts of the cartridge 120, such as for example other parts of the heating element 142 that are not as directly affected by the electromagnetic energy, the vaporizable material 102, other thermally conductive parts of the cartridge 120 or the vaporizer body 110, etc. The vaporizable material 102 can be vaporized by this heat based in part on being in contact with one or more surfaces of the heating element 142 and/or other materials that are conductively heated by the heating element 142.

In some implementations, the vaporizable material 102 can be heated via one or more heating elements 142 that is not in physical contact with the vaporizable material 102, such as by convective heating. In accordance with such implementations, a heating element 142 can be configured to heat air passing along, through, and/or near the heating element 142 such that a temperature of the air reaches a temperature sufficient to vaporize at least a portion of the vaporizable material 102. In some implementations, the vaporizable material 102 can be vaporized by both conductive heat from at least one heating element 142 and convective heat from at least one other heating element 142.

The heating element 142 can provide heat to convert, to the gas phase, one or more compounds present in the vaporizable material 102 in association with a user puffing (e.g., drawing, inhaling, etc.) on a mouthpiece portion 130 and/or end of the vaporizer device 100 to cause air to flow from an air inlet, along an airflow path for assisting with forming an aerosol that can be delivered out through an air outlet in the mouthpiece portion 130 and inhaled by a user. Incoming air moving along the airflow path moves past (e.g., around, over, etc.) and/or through the cartridge 120 and/or vaporizable material 102 where compounds released from the vaporizable material 102 into the gas-phase are entrained into the air. The heating element 142 can be activated via the controller 104, which can optionally be a part of the vaporizer body 110 as discussed herein, causing current to pass from the power source 112 through a circuit including or otherwise electromagnetically coupled to (e.g., as part of an inductor-susceptor pairing) the heating element 142, which can be part of the vaporizer body 110. As noted herein, at least some of the entrained one or more gas-phase compounds can condense while passing through the remainder of the airflow path such that an inhalable dose of the one or more compounds in an aerosol form can be delivered from the air outlet (e.g., via the mouthpiece portion 130) for inhalation by a user.

In some implementations, the heating element 142 can be activated in association with a user interacting with the vaporizer device 100. For example, activation of the heating element 142 can be caused by automatic detection of a puff or other user interaction based on one or more signals generated by one or more sensors 113. The one or more sensors 113 and/or the signals generated by the one or more sensors 113 can include one or more of: a pressure sensor or sensors disposed to detect pressure along the airflow path of the vaporizer device 100 relative to ambient pressure or optionally to measure changes in absolute pressure; a temperature sensor or sensors, such as a thermistor, a positive temperature coefficient (PTC) circuit such as a PTC thermistor, a negative temperature coefficient (NTC) circuit such as an NTC thermistor, a thermocouple, and/or the like disposed to measure the temperature of the receptacle 118, the heating element 142, and/or some other component of the vaporizer body 110 or the cartridge 120; one or more circuits configured to determine a temperature of the heating element 142, for example based on measuring or determining a resistance and/or inductance of the heating element 142 via comparison to one or more resistors with a known resistance and/or one or more inductors with a known inductance; a motion sensor or sensors, such as an accelerometer, a gyroscope, or the like, configured to detect movement, vibration, orientation, position, acceleration, etc. of the vaporizer device 100; an airflow sensor or sensors configured to detect a flow rate of air, gas, or liquid within the vaporizer device 100; a capacitive sensor configured to detect touch, such as of a user's finger(s), palm(s), lip(s), etc. on some part of the vaporizer device 100; circuitry configured to detect interaction with the vaporizer device 100 via one or more input devices 116, such as buttons, other tactile control devices, or the like of the vaporizer device 100; circuitry configured to receive and process signals from a computing device in communication with the vaporizer device 100; and/or circuitry configured for determining that a puff is occurring or imminent.

In some implementations, the vaporizer device 100 can be configured to start a heating cycle that can include a period of heating the heating element 142, receptacle 118, cartridge 120, and/or vaporizable material 102 to an operating (e.g., pre-determined) temperature or temperature range (e.g., a temperature or range sufficient to convert, to the gas phase, one or more compounds present in the vaporizable material 102). Once the heating element 142, receptacle 118, cartridge 120, and/or vaporizable material 102 reach the operating temperature or temperature range, the vaporizer device 100 can be configured to maintain or otherwise regulate the application of heat such that the vaporizable material 102 can be vaporized without burning. In some implementations, additional heat can be provided via the heating element 142 upon detection of an event, such as a user placing their lips on the vaporizer device 100, the user taking a puff on the vaporizer device 100, and/or any of the signals (e.g., generated by the one or more sensors 113) described herein. The heating cycle can terminate upon detection of an additional interaction with the vaporizer device 100 via the one or more input devices 116, upon determining that a certain amount of time has elapsed since the start of the heating cycle, upon determining the user is no longer puffing on the vaporizer device 100 (e.g., mouthpiece 130 of the cartridge 120), upon determining that a certain amount of time has elapsed since the last detection of a user puff, upon determining that a cartridge 120 is not present within the receptacle 118, as a result of other events, actions, detected durations of the same, and/or the like, consistent with implementations described herein.

As discussed herein, the vaporizer device 100 consistent with implementations of the current subject matter can be configured to connect (e.g., wirelessly or via a wired connection) to a computing device (or optionally two or more devices) in communication with the vaporizer device 100. To this end, the controller 104 can include communication hardware 105. The controller 104 can also include a memory 108. The communication hardware 105 can include firmware and/or can be controlled by software for executing one or more protocols for the communication.

A computing device can be a component of a vaporizer system that also includes the vaporizer device 100, and can include its own hardware for communication, which can establish a wireless communication channel with the communication hardware 105 of the vaporizer device 100. For example, a computing device used as part of a vaporizer system can include a general-purpose computing device (such as a smartphone, a tablet, a personal computer, some other portable device such as a smartwatch, or the like) that executes software to produce a user interface for enabling a user to interact with the vaporizer device 100. In other implementations of the current subject matter, such computing device(s) used as part of a vaporizer system can be a dedicated piece of hardware such as a remote control or other wireless or wired device having one or more physical or soft (e.g., configurable on a screen or other display device and selectable via user interaction with a touch-sensitive screen or some other input device 116 like a mouse, pointer, trackball, cursor buttons, or the like) interface controls. The vaporizer device 100 can also include one or more outputs 117 or devices for providing information to the user. For example, the outputs 117 can include one or more light emitting diodes (LEDs) configured to provide feedback to a user based on a status and/or mode of operation of the vaporizer device 100. The one or more LEDs can be single-color LEDs and/or multicolored LEDs (e.g., both can be separately used).

In the example in which a computing device provides signals related to activation of the heating element 142, or in other examples of coupling of a computing device with the vaporizer device 100 for implementation of various control or other functions, the computing device executes one or more computer instruction sets to provide a user interface and underlying data handling. In one example, detection by the computing device of user interaction with one or more user interface elements can cause the computing device to signal the vaporizer device 100 to activate the heating element 142 to reach an operating temperature for creation of an inhalable dose of aerosol. Other functions of the vaporizer device 100 can be controlled by interaction of a user with a user interface on a computing device in communication with the vaporizer device 100.

The temperature of the heating element 142 of the vaporizer device 100 can depend on a number of factors, including an amount of power or energy delivered to the heating element 142, a voltage applied to the heating element 142 and/or driving circuitry 143, a duty cycle at which power or current is delivered, a frequency at which power is provided or applied to the heating element 142 and/or driving circuitry 143, a time during which the power or current is delivered, an efficiency of the heating element 142 converting current to heat, a temperature coefficient of resistivity (TCR) of the heating element 142, the construction and geometry of the heating element 142 (e.g., thickness, number of layers, number of folds or bends, etc.), conductive and/or radiative heat transfer to other parts of the vaporizer device 100 (e.g., vaporizable material 102), and/or to the environment, latent heat losses due to vaporization of the vaporizable material 102, convective heat losses due to airflow (e.g., air moving across the heating element 142 and/or an area heated by the heating element 142 when a user puffs on the vaporizer device 100), and/or the like.

As noted herein, to reliably activate the heating element 142 and/or heat the heating element 142 to a desired temperature, in some implementations of the current subject matter the vaporizer device 100 can make use of signals from the one or more sensors 113. For example, the one or more sensors 113 can include a pressure sensor and/or airflow sensors, to determine when a user is inhaling. The one or more sensors 113 can optionally be positioned in the airflow path and/or can be connected (for example, by a passageway or other path) to an airflow path containing an airflow inlet for air to enter the vaporizer device 100 and an airflow outlet via which the user inhales the resulting aerosol such that the one or more sensors 113 experiences changes (for example, pressure changes) concurrently with air passing through the vaporizer device 100 from the airflow inlet to the airflow outlet. In some implementations of the current subject matter, the heating element 142 can be activated in association with a user's puff, for example by automatic detection of the puff, or by the one or more sensors 113 detecting a change (such as a pressure change or flow rate) in the airflow path.

Additionally or alternatively, to maintain the heating element 142 at a desired temperature, in some implementations of the current subject matter the vaporizer device 100 can make use of other signals from one or more sensors 113. For example, the one or more sensors 113 can include a capacitive, conductive, and/or electromagnetic sensor, to determine the inductance, resistance, and/or impedance of the heating element 142. The one or more sensors 113 can optionally be positioned in a location that is in physical contact with the heating element 142 (for example, within the receptacle 118) or in a location that is sufficiently close to the heating element 142 to measure the variations in an electromagnetic field or components affecting the heating element 142 (e.g., within, touching, or proximate to at least some part of the receptacle 118). In some implementations, the one or more sensors 113 can be in electrical communication with an inductor configured to inductively heat the heating element 142 and/or configured to determine the inductance, resistance, and/or impedance of the inductor. Additionally or alternatively, the one or more sensors 113 can include a temperature sensor configured to sense a temperature of the inductor and/or heating element 142. Based on information derived from the one or more sensors 113, the controller 104 can be configured to estimate a temperature of the heating element 142, as described herein. In some implementations, the heating element 142 can be activated and/or power provided to the heating element 142 can be adapted in association with an estimated temperature of the heating element 142, for example by comparison of the detected inductance and/or resistance of the heating element 142 via the one or more sensors 113 with a suitable sensing circuit.

The one or more sensors 113 can be positioned on and/or coupled to (e.g., electrically or electronically connected, physically or via a wireless connection) the controller 104 (e.g., a printed circuit board assembly or other type of circuit board). To take measurements accurately and maintain durability of the vaporizer device 100, it can be beneficial to provide a seal that is sufficiently resilient to separate an airflow path from other parts of the vaporizer device 100. The seal, which can be a gasket, can be configured to at least partially surround the one or more sensors 113 such that connections of the one or more sensors 113 to the internal circuitry of the vaporizer device 100 are separated from a part of the one or more sensors 113 exposed to the airflow path. Such arrangements of the seal in the vaporizer device 100 can be helpful in mitigating against potentially disruptive impacts on vaporizer components resulting from interactions with environmental factors such as water in the vapor or liquid phases and/or to reduce the escape of air from the designated airflow path in the vaporizer device 100. Passage of air, liquid, or other fluid passing and/or contacting circuitry of the vaporizer device 100 can cause various unwanted effects, such as altered pressure and/or airflow readings, and/or can result in the buildup of material, such as moisture or residue, errant portions of the vaporizable material 102, etc., in parts of the vaporizer device 100 where they can result in poor pressure and/or airflow signal, degradation of the one or more sensors 113 or other components, and/or a shorter life of the vaporizer device 100. Leaks in the seal can also result in a user inhaling air that has passed over parts of the vaporizer device 100 containing, or constructed of, materials that may not be desirable to be inhaled, such as the controller 104, power source 112, and/or the like.

When the one or more sensors 113 includes an electrically conductive surface for measuring the resistance of the heating element 142, the one or more sensors 113 can additionally or alternatively be positioned on a surface that is biased against some part of the heating element 142. For example, the one or more sensors 113 can be disposed on a surface of a spring or other resiliently deformable structure, or otherwise biased by a spring or other resiliently deformable structure, such that the one or more sensors 113 remains in physical contact with a surface of the heating element 142. Such arrangements of a spring or other resiliently deformable structure in the vaporizer device 100 can be helpful in mitigating against potentially disruptive impacts on vaporizer components resulting from interactions with environmental factors such as those described herein.

In vaporizer devices in which the power source 112 is part of a vaporizer body 110 and the heating element 142 is disposed in the cartridge 120 configured to couple with the vaporizer body 110, the cartridge 120 and vaporizer device 100 can include electrical connection features (e.g., electrical contacts, conductors, and the like) for completing a physical circuit that includes the controller 104 (e.g., a printed circuit board, a microcontroller, or the like), the power source 112, and the heating element 142. The circuit completed by these electrical connections can allow delivery of electrical current to the heating element 142 (e.g., resistive heating element) and can further be used for additional functions, such as measuring a resistance of the heating element 142 for use in determining and/or controlling a temperature of the resistive heating element based on a thermal coefficient of resistivity of the resistive heating element. In some implementations, a different circuit can be provided for measuring a resistance of the heating element 142, compared to the circuit that allows for delivery of the electrical current to the heating element 142, such as a circuit that includes one or more sensors 113 and the heating element 142, as described herein.

Alternatively, the power source 112 can be part of a vaporizer body 110 and the heating element 142 can be disposed in the cartridge 120 and configured as a susceptor to be electromagnetically coupled with one or more inductor coils that are part of the driving circuitry 143 in the vaporizer body 110. A physical circuit in the vaporizer body 110 includes the controller 104 (e.g., a printed circuit board, a microcontroller, or the like), the power source 112, and the one or more inductor coils, which can be or form part of the driving circuitry 143. The physical circuit delivers electrical current to the one or more inductor coils and can further be used for additional functions, such as measuring inductance, resistance, and/or impedance of the heating element 142 for use in determining and/or controlling a temperature of the heating element 142 based on a thermal coefficient of resistivity of the heating element 142. In some implementations, a different circuit can be provided for measuring inductance, resistance, and/or impedance of the heating element 142, compared to the circuit that allows for delivery of the electrical current to the one or more inductor coils, such as a circuit that includes one or more sensors 113 as described herein.

In some implementations, the receptacle 118 can include all or part of the heating element 142 (e.g., a heating coil, resistive heating element, etc.) that is configured to conductively, radiatively, convectively, etc. heat the cartridge 120 received in the receptacle 118, such as for forming an aerosol to be inhaled by a user of the vaporizer device 100. For example, the receptacle 118 can include various implementations of the heating element 142 that are configured to receive and/or be placed in contact with the cartridge 120. Various implementations of the heating element 142, the receptacle 118, and the cartridge 120 are described herein for integration within and/or use with a variety of vaporizer bodies 110 for forming inhalable aerosol.

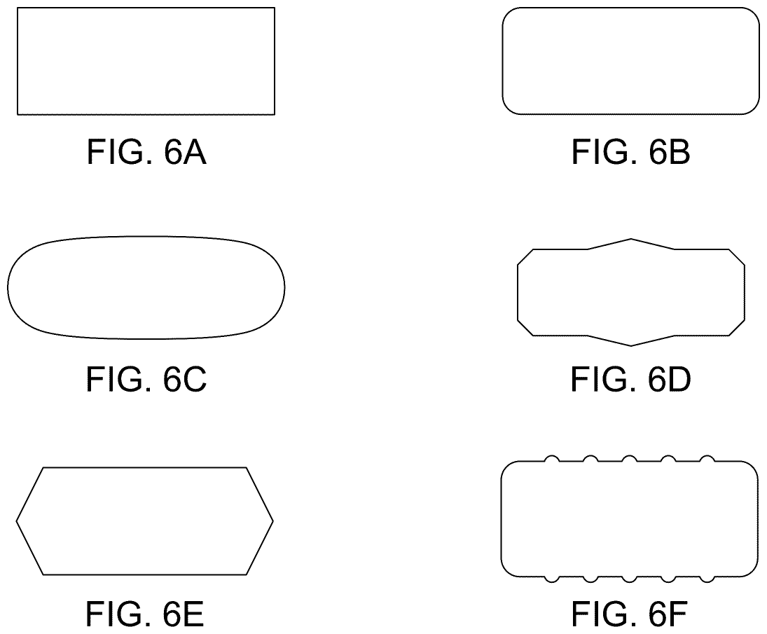

In some implementations, the cartridge 120 can be configured for insertion in the receptacle 118, such as for forming contact between an outer surface of the cartridge 120 and one or more inner walls of the receptacle 118. In some implementations, the cartridge 120 can have a same or a similar shape as the receptacle 118. In some implementations, the cartridge 120 can include a square or rectangular shape. In some implementations, the cartridge 120 can include a circular cross-section and/or a cylindrical shape. In some implementations, the cartridge 120 can have a non-circular cross-section transverse to the longitudinal axis along which the cartridge 120 is inserted into the receptacle 118. The non-circular cross-section(s) of the cartridge 120 and/or receptacle 118 can include two sets of parallel or approximately parallel opposing sides (e.g., having a parallelogram-like shape), or other shapes, including curved shapes, having rotational symmetry of at least order two. For example, FIGS. 6A-6F illustrate example cross-sections of the cartridge 120 and/or receptacle 118, including a rectangular shape (FIG. 6A), a rounded rectangular shape (FIG. 6B), an elliptical or oval shape (FIG. 6C), or other shapes that include corners, bends, edges, protrusions, recesses, and/or the like (FIGS. 6D-6F). In this context, approximate shape indicates that a basic likeness to the described shape is apparent, but that sides of the shape in question need not be completely linear and vertices need not be completely sharp. Rounding of both or either of the edges or the vertices of the cross-sectional shape is contemplated in the description of any non-circular cross-section referred to herein.

In some implementations, at least one of the one or more inner walls forming the receptacle 118 can include the heating element 142 and/or include thermally conductive material. For example, cartridge 120 configurations in which the cartridge 120 forms a sliding fit and/or forms close contact with the receptacle 118 can allow for efficient heat transfer between the heating element 142, the receptacle 118, and the cartridge 120, thereby causing efficient and effective heating of the vaporizable material 102 within the cartridge 120. In other implementations, at least one of the one or more inner walls forming the receptacle 118 can include ridges that only contact the cartridge 120 in specific locations, in order to minimize conductive heat losses from the cartridge due to physical contact with surfaces of the vaporizer body 110 that are not actively heated. For example, cartridge 120 configurations in which the heater portion 141 (or other thermally conductive parts) of the cartridge 120 only contacts the receptacle 118 in certain regions, such as regions distal to the heating element(s) 142, can allow for maintaining a higher temperature at the heating element 142, thereby causing efficient and effective heating of the vaporizable material 102 within the cartridge 120.

Furthermore, the cartridge 120 can include compressed and/or higher density configurations of non-liquid vaporizable material 102, which can further contribute to efficient and effective heating and converting, to the gas phase, one or more compounds present in the vaporizable material 102. For example, vaporizable material 102 in a compressed and/or high-density configuration can include a minimal amount of air or pockets of air in the vaporizable material 102 thereby increasing the efficiency and effectiveness of transferring heat within the vaporizable material 102. Such a configuration can allow for reduced power consumption at least because less heating power is needed to effectively heat the vaporizable material 102 to a temperature sufficient to cause release of inhalable substances. Additionally, lower temperatures (e.g., at a contact surface of an oven or heating element) can be used to heat the vaporizable material 102 at least because of the improved heating efficiency of the vaporizable material 102, which can also reduce power consumption and formation of hazardous byproducts resulting from heating the vaporizable material at higher temperatures. Various implementations of the cartridge 120 are described herein that include the vaporizable material formed in compressed and/or high-density configurations for achieving at least some of the benefits described above.

In some implementations, the vaporizer device 100 can include a heating system configured to receive and heat the vaporizable material 102 for generating an inhalable aerosol. For example, implementations of the heating system can include one or more heating elements 142 positioned at, against, near, within, outside, and/or along the walls of the receptacle 118 (e.g., extending along at least a portion of the wall(s) at the distal end (e.g., bottom) of the receptacle 118, extending along at least a portion of each of the distal wall(s) and/or side wall(s) of the receptacle 118, etc.). In some implementations, the one or more heating elements 142 can be configured to heat one or more of the walls of the receptacle 118 from the outside to the interior of the receptacle 118 (e.g., with the vaporizable material 102 being in the interior of the receptacle 118). In another example, implementations of the heating system can include one or more heating elements 142 positioned at, against, near, within, outside, and/or along the walls of the cartridge 120 (e.g., extending along at least a portion of the wall(s) at the distal end (e.g., bottom) of the cartridge 120, extending along at least a portion of each of the distal wall(s) and/or side wall(s) of the cartridge 120, etc.). In some implementations, the one or more heating elements 142 can form one or more of the walls of the cartridge 120 to heat from the outside to the interior of the cartridge 120 (e.g., with the vaporizable material 102 being in the interior of the cartridge 120 and optionally, in the interior of the heating element 142).

The heating system can also include at least one airflow pathway, which can be configured to move heated air through the vaporizable material 102. As described herein, the heating system can be configured to receive the cartridge 120 and heat the cartridge 120 using at least one heating element 142 to provide an inhalable aerosol via one or more airflow pathways for inhalation by a user.

Various implementations of such heating systems of vaporizer devices 100 are described herein that provide a number of benefits, including evenly distributing heat through the vaporizable material 102 of the cartridge 120. This can result in improved inhalable aerosol generation, less energy and/or lower average temperatures required to form inhalable aerosol, and increased user satisfaction with the device use and consumption of the vaporizable material 102.

In some implementations, the heating system of the vaporizer device 100 is configured to heat a non-liquid vaporizable material, such as a tobacco-based material. For example, the vaporizer body 110 can include one or more heater portions 141 or containers 123 that each accept and heat vaporizable material 102 via one or more heating elements 142, thereby generating an inhalable aerosol. In some implementations, the vaporizer device 100 can include one or more airflow pathways that extend through the cartridge 120 positioned within a respective receptacle 118, and out through a mouthpiece portion 130 to a user.

In some implementations, the cartridge 120 can include one or more barriers configured to contain vaporizable material 102 and/or hold the components of the cartridge 120 together. The one or more barriers can be provided by the heating element 142 itself, a container 123, an insert 124, an outer layer, such as one or more wrappers 122, and/or the like. The one or more barriers can be made of material that is one or both of non-vapor permeable and moisture-resistant (e.g., resists damaging effects of water, at least to some extent). Such material can include one or more of metal, metal alloy, cotton, paper material such as cardstock, corrugated material such as cardboard or paper, tobacco paper, temperature-resistant plastic such as polyethylene terephthalate (PET), cellulose acetate, non-wood plant fibers such as flax, hemp, sisal, rice straw, and/or esparto, and/or the like.

In some implementations, use of a metal (such as aluminum) in the heating element 142 and/or a container 123 can be advantageous where efficient heat transfer (e.g., requiring less energy to spread across a larger region) is required, which can be the case where a singular heat source is provided. In other implementations, a metal such as stainless steel in the heating element 142 and/or a container 123 can be advantageous where efficient heat transfer is of less concern, such as where multiple heat sources are disposed to heat different regions of the cartridge 120. Containing the vaporizable material 102 within a non-vapor permeable and/or moisture-resistant barrier can protect the receptacle 118 and/or other portions of the vaporizer device 100 from vapor deposits and/or remains of the vaporizable material 102, such that cleaning of the heating element 142, receptacle 118, and/or other portions of the vaporizer device 100 after use may not be required. Stated another way, one or more of the heating element 142, the container 123, the insert 124, and/or the outer layer (e.g., one or more wrappers 122) can provide a barrier between the vaporizable material 102 and the components of the vaporizer body 110, with the barrier optionally being non-vapor permeable and/or moisture-resistant.

The heater 141 of FIG. 1A and/or the container 123 of FIG. 1B cartridge 120 can be configured to hold the vaporizable material 102 with a lid, outer layer and/or inner layer(s) (e.g., wrapper(s) 122), insert 124, and/or other component configured to retain the vaporizable material 102 therein. Various implementations of a heating system and cartridge 120 are described in greater detail herein.

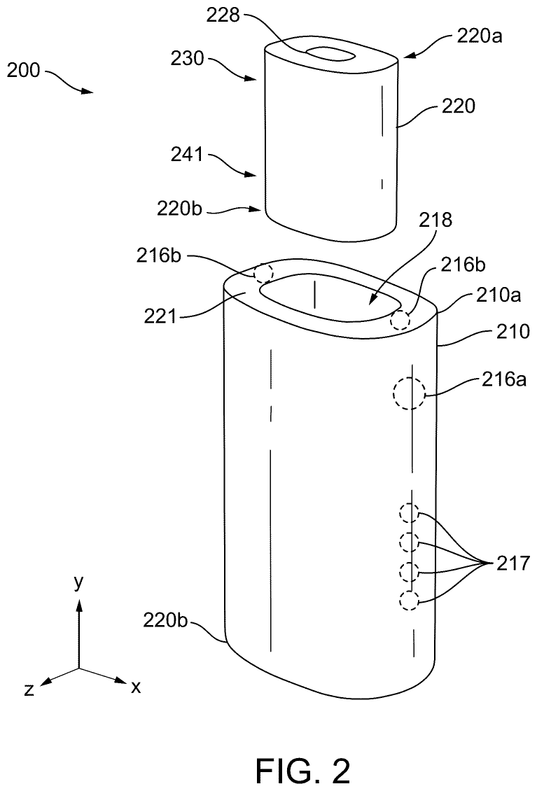

FIG. 2 illustrates a perspective view of an implementation of a vaporizer device 200, consistent with implementations of the current subject matter. The vaporizer device 200 can be an implementation of one or more components of the vaporizer device 100 of FIGS. 1A-1B. Separately, any of the structure of functionality described with respect to the vaporizer device 200 of FIG. 2 can be implemented in or by the vaporizer device 100 of FIGS. 1A-1B.

For example, as illustrated, the vaporizer device 200 can include a vaporizer body 210, a receptacle 218, and a ledge 221 outside of the receptacle 218. As described herein, a cartridge 220 containing vaporizable material 102 (including any implementation of the vaporizer material 102 of FIGS. 1A-1C) can be inserted into the receptacle 218, and at least a portion of the cartridge 220 can remain outside of the receptacle 218, such as at least part of the mouthpiece portion 230 that includes an airflow outlet 228. At least part of the heater portion 241 of the cartridge 220 can be inserted into and/or at least partially enclosed within the receptacle 218.

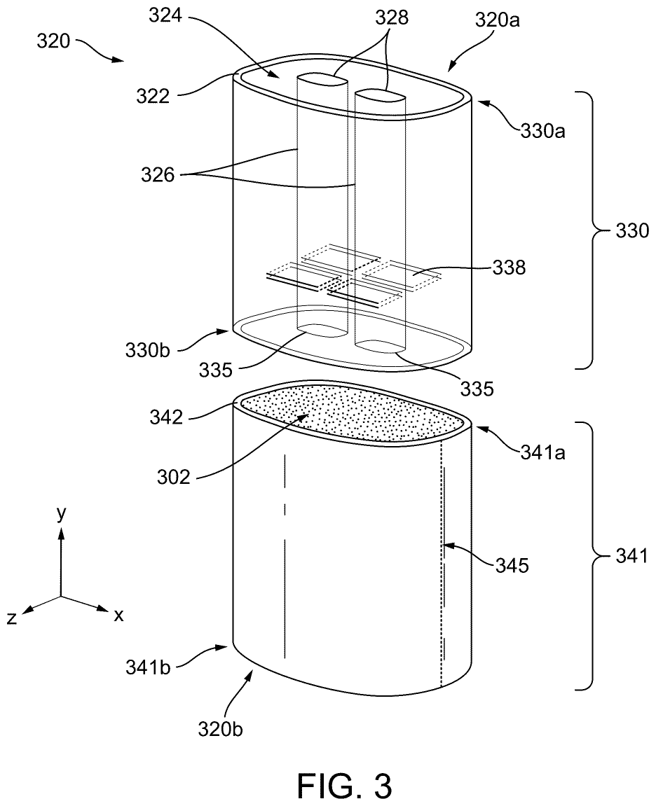

As illustrated, the cartridge 220 can extend from a cartridge proximal end 220a to a cartridge distal end 220b and contain two or more portions, such as a heater portion 241 and a mouthpiece portion 230. The total distance between the cartridge proximal end 220a and the cartridge distal end 220b can be regarded as the cartridge 220 length, for example, extending along the y-axis as illustrated in FIG. 2 (and as also illustrated in FIG. 3). Furthermore, any component of the cartridge 220 can be referred to as having a length as referenced by the y-axis in FIG. 2 (and as also illustrated in FIG. 3).

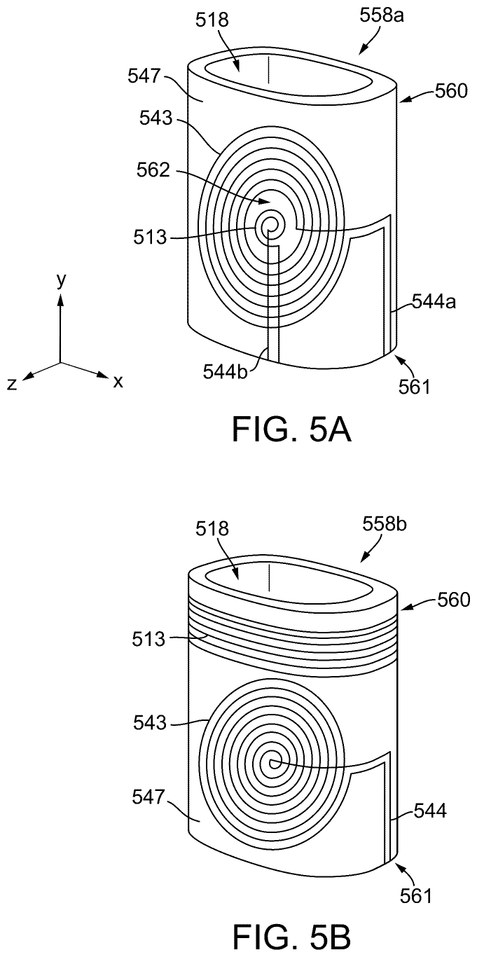

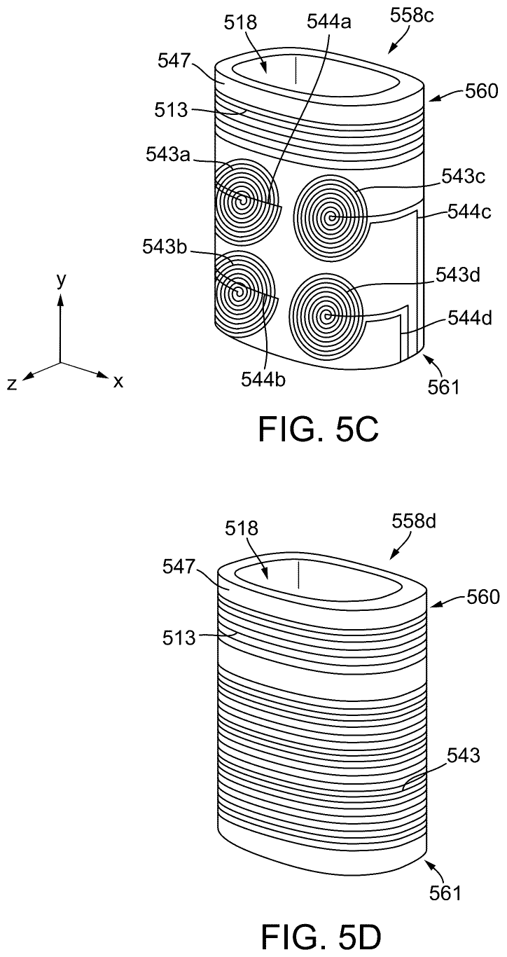

As also illustrated, the vaporizer body 210 can extend from a body proximal end 210a to a body distal end 210b. The total distance between the body proximal end 210a and the body distal end 210b can be regarded as the vaporizer body 210 length, for example, extending along the y-axis as illustrated in FIG. 2 (and as also illustrated in FIGS. 5A-5D). Furthermore, any component of the vaporizer body 210, as well as the vaporizer device 200, can be referred to as having a length as referenced by the y-axis in FIG. 2 (and as also illustrated in FIGS. 5A-5D with respect to components of the vaporizer body 210).

The cartridge 220 can be regarded as having two additional dimensions that are transverse to the cartridge 220 length, which are the depth and the width. As referred to herein, the cartridge 220 depth can be the distance between two points on opposing faces (e.g., surface areas, which can be substantially the same size and shape when rotated about a central longitudinal axis, which can be regarded as an axis along which the cartridge 220 length extends) of the exterior of the cartridge 220, in a dimension that is perpendicular to the cartridge 220 length, for example, extending along the z-axis as illustrated in FIG. 2 (and as also illustrated in FIG. 3). Furthermore, any component of the cartridge 220 can be referred to as having a depth as referenced by the z-axis in FIG. 2 (and as also illustrated in FIG. 3). In some aspects, the cartridge 220 depth can be understood as the greatest distance of the cartridge 220 along the z-axis and/or the distance between two opposing points on the exterior of the cartridge 220 (e.g., with the opposing points being opposite each other along an axis that is perpendicular to the center of the cartridge 220 width). As referred to herein, the cartridge 220 width can be the distance between two points on opposing faces of the exterior of the cartridge 220, in a dimension that is perpendicular to both the cartridge 220 length and the cartridge 220 depth, and is the longer of the two transverse dimensions, for example, extending along the x-axis as illustrated in FIG. 2 (and as also illustrated in FIG. 3). Furthermore, any component of the cartridge 220 can be referred to as having a width as referenced by the x-axis in FIG. 2 (and as also illustrated in FIG. 3). In some aspects, the cartridge 220 width can be understood as the greatest distance of the cartridge 220 along the x-axis and/or the distance between two opposing points on the exterior of the cartridge 220 (e.g., with the opposing points being opposite each other along an axis that is perpendicular to the center of the cartridge 220 depth). Accordingly, the axis along which the cartridge 220 width extends can be referred to as the first transverse axis and/or the cartridge long axis, and the axis along which the cartridge 220 depth extends can be referred to as the second transverse axis and/or the cartridge short axis.

A surface of the cartridge 220 extending primarily along the cartridge 220 width can be referred to as a long side of the cartridge 220 and/or as being on a long side of the cartridge 220, and a surface of the cartridge 220 extending primarily along the cartridge 220 depth can be referred to as a short side of the cartridge 220 and/or as being on a short side of the cartridge 220. Each of the referenced surfaces of the cartridge 220 can be a surface area on the exterior of the cartridge 220. In some aspects, the longer opposing faces can be regarded as being on the long/longer sides of the cartridge 220, offset along the cartridge 220 depth, and the smaller opposing faces can be regarded as being on the short/shorter sides of the cartridge 220, offset along the cartridge 220 width. It will be appreciated that this terminology can be applied to any implementation of a cartridge and its subcomponents described herein (e.g., heater portion, mouthpiece portion, heating element, layer of material, wrapper, insert, and/or the like), and this terminology is not redefined with respect to each implementation or subcomponent for the sake of brevity.

The vaporizer body 210 can also be regarded as having two additional dimensions that are transverse to the vaporizer body 210 length, which are the depth and the width. As referred to herein, the vaporizer body 210 depth can be the distance between two points on opposing faces of the exterior of the vaporizer body 210, in a dimension that is perpendicular to the vaporizer body 210 length, for example, extending along the z-axis as illustrated in FIG. 2 (and as also illustrated in FIG. 5A). Furthermore, any component of the vaporizer body 210, as well as the vaporizer device 200, can be referred to as having a depth as referenced by the z-axis in FIG. 2 (and as also illustrated in FIG. 5A with respect to components of the vaporizer body 210). In some aspects, the vaporizer body 210 depth can be understood as the greatest distance of the vaporizer body 210 along the z-axis and/or the distance between two opposing points on the exterior of the vaporizer body 210 (e.g., with the opposing points being opposite each other along an axis that is perpendicular to the center of the vaporizer body 210 width). As referred to herein, the vaporizer body 210 width can be the distance between two points on opposing faces of the exterior of the vaporizer body 210, in a dimension that is perpendicular to both the vaporizer body 210 length and the vaporizer body 210 depth, and is the longer of the two transverse dimensions, for example, extending along the x-axis as illustrated in FIG. 2 (and as also illustrated in FIGS. 5A-5D). Furthermore, any component of the vaporizer body 210, as well as the vaporizer device 200, can be referred to as having a width as referenced by the x-axis in FIG. 2 (and as also illustrated in FIGS. 5A-5D with respect to components of the vaporizer body 210). In some aspects, the vaporizer body 210 width can be understood as the greatest distance of the vaporizer body 210 along the x-axis and/or the distance between two opposing points on the exterior of the vaporizer body 210 (e.g., with the opposing points being opposite each other along an axis that is perpendicular to the center of the vaporizer body 210 depth). Accordingly, the axis along which the vaporizer body 210 width extends can be referred to as the first transverse axis and/or the vaporizer body long axis, and the axis along which the vaporizer body 210 depth extends can be referred to as the second transverse axis and/or the vaporizer body short axis.

A surface of the vaporizer body 210 extending primarily along the vaporizer body 210 width can be referred to as a long side of the vaporizer body 210 and/or as being on a long side of the vaporizer body 210, and a surface of the vaporizer body 210 extending primarily along the vaporizer body 210 depth can be referred to as a short side of the vaporizer body 210 and/or as being on a short side of the vaporizer body 210. Each of the referenced surfaces of the vaporizer body 210 can be a surface area on the exterior of the vaporizer body 210. In some aspects, the longer opposing faces can be regarded as being on the long/longer sides of the vaporizer body 210, offset along the vaporizer body 210 depth, and the smaller opposing faces can be regarded as being on the short/shorter sides of the vaporizer body 210, offset along the vaporizer body 210 width. It will be appreciated that this terminology can be applied to any implementation of a vaporizer body and its subcomponents described herein (e.g., holder assembly, frame, inductor, flux concentrator, shell, and/or the like), and this terminology is not redefined with respect to each implementation or subcomponent for the sake of brevity.

It will be appreciated that elements described herein (e.g., vaporizer device, cartridge, vaporizer body, and component thereof) can have surfaces defined in Euclidean or non-Euclidean spaces. Dimensions of ends, sides, faces, and/or the like that exist in non-Euclidean spaces can be regarded as dimensions of the referenced ends, sides, faces and/or the like that exist in Euclidean spaces. The distance between any two ends, sides, faces, points, etc. can be equal to the shortest distance between two opposing points at the center of each identified structure, component, region, portion, etc. However, in the event a structure, component, region, portion, etc. is not uniform in shape (e.g., convex or concave ends of a cartridge 220 and/or vaporizer body 210), the distance can be equal to the longest distance along a plane or volume that intersects the identified ends, sides, points, etc., orthogonal to the identified ends, sides, points, etc.

The term “heater portion” as used herein can refer to a portion (e.g., region and/or subset of the components) of a cartridge that includes a heating element or is otherwise heated in use. The term “mouthpiece portion” as used herein can refer to a portion (e.g., region and/or subset of the components) of a cartridge that includes a mouthpiece or other component to which a user applies their mouth in use. Although the cartridges are generally described herein with respect to a heater portion and a mouthpiece portion for simplicity, it will be appreciated that additional portions can be provided within the cartridge, which can be at least partially upstream, between, downstream, adjacent, within and/or exterior to the heater portion and/or mouthpiece portion. For example, an external wrapper or shell can be exterior to both the heater portion and mouthpiece portion, a space and/or component(s) can be disposed between the heater portion and mouthpiece portion such as a divider, the heater portion can include an insert and/or end cap upstream or at least partially within the heater portion, the mouthpiece portion can include an insert and/or end cap downstream or at least partially within the mouthpiece portion, and/or the like. Although the mouthpiece portion 230 and the heater portion 241 can be approximately the same size in length (e.g., 1:1) along the cartridge 220 length, other relative sizes are contemplated (e.g., approximately 1:2, 2:3, 3:4, 4:5, 5:4, and/or the like). Furthermore, it will be appreciated that although described at times as separable, the mouthpiece portion 230 and the heater portion 241 can simply regarded as general regions of a unitary body that is the cartridge 220.

As illustrated, the vaporizer device 200 can include one or more input devices 216a, 216b (collectively referred to as input devices 216), such as a pair of input devices 216a on opposing sides of the vaporizer body 210 and/or one or more input devices 216b on the ledge 221. In some implementations, the one or more input devices 216a, 216b can include a button (e.g., plastic, metal, elastomeric), a capacitive sensor, and/or the like. A controller (not illustrated) of the vaporizer device 200, similar to controller 104 of FIGS. 1A-1C, can be configured to detect actuation (e.g., touch or force) of the one or more input devices 216a, 216b based on signals or data provided by the one or more input devices 216a, 216b. In implementations where multiple input devices 216 are present, a controller 104 of the vaporizer device 200 can be configured to activate the vaporizer device 200 only in response to detecting actuation of all of the input devices 216 (e.g., two input devices 216a located at opposing sides of the vaporizer body 210). It can be beneficial to provide multiple input devices 216 in different locations that are less likely to each be activated accidentally (e.g., in locations most likely to be touched all at the same time only during active use of the vaporizer device 200). However, a simpler interface can be provided, such as by using an input device 216 in the form of a single push button or multiple push buttons.

In some implementations, the controller 104 of the vaporizer device 200 can be configured to select predetermined operating temperatures and/or heating profiles from among N temperatures or profiles. In accordance with these implementations, the controller 104 of the vaporizer device 200 can be configured (and thereby a user can be allowed) to select a temperature or profile based on detecting actuation of the one or more input devices 216. In some implementations, the input device(s) 216 (e.g., input devices 216a) can be used to increase and decrease the currently selected operating temperature (also referred to as target temperature) and/or profile between a range of zero (0) through N temperatures and/or profiles, where zero means the vaporizer device 200 is in an “off” state (e.g., not actively heating the receptacle 218 but otherwise configured to detect interactions with one or more components of the vaporizer device 200). Accordingly, an input device 216 can be actuated to increase the currently selected operating temperature and/or profile and the same or another input device 216 can be actuated to decrease the currently selected operating temperature and/or profile. The input device(s) 216 can be actuated to provide for switching between the “off” state and an “on” state (e.g., where the “on” state starts at the lowest pre-configured temperature and/or profile) when one or more input device 216 is actuated (e.g., held down or pressed) for a predetermined time. As described herein, the controller 104 can be configured to heat different regions of the heating element 143, optionally at different temperatures and/or times.

In some implementations, the controller 104 of the vaporizer device 200 can be configured to operate (e.g., power the heating element 142 as described herein) at one or more predetermined operating temperatures, such as based on a default or user-selected heating profile. For example, in some heating profiles, the controller of the vaporizer device 200 can be configured to power the heating element 142 at a first operating temperature for a first period of time, power the heating element 142 at a second operating temperature for a second period of time, power the heating element 142 at a third operating temperature for a third period of time, and/or the like. In some implementations, the controller 104 of the vaporizer device 200 can be configured to power the heating element 142 based on usage of the vaporizer device 200. For example, an operating temperature of the heating element 142 can be initially set to an initial operating temperature and/or the operating temperature can be dynamically changed depending on detected airflow, temperatures, heating time, power applied, estimated vaporizable material 102 used, estimated vaporizable material 102 remaining, and/or the like. Although heating of the vaporizable material 102 is at times described with respect to a singular heating element 142, it will be appreciated that multiple heating elements 142 and/or multiple regions of a singular heating element 142 can be implemented and/or controlled in the same or similar manner to provide more control over vaporization of the vaporizable material 102.

In some implementations, the controller 104 of the vaporizer device 200 can be configured to detect when the heater portion 241 is present within the receptacle 218 and/or for a sufficient duration of time. In response to determining that the heater portion 241 is present within the receptacle 218 and/or for a sufficient duration of time, the controller of the vaporizer device 200 can switch the vaporizer device 200 between the “off” state and the “on” state, increase the temperature (e.g., to a range of zero (0) through N target temperatures), implement a predetermined (e.g., user-selected) profile (e.g., from a plurality of zero (0) through N different profiles), and/or the like.

In some implementations, the controller 104 of the vaporizer device 200 can be configured to determine whether a cartridge 220 is spent and/or should be changed. This can occur when all, most, or an estimated threshold amount of one or more compound present in the vaporizable material 102 contained within the cartridge 220 has been converted to the gas phase, when an insufficient amount or quality of the vaporizable material 102 is present to provide an inhalable aerosol that would be satisfying to a user, and/or the like. For example, based on the length of time the cartridge 220 is heated, the temperatures at which the cartridge 220 is heated across the length of time or the temperatures at each of a plurality of time segments (which can be measured via the controller 104 of the vaporizer device 200 as described herein), and/or the like, the controller 104 of the vaporizer device 200 can be configured to determine that the cartridge 220 is spent and/or should be changed. Based on determining that the cartridge 220 is spent and/or should be changed, the controller 104 of the vaporizer device 200 can be figured to provide an indication that the cartridge 220 is spent and/or should be changed, switch the vaporizer device 200 into the “off” state, and/or the like. During operation, the controller 104 of the vaporizer device 200 can be configured to provide indications of an estimated amount of vaporizable material 102 left in the cartridge 220 and/or an estimated amount of time remaining in a vaporizing session during which the vaporizable material 102 can be used (e.g., a period of time starting when the vaporizer device 200 is heated or when the receptacle 218 reaches a predetermined operating temperature and ending when the cartridge 220 is spent and/or should be changed). In some implementations, the controller 104 can be contained in and/or in communication with the vaporizer body 210 and/or the cartridge 220.

The vaporizer device 200 can include a plurality of outputs 217 (e.g., LEDs) that can be similar to the output(s) 117 (e.g., vibration, sound, and/or the like), and the controller 104 of the vaporizer device 200 can be configured to illuminate one or more of the LED outputs 217 in response to detecting actuation of one or more of the input devices 216a, 216b, in response to detecting a cartridge 220 has been inserted into the receptacle 218, to indicate the currently selected operating temperature and/or temperature profile; to indicate the current temperature of the receptacle 218; to indicate the current temperature of the receptacle 218 relative to the currently selected operating temperature and/or temperature profile; to indicate the current temperature of the receptacle 218 has reached the currently selected operating temperature; to indicate an estimated amount of useable vaporizable material remaining in a cartridge 220 (e.g., by selectively illuminating more or less of the LED outputs 217); to indicate an estimated amount of time remaining in a vaporizing session (e.g., by selectively illuminating more or less of the LED outputs 217); to indicate an indication that the cartridge 220 is spent and/or should be changed; to indicate an amount of battery power remaining (e.g., voltage remaining within a power source 112), and/or the like. In some implementations, the one or more input devices 216a, 216b can include one or more of the LEDs described (additionally or alternatively to the LED outputs 217), be at least partially surrounded by the LEDs, and/or be positioned relative to the LEDs such that a perimeter (e.g., halo) of light at least partially surrounds a perimeter of the one or more input devices 216a, 216b.

The controller 104 of the vaporizer device 200 can be configured to illuminate the LEDs (e.g., the plurality of LED outputs 217 and/or LEDs proximate one or more of the input devices 216a, 216b) in one or more colors and/or according to one or more patterns. For example, the controller 104 of the vaporizer device 200 can be configured to illuminate the LEDs according to different colors to indicate a current temperature of the receptacle 218 (e.g., oven), blink one or more times to indicate the current temperature of the receptacle 218 has reached the currently selected operating temperature, and/or the like. Additionally or alternatively, the controller 104 can be configured to provide haptic feedback (e.g., via one or more outputs 217, such as a motor, a linear resonant actuator, and/or the like) to indicate the one or more input devices 216a, 216b have been pressed, whether the vaporizer device 200 has switched between the “off” state and/or the “on” state (e.g., that the receptacle 218 is heating up), a current temperature of the receptacle 218 (e.g., in a periodic pattern with increasing frequency), whether the current temperature of the receptacle 218 has reached the currently selected operating temperature, when threshold amounts of the estimated amount of useable vaporizable material remaining in a cartridge 220 are reached, when threshold amounts of estimated amounts of time remaining in the vaporizing session are reached, that the cartridge 220 is spent and/or should be changed, and/or the like. Although illustrated as a generally flattened cylindrical shape, a cross-section of the cartridge 220 and/or vaporizer body 210 can be a different shape. For example, in some implementations, a cross-section of the cartridge 220 and/or vaporizer body 210 can be similar to one or more of the cross-sections of FIGS. 6A-6F. The cross-section can be anywhere between the respective distal and proximal ends of each of the cartridge 220 and/or vaporizer body 210.

FIG. 3 illustrates a perspective view of an implementation of a cartridge 320 in an exploded schematic form, consistent with implementations of the current subject matter. The cartridge 320 can be an implementation of one or more components of the cartridges 120 of FIGS. 1A-1B and/or the cartridge 220 of FIG. 2, and/or can be configured for use within a vaporizer device such as the vaporizer devices 100a, 100b of FIGS. 1A-1B and/or the vaporizer device 200 of FIG. 2. As illustrated, the cartridge 320 can extend from a cartridge proximal end 320a to a cartridge distal end 320b and contain two or more portions, such as a heater portion 341 and a mouthpiece portion 330. As described herein, the total distance between the cartridge proximal end 320a and the cartridge distal end 320b can be regarded as the cartridge 320 length, and transverse to the cartridge 320 length are the width (longer dimension, x-axis) and the depth (shorter dimension, z-axis). As further described herein, cartridges 320 can have surfaces defined in Euclidean or non-Euclidean spaces.

As illustrated, the heater portion 341 can include a heating element 342 and vaporizable material 302. The heating element 342 and/or the vaporizable material 302 can extend between a heater portion proximal end 341a and a heater portion distal end 341b, and the total distance (dimension) between these two ends can be referred to as the heater portion 341 length. For convenience, the heater portion 341 length can be referred to with respect to the longitudinal axis (y-axis) along which the cartridge 320 is inserted into a receptacle (e.g., the receptacle 218 of FIG. 2). The heater portion 341 can also be regarded as having two additional dimensions that are transverse to the heater portion 341 length, which are the width (longer dimension, x-axis) and the depth (shorter dimension, z-axis).

In implementations where the heater portion 341 width is greater than the heater portion 341 depth and/or the vaporizable material 302 width is greater than the vaporizable material 302 depth (e.g., in a 3:2 ratio, 9:5 ratio, 2:1 ratio, 9:4 ratio, 5:2 ratio, or greater ratio), heat transfer can be more efficient. For example, relative to a cylindrical surface, a heating element 342 and/or vaporizable material 302 that includes two wider, opposing surface areas (e.g., faces) with a shorter distance between the two opposing surfaces can allow for a vaporizer device that only needs to actively heat from one or two of the opposing sides, as opposed to on all surfaces of a cylindrical surface. The remaining portions of the heating element 342 that are not actively heated can be configured to absorb and redistribute heat from the nearby regions that are actively heated, thereby providing heat to a much larger surface area of the vaporizable material 302 compared to a cylindrical surface. While this non-cylindrical structure (e.g., elliptical or oval) is harder to manufacture than a cylindrical structure, it provides benefits to the user by making the system easier and more comfortable to use (e.g., more ergonomic structure that fits the natural shape of a user's lips). Additionally, the use of less power due to increased efficiency allows for longer battery life and/or less spatial constraints on the vaporizer device (e.g., a smaller battery can be used). Ultimately, the manner in which the heating element 342 and/or vaporizable material 302 is heated can affect the temperature at which the vaporizable material 302 is heated and/or the rate at which one or more compounds present in the vaporizable material 302 are converted to the gas phase and/or otherwise released from the vaporizable material 302.

As discussed herein, the heating element 342 can be configured to convert electrical energy into heat (e.g., through inductive heating, resistive heating, etc.). However, in some implementations, the heating element 342 of FIG. 3 can instead be regarded as a container (e.g., similar to the container 123 of FIG. 1B) that receives heat from an external heat source and distributes it to the vaporizable material 302. In implementations in which inductive heating is used to heat the heating element 342, providing a wider surface area also has further benefits. For example, it is easier to generate eddy currents in wider, flatter, and/or larger surfaces as compared to curved and/or smaller surfaces. Additionally, larger surface areas of a heating element 342 allow for more surface area of the heating element 342 to be in direct and thermal contact with a larger area of the vaporizable material 302 and/or be in thermal contact with air passing through the cartridge 320. These eddy currents can be generated over a larger surface area using less energy and/or the larger surface area can provide multiple, smaller regions that can be selectively targeted using a plurality of smaller inductors. In this regard, use of susceptors that are inductively heated, at least primarily, via formation of eddy currents rather that via hysteresis (as is the case for susceptors comprising magnetic and/or ferritic materials) can be advantageous. In implementations where eddy currents are the primary (e.g., entire) form of heat generation, the inductive coil(s) can include or otherwise be formed of Litz wire. As used herein, Litz wire can refer to a wire formed from a plurality of strands of metal (e.g., 5 strands, 10 strands, 20 strands, 40 strand, etc.) that are twisted or braided together, and can optionally include an outer insulation material, an internal core of material, and/or the like.

In some implementations, a susceptor is provided that is non-ferritic and/or non-magnetically permeable. For example, aluminum can be considered as non-ferritic and non-magnetically permeable, and thereby substantially unaffected by hysteresis. With no or substantially no influence on temperature created via hysteresis, the temperature of non-ferritic and/or non-magnetically permeable susceptors can be derived based on the direct relationship of the temperature of the susceptor and eddy currents, as described herein. Although inductors and/or inductive coils may be referred to herein as “heating” susceptors and/or heating element, it will be appreciated by those of skill in the art that heating in this sense can be regarded as an inductor generating magnetic and/or electromagnetic energy that is radiated into and absorbed by one or more segments of a susceptor, which is in turn converted into heat via eddy currents and/or hysteresis.

At least a portion of the heater portion 341 can be contained within a wrapper 322. The wrapper 322 can be similar to the outer layer (e.g., wrapper(s) 122) of FIGS. 1A-1B. For example, the wrapper 322 can be made of material such as one or more of a paper material such as cardstock, corrugated material such as cardboard or paper, tobacco paper, temperature-resistant plastic (e.g., PET), non-wood plant fibers such as flax, hemp, sisal, rice straw, and/or esparto, and/or the like. The wrapper 322 can extend along all or at least some part of the heater portion 341 length, and define an interior volume between the heater portion 341 depth and width. The vaporizable material 302 can fill the majority of the volume, but other components can be present, such as an end cap and/or divider configured to at least partially enclose end(s) of the volume. In some implementations, the heating element 342 extends between all or at least some part of the heater portion 341 length, and defines an interior volume between the heater portion 341 depth and width within which the vaporizable material 302 can be contained.

In some implementations, the vaporizable material 302 can be formed from tobacco leaves (e.g., dried, cut, shredded, and/or reconstituted), tobacco stems (dried, cut, shredded, and/or ground), a carrier, and/or an acid (e.g., an organic acid such as benzoic acid, citric acid, and/or the like). The ratio of tobacco leaves to tobacco stems can be based on the total desired amount of nicotine to be delivered, and can vary with the strain of tobacco used. Tobacco stems can provide a similar sensation to smoking when vaporized, but with a lower nicotine content. The carrier can be formed of vegetable glycerin, propylene glycol, and/or the like. In some implementations, the carrier can form 30-50% of the total weight of the vaporizable material 302. Because tobacco naturally includes some moisture, the percentage by weight of the carrier can be measured with respect to the dried weight of the vaporizable material (e.g., substantially free of water).

Including a carrier such as vegetable glycerin as at least 30% of the dried weight of the vaporizable material 302 can create a smoother inhalable aerosol and provide a unique experience to users that is more pleasant than smoking combustible cigarettes and other available heat-not-burn products. For example, cartridges 320 containing vaporizable material 302 with a carrier forming at least 30% of the dried weight of the vaporizable material 302 can allow for a lower temperature of vaporization (e.g., by approximately 100 degrees Celsius), and therefore less odor, higher flavor extraction efficiency, net reduction in HPHCs (harmful and potentially harmful constituents) such as via less charring, a more tunable experience, a more uniform vaporization of nicotine from tobacco over time, a faster heat up time (e.g., 10-15 seconds compared to 20-30 seconds, or more), and/or the like. In example implementations of the vaporizable material 302, the tobacco leaves and tobacco stems are in an approximately 1:1, 1:2, 2:3, 3:4, or 4:5 ratio and vegetable glycerin forms at least 30% of the dried weight of the vaporizable material 302, such as approximately 30%, 35%, 40%, 45%, or less than 50%. For example, in some implementations, the vaporizable material 302 includes tobacco leaves and tobacco stems in an approximately 1:1 ratio, and approximately 35% by weight (dried) of vegetable glycerin. Having a carrier in higher quantities can result in degradation of components of the vaporizer body 110, 120, such as the receptacle 118, 218 if not properly compensated for.

In some implementations, the heating element 342 can be formed of metal, such as aluminum, an aluminum alloy, copper, brass, zirconium, stainless steel (ferritic or non-ferritic), nickel, and/or the like. As described herein, aluminum is beneficial for spreading heat and stainless steel is better for localized heat. For an inductive heating approach, use of a non-magnetic material, such as aluminum, allows the creation of eddy currents in the susceptor heater, while a magnetic material, such as ferritic stainless steel, is inductively heated by a hysteresis mechanism. Different inductor coil arrangements are generally needed for these two heating approaches, which can have different requirements such as an amount of power required to generate an electromagnetic field. However, in some implementations, the heating element 342 is non-ferritic and non-magnetically permeable, which can simplify the design of the vaporizer device 100, 200 and allow for tighter control in heating of the heating element 342.

The heating element 342 can be formed of one or more pieces, and can define all, substantially all, or at least a portion of the walls that define the volume into which the vaporizable material 302 can be inserted. For example, the heating element 342 can form at least a portion of a bottom wall of the heater portion 341 (proximate the heater portion distal end 341b), a top wall of the heater portion 341 (proximate the heater portion proximal end 341a), and/or a perimeter along a length of the heater portion 341 (extending between the heater portion distal end 341b and the heater portion proximal end 341a). In implementations where the heating element 342 forms at least a portion of a bottom wall of the heater portion 341, this bottom wall can be the most distal portion of the heater portion 341 at the heater portion distal end 341b or can be offset from the heater portion distal end 341b such that it is not the most distal portion of the cartridge at the heater portion distal end 341b. In implementations where the heating element 342 forms at least a portion of a top wall of the heater portion 341, this top wall can be the most proximal portion of the heater portion 341 at the heater portion proximal end 341a or can be offset from the heater portion proximal end 341a such that it is not the most proximal portion of the cartridge at the heater portion proximal end 341a. Such bottom walls and/or top walls can include one or more perforations or other openings to allow for passage of air and/or vaporized material. In implementations where the heating element 342 forms at least a portion of a perimeter of the heater portion 341, the heating element 342 can be disposed inside and/or on an interior surface of the wrapper 322 or outside and/or on an exterior surface of the wrapper 322.

In some implementations, the heating element 342 can be formed from one or more sheets of metal that are configured to wrap (at least partially) around the perimeter of the heater portion 341. Where one or more sheets are used, the two ends of the heating element 342 sheet can meet or be in proximity to each other, at or near a joint location 345, as shown in FIG. 3, and optionally form a continuous loop. In some aspects, when assembled within the cartridge 320, a surface of the heating element 342 primarily facing towards and/or touching the vaporizable material 302 can be regarded as an interior face of the heating element 342 and a surface of the heating element 342 primarily facing away from and/or not touching the vaporizable material 302 can be regarded as an exterior face of the heating element 342. In some aspects, a joint location 345 can be regarded as a location or region, at or near an end of the heating element 342, such as where the end of the heating element 342 is at or near another end or another region of the heating element 342. When portions of the heating element 342 overlap, the joint location 345 can optionally be regarded as the overlapping portion, bounded in part by the ends of the heating element 342. Additionally or alternatively, in some aspects a joint location 345 can be regarded as a location or region, at or near where a joint is formed (e.g., via direct physical contact, welding, gluing, and/or the like) between two portions of the heating element 342.

In example implementations, the heating element(s) 342 can be made to include metal which is in a range of 50-150 μm thick, such as 50-100 μm thick, 60-80 μm thick, 70-90 μm thick, 75-85 μm thick, and optionally approximately 80 μm thick. In some implementations, the heating element(s) 342 can be made to include metal which is in a range of 3-15 μm thick, such as 5-10 μm thick, 6-8 μm thick, and optionally approximately 6.5 μm thick. In other implementations, the heating element(s) 342 can be made to include metal which is in a range of 200-800 nm thick, such as 200-400 nm thick, 300-500 nm thick, 400-600 nm thick, 400-800 nm thick, and/or the like. In some implementations, the heating element(s) 342 can be made to include metal which is backed with material(s) to increase rigidity, such as cardstock, corrugated material such as cardboard or paper, tobacco paper, temperature-resistant plastic, non-wood plant fibers such as flax, hemp, sisal, rice straw, and/or esparto, and/or the like. The total thickness of the heating element(s) 342 can be measured as an average thickness of the heating element(s) 342 when disassembled and/or flattened, and as either inclusive or exclusive of the thickness of any backing.

The metal can include an aluminum alloy, such as aluminum foil. In other implementations, the metal can include another alloy, such as invar. In some implementations, the heating element 342 can be formed of a cladded metal, which can take advantage of benefits of different metals. For example, the heating element 342 can comprise a cladding metal formed from an aluminum alloy and stainless steel, which could take advantage of the higher coupling efficiency of stainless steel and the higher heat transfer of aluminum. If a thinner metal is used, then increases in coupling efficiency and/or higher temperatures of the heating element 342 with lower total energy can be achieved. Additionally or alternatively, a thinner metal can be better suited for application of magnetic and/or electromagnetic energy at a higher frequency, such as greater than 1 MHz, greater than 5 MHz, greater than 15 MHz, greater than 20 MHz, or greater than 25 MHz.

As illustrated in FIG. 3, the mouthpiece portion 330 can include an insert 324 that is at least partially wrapped in a wrapper 322 or some other shell or layer of material. The insert 324 can be similar to the insert(s) 124 of FIGS. 1A-1B. For example, the insert 324 can be made of material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. The insert 324 and/or layer of material (e.g., wrapper 322) can extend between a mouthpiece portion proximal end 330a and a mouthpiece portion distal end 330b, and the total distance between these two ends can be referred to as the mouthpiece portion 330 length. Similar to the heater portion 341, the mouthpiece portion 330 can include a shorter mouthpiece portion 330 depth transverse to its length, and a longer mouthpiece portion 330 width that is transverse to both its length and depth. These dimensions can extend in the same axes as the heater portion 341.

As illustrated in FIG. 3, the insert 324 can include a plurality of airflow outlet channels 326 that extend from a plurality of corresponding vapor inlets 335 at the mouthpiece portion distal end 330b to a plurality of corresponding airflow outlets 328 at the mouthpiece portion proximal end 330a. The airflow outlet channels 326 thereby form a fluid connection between the heater portion 341 and the airflow outlets 328, such that vapor generated in the heater portion 341 can be drawn towards a user at the mouthpiece portion proximal end 330a, and ultimately out of the airflow outlets 328 as an inhalable aerosol. Proximate to the mouthpiece portion distal end 330b (at least more proximate than to the mouthpiece portion proximal end 330a), the insert 324 can further include a plurality of bypass channels 338 that each extend from a corresponding bypass air inlet to a corresponding bypass outlet, and thereby form a fluid connection between the airflow outlet channels 326 and ambient air. In some implementations, the airflow outlet channels 326 and/or the bypass channels 338 can be created via a laser-cutting operation through walls of the insert 324 during the manufacturing process. Although two airflow outlet channels 326 are illustrated, more or less airflow outlet channels 326 can be present. Although one insert 324 is illustrated as extending along a majority of the length of the mouthpiece portion 330, additional inserts 324 can be present and/or the insert(s) 324 can extend along less than half of the length of the mouthpiece portion 330.

The heater portion 341 can include one or more cartridge inlets (e.g., though-holes) at the heater portion distal end 341b configured to allow external air (i.e., external to the cartridge 320, such as ambient air) to enter the cartridge 320. In some aspects, the volume defined at least in part by the heating element 342 or otherwise including the heating element 342 can be referred to as a heater chamber, as it is a physically bound location in which heating is occurring. The heater chamber can be in fluid communication with the heater portion proximal end 341a, which can include one or more outlets. Accordingly, the one or more outlets at the heater portion proximal end 341a can be in fluid communication with the one or more cartridge inlets at the heater portion distal end 341b, via the heater chamber.

When a user draws on the mouthpiece portion 330 at the mouthpiece portion proximal end 330a, this can cause external air to enter one or more cartridge inlets (e.g., though-holes) at the heater portion distal end 341b and cause ambient air to enter and pass through the plurality of bypass channels 338 (when present) at approximately the same time. The external air that enters at the heater portion distal end 341b can subsequently pass through the vaporizable material 302 as it is heated to entrain the vaporized material (also referred to as “vapor”) generated within the heater chamber. Meanwhile, ambient air enters and passes through the plurality of bypass channels 338, entering an associated airflow outlet channel 326. The air that entrains the vaporized material 302 in the heater chamber (including the volume defined at least in part by the heating element 342) can subsequently pass through one or more outlets at the heater portion proximal end 341a and into the plurality of vapor inlets 335 at the mouthpiece portion distal end 330b, entering the plurality of airflow outlet channels 326. As the vapor and air from the heater portion 341 traverse the plurality of airflow outlet channels 326, they mix with the ambient air that entered through the plurality of bypass channels 338 (when present) to form an inhalable aerosol. The area in which the mixing and/or condensation occurs can be referred to as a condensation chamber. Accordingly, each of the plurality of airflow outlet channels 326 can include one or more condensation chambers configured to condense the entrained vapor with the ambient air to form at least a portion of the inhalable aerosol. For example, at least a part of one or more airflow outlet channels 326 can include one or more condensation chambers. The inhalable aerosol ultimately travels out of the airflow outlet(s) 328 at the mouthpiece portion proximal end 330a and into the mouth of a user. Collectively, the path of air, vapor, and inhalable aerosol within the cartridge 320 can be referred to as the airflow path of the cartridge 320. The overall airflow path of a vaporizer device that includes the cartridge 320 is further defined by the vaporizer body, which is described in greater detail below. Although the flow of “air” is described herein, depending on the location within or even outside of the cartridge 320, the “air” can contain other matter, such as gas-phase and/or condensed-phase material suspended in a stationary or moving mass of air or some other gas carrier (e.g., an aerosol), a liquid or solid at least partially transitioned to the gas phase (e.g., a vaporizable material), and/or the like.

In some implementations, more or less components and/or features can exist in the heater portion 341 and/or the mouthpiece portion 330, the components and/or features of the heater portion 341 and/or the mouthpiece portion 330 can be disposed in different locations and/or take different physical forms, and/or components of the heater portion 341 and the mouthpiece portion 330 can instead be present in the other portion 330, 341. Although illustrated as a generally flattened cylindrical shape, a cross-section of the mouthpiece portion 330 and/or the heater portion 341 can be a different shape. For example, in some implementations, a cross-section of the mouthpiece portion 330 and/or the heater portion 341 can be similar to one or more of the cross-sections of FIGS. 6A-6F. The cross-section can be anywhere between the respective distal and proximal ends of each of the mouthpiece portion 330 and/or the heater portion 341.

Among other things, various implementations of the vaporizer devices 100a-100c, 200, vaporizer body 110, 210, cartridges 120, 220, 320, and heating elements 142, 342 are described in greater detail below. For example, FIGS. 4A-4B illustrate cross-sectional schematics of an example implementation of a vaporizer device 400 consistent with implementations of the current subject matter. For purposes of simplicity only, certain components of the vaporizer device 400 are not illustrated. Implementations of the vaporizer device 400 can include or more components of the vaporizer devices 100a-100c of FIGS. 1A-1C, the vaporizer device 200 of FIG. 2, the cartridge 320 of FIG. 3, and the holder assemblies 558a-558d of FIGS. 5A-5D.

As illustrated in FIGS. 4A-4B, the vaporizer device 400 can include a vaporizer body 410 and a cartridge 420 containing a vaporizable material 402 and one or more heating element 442. The cross-section of the vaporizer device 400 illustrated in FIG. 4A is taken along the length and width of the vaporizer device (y-axis and x-axis), whereas the cross-section of the vaporizer device 400 illustrated in FIG. 4B is taken along the length and depth of the vaporizer device (y-axis and z-axis). As illustrated, the vaporizer body 410 can include a holder assembly 458 and one or more sensors 413 (which can be part of or separate from the holder assembly 458). The holder assembly 458 can include a frame 447 defining a receptacle 418. The receptacle can optionally include a plurality of ridges or other features for retaining the cartridge 420 within the receptacle, such as by applying force against a region of the heater portion 441 that does not include a heating element 442. As illustrated in FIG. 4A, external to the frame 447 and the receptacle 418, the holder assembly 458 can include or otherwise be coupled to one or more inductors 443 and/or one or more flux concentrators 448. In some implementations, each of the one or more inductors 443 can include an inductive coil configured to generate an electromagnetic field. When the one or more heating element 442 receives the electromagnetic field, they can be configured to convert the current to heat, in order to heat the vaporizable material 402. In some implementations, each of the one or more flux concentrators 448 can include a magnetic material (e.g., ferritic material) configured to control and/or direct an electromagnetic field, generated by a respective inductor 443, such as by changing magnetic properties of the field. In some implementations, each of the one or more flux concentrators 448 can include a nanocrystal material, a nanometal material, and/or the like. In some implementations the inductor(s) 443 and/or flux concentrator(s) 448 can be secured to or on the frame 447.

As illustrated, the cartridge 420 can include a mouthpiece portion 430 and a heater portion 441 within one or more layers of material (illustrated as wrapper(s) 422). The cartridge 420 can extend between a cartridge proximal end 420a and a cartridge distal end 420b, with the dimension between the two being the cartridge 420 length. Transverse to the cartridge 420 length (along the y-axis) and illustrated in FIG. 4A (from the left to the right) is the cartridge 420 depth (along the z-axis). Transverse to both the cartridge 420 length and depth, and as illustrated in FIG. 4B (from the left to the right) is the cartridge 420 width (along the x-axis).

The heater portion 441 can include one or more heating element 442 configured to heat the vaporizable material 402 of the cartridge 420 to generate a vapor. As described herein, the heat can be generated through inductive means, and apply heat to the vaporizable material 402 by conductive and/or convective heating. For example, eddy currents can be induced in the heating element(s) 442 via induction, which in turn causes the heating element(s) 442 to heat up. If the vaporizable material 402 is in direct contact with the heating element(s) 442, then the vaporizable material 402 can be heated via conductive heating at the points of direct contact. Additionally and/or alternatively, the heat produced by the heating element(s) 442 can be picked up by air passing along or near the heating element(s) 442 and distribute the heat to portions of the vaporizable material 402 that are not in physical contact with the heating element(s) 442, thereby heating the vaporizable material 402 via convective heating. The volume within which the vaporizable material 402 is held can be regarded as a heater chamber. For example, the heating element(s) 442 can define at least a portion of a perimeter of a heater chamber containing the vaporizable material 402, and in some implementations define substantially all of the perimeter. Arrows shown extending from the heating element(s) 442 can indicate a direction of heat flow and/or heat transfer from the heating element(s) 442, such as the opposing sets of horizontal arrows extending from the heating element(s) 442 and directed towards a center of the heating chamber and/or towards a center of the vaporizable material 402. As shown in FIGS. 4A-4B, arrows that are not extending from the heating element(s) 442 can indicate a direction of fluid flow (e.g., airflow, inhalable aerosol, etc.) and/or a fluid pathway (e.g., airflow pathway, inhalable aerosol pathway, etc.).

The heater portion 441 can include an end cap (e.g., the illustrated first insert(s) 424a) proximate the cartridge distal end 420b to hold the vaporizable material 402 therein and/or define a lower boundary of the volume (e.g., heater chamber). However, in some implementations, the vaporizable material 402 can be formed with sufficient rigidity (e.g., in the form of a puck or another pre-formed shape) that an end cap is not necessary. In the event first insert(s) 424a are included, they can include one or more cartridge inlets and/or an air-permeable material such that ambient air can enter the heater chamber through the material. The first insert(s) 424a be regarded as a filter end cap, and/or include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. For example, the end cap can include corrugated paper material that is pressed or formed to fit within a region at the cartridge distal end 420b.

As illustrated between FIGS. 4A-4B, the mouthpiece portion 430 can include one or more second inserts 424b. The one or more second inserts 424b can include airflow outlet(s) 428, which can take the form of a cutout or other aperture (e.g., formed via laser-cutting, molding, pre-formed holes, and/or the like, as described herein). The one or more second inserts 424b can be disposed proximate the proximal end 420a of the cartridge 420.

The cartridge 420 can optionally include first and second bypass channels 438a, 438b forming a fluid connection between the second airflow outlet channel 426b and ambient air. As illustrated, the first and second bypass channels 438a, 438b can be formed through opposing long sides of the wrapper 422. In some implementations, the bypass channels 438 can be created via a laser-cutting operation through walls of the wrapper 422 during the manufacturing process. Instead of one bypass channel 438 on each of the opposing long sides of the wrapper 422, it will be appreciated that additional bypass channels 438 can be present, that the bypass channels 438 can be disposed in different locations (e.g., on one or both of the short sides of the cartridge 420), and/or different numbers of bypass channels 438 can be located on opposing sides of the cartridge 420, including only having one or more bypass channels 438 on one side of the cartridge 420.

As further illustrated, the cartridge 420 can optionally include a divider 454 that is configured to restrict movement of the vaporizable material 402. The divider 454 can include a proximal end (or upstream end), an opposing distal end (or downstream end), and a boundary that extends between the two ends (e.g., along a perimeter of the divider 454, where the perimeter can optionally be substantially the same dimensions at each end). At least a portion of the boundary of the divider 454 can be in contact with a layer of material (e.g., wrapper 422) such that the divider 454 is held in place within the cartridge 420.

The divider 454 can be proximate the intersection of the mouthpiece portion 430 and the heater portion 441. The divider 454 can be disposed closer along the cartridge 420 length to the cartridge distal end 420b or the cartridge proximal end 420a. In some implementations, the divider 454 can extend out of the distal end of the mouthpiece portion 430 such that it can couple with and/or be inserted within the heater portion 441. The divider 454 can be regarded as part of the mouthpiece portion 430 only, as part of both the mouthpiece portion 430 and the heater portion 441, or as part of an intermediate divider portion disposed between the mouthpiece portion 430 and the heater portion 441. In some implementations, at least a portion of the divider 454 or divider portion can be disposed within the receptacle 418 when the cartridge 420 is inserted into the vaporizer body 410 and/or at least a portion of the divider portion can be disposed outside of the receptacle 418 when the cartridge 420 is inserted into the vaporizer body 410.

The boundary (e.g., outer walls) of the divider 454, parallel to the longitudinal axis of the cartridge 420, are illustrated as only extending partially within the mouthpiece portion 430 (e.g., spaced apart from the second filter 424b). However, in some implementations the boundary of the divider 454 can extend along a majority of the mouthpiece portion 430 (e.g., with the second filter 424b disposed adjacent the proximal end of the divider 454 and the vaporizable material 402 disposed adjacent the distal end of the divider 454). This extended boundary of the divider 454 can increase the overall durability and rigidity of the cartridge 420, especially in the region proximate the divider 454, which can be partially inserted into the receptacle 418 and/or in contact with one or more ridges of the receptacle 418 in some implementations. However, a divider 454 that does not extend all the way from adjacent the second filter 424b to adjacent the vaporizable material 402 can provide sufficient durability and rigidity to the cartridge 420 while also saving on manufacturing costs and complexity. Accordingly, in some implementations, the divider 454 can extend less than 50% of the distance between the second filter 424b (or cartridge proximal end 420a) and the vaporizable material 402 along the longitudinal axis of the cartridge 420, less than 40% of the same distance, less than 30% of the same distance, and/or the like.

The divider 454 can include at least one first airflow outlet channel 426a, through which vaporized vaporizable material 402 and air from the heater chamber can pass and at least partially condense into an inhalable aerosol. The at least one first airflow outlet channel 426a can form or be defined by an interior perimeter of the divider 454. In some implementations the divider 454 can include a solid or partially solid volume at the upstream end of the divider 454. For example, the divider 454 can include grates, a mesh material, filter, and/or the like at the upstream end of the divider 454. In such implementations, the grates, mesh, filter, etc. can be in fluid communication with the at least one first airflow outlet channel 426a and/or form a plurality of first airflow outlet channels 426a at least partially through the divider 454. The at least one first airflow outlet channel 426a can be in fluid communication with at least one second airflow outlet channel 426b.

After exiting the least one first airflow outlet channel 426a and entering the at least one second airflow outlet channel 426b, the vaporized vaporizable material 402 and air can further condense into an inhalable aerosol. Thereby, vapor generated in the heater portion 441 can be drawn towards a user at the cartridge proximal end 420a, and ultimately out of the airflow outlet(s) 428 as an inhalable aerosol. When bypass channels 438 are present, ambient air can enter the second airflow outlet channel 426b through the bypass channels 438 to further promote nucleation. As illustrated, the second airflow outlet channel 426b includes a larger volume of space compared to the first airflow outlet channel 426a, which can promote nucleation and aerosol formation in a manner. This interior volume of the mouthpiece portion 430 can be defined as a space between the second filter 424b (or cartridge proximal end 420a) and the proximal end of the divider 454, within the interior perimeter of the wrapper 422. In some implementations, the second airflow outlet channel 426b can include a larger, open volume (e.g., condensation chamber) downstream of the first airflow outlet channel 426b and upstream of the second airflow outlet(s) 428b (e.g., proximate the cartridge proximal end 420a),

When a user draws on the mouthpiece portion 430 at the cartridge proximal end 420a, this can cause ambient air to enter the receptacle 418 of the vaporizer body 410 at the airflow inlets 434, cause the air residing in the receptacle 418 to enter one or more inlets at the cartridge distal end 420b, and cause ambient air to pass through the bypass channel(s) 438 (when present) into the second airflow outlet channel(s) 426b at the same time. The air that enters the receptacle 418 from the airflow inlets 434 can travel along the airflow inlet path 432 to the cartridge distal end 420a, where it can flow into the one or more cartridge inlets located there.

The air that enters at the cartridge distal end 420b can subsequently pass through the vaporizable material 402 as it is heated to entrain the vaporized material generated within the heater chamber. The air that entrains the vaporized material in the heater chamber can subsequently pass into the first airflow outlet channel(s) 426a. As the vapor and air from the heater portion 441 traverse the first airflow outlet channel(s) 426a, they continue to mix to form an inhalable aerosol. The vapor and air pass through the first airflow outlet channel(s) 426a and into the second airflow outlet channel(s) 426b, where they can they mix with the air present in the second airflow outlet channel(s) 426b and/or ambient air that enters through the bypass channel(s) 438 to continue forming the inhalable aerosol. Ultimately, the inhalable aerosol passes through the airflow outlet(s) 428 and/or the cartridge proximal end 420a where it is inhaled by the user. Collectively, the path of air, vapor, and inhalable aerosol through the vaporizer device 400 can be referred to as the airflow path of the vaporizer device 400.

In some implementations, the cartridge 420 can be assembled by inserting at least a portion of the components of the cartridge 420 into a pre-formed wrapper 422 and/or by wrapping a wrapper 422 around at least a portion of the components of the cartridge 420. For example, the components of the cartridge 420 can be inserted into the wrapper 422 starting from the first insert(s) 424a at the cartridge distal end 420b, the heating element(s) 442, the vaporizable material 402, then the divider 454, and ending with the second insert(s) 424b at the cartridge proximal end 420a. When the heating element(s) 442 are disposed on the outer surface of the wrapper 422, the heating element(s) 442 can be attached to and/or around the outer surface of the wrapper 422 before any component is inserted into the wrapper 422 or after the components are inserted into the wrapper 422. When the bypass channel(s) 438 are present, they can be formed in the wrapper 422 before any component is inserted into the wrapper 422 or after the components are inserted into the wrapper 422. In some implementations, the cartridge can include more than one wrapper 422, such as a primary wrapper that includes the first insert 424a, the heating element(s) 442, the vaporizable material 402, and/or the divider 454, as well as a secondary (e.g., tipping) wrapper 422 that includes the second insert 424b and/or divider 454. The primary wrapper 422 and secondary wrapper 422 can be combined to simplify the manufacture of the cartridge 420 such that the components can be inserted over shorter distances and/or in a more controlled manner.

Other implementations exist where the cartridge 420 can be heated externally by conductive and/or convective heat. For example, rather than the heater portion 441 of the cartridge including the heating element(s) 442, the heater portion 441 can instead include a container configured to hold the vaporizable material 402. The container can take the form (e.g., material and/or geometry) of the heater chambers described herein, but is instead configured to receive heat from one or more external heating element 442 (e.g., external to the cartridge 420, such as within the receptacle 418 or otherwise configured to heat the receptacle 418 itself) and redistribute the heat to the vaporizable material 402, rather than generate heat independently. In such implementations, the heating element(s) 442 can be inductively heated as described herein.

The one or more sensors 413 can include one or more pressure sensors, airflow sensors, accelerometers, temperature sensors, measurement circuitry configured to measure properties of the various components of the vaporizer body 410 and/or cartridge 420, and/or the like. When present, the pressure sensor can be configured to detect changes in pressure that occur along the airflow path of the vaporizer device 400, optionally including an absolute pressure within the airflow path and/or a differential pressure between the airflow path and ambient pressure. Additionally or alternatively, when present, the airflow sensor can be configured to detect air flowing along the airflow path of the vaporizer device 400, optionally including a measurement of a rate of airflow along the airflow path. When present, the temperature sensor(s) can be configured to detect an orientation of the vaporizer body 410, which can be referenced to determine whether or not the vaporizer body 410 is in an orientation indicative consistent with an intended use of the vaporizer device 400. When present, the temperature sensor(s) can be configured to detect a temperature of the cartridge 420, heating element(s) 442, receptacle 418, frame 447, inductor(s) 443, flux concentrator(s) 448, and/or other components of the vaporizer body 410 and/or cartridge 420. The temperature sensor(s) can be physically touching and/or in thermal proximity to any component for which a temperature is desired.

Detected pressure drops, increases in airflow, and/or other measurements can be used to determine when a user is inhaling, which can in turn be used to control the power applied to the inductor(s) and/or heating element(s) 442 to decrease, maintain, or increase the temperature of the heating element(s) 442 and/or vaporizable material 402. Additionally or alternatively, the detected pressure drops, increases in airflow, and/or other measurements can be used to count the number of puffs taken, which can in turn be used for other operations, such as stopping the application of power to the heating element(s) 442 (e.g., placing the vaporizer device 400 in a sleep or off state).

In some implementations, the one or more sensors 413 can include measurement circuitry configured to derive one or more properties of the heating element(s) 442 and/or inductor(s) 443, such as inductance, resistance, impedance, and/or temperature. In some aspects, the measurement circuitry can include circuitry configured to directly measure the one or more properties and/or circuitry configured to estimate the one or more properties based on other data (e.g., obtained via direct measurement, obtained via processed and/or filtered measurement data or signals, obtained from memory, and/or the like). The resistance and/or inductance of the heating element(s) 442, for example, can be used to estimate the temperature of the heating element(s). The inductance, resistance, impedance, and/or temperature can be used to maintain and/or alter the application of power to the heating element(s) 442, such as to achieve a target temperature. For example, altering the application of power can include increasing or decreasing the total power applied to the inductor(s) 443 and/or heating element(s) 442, increasing or decreasing the voltage applied to the inductor(s) 443 and/or heating element(s) 442, increasing or decreasing the frequency at which power is applied to the inductor(s) 443 and/or heating element(s) 442, increasing or decreasing the time during which power is applied to the inductor(s) 443 and/or heating element(s) 442, adjusting a duty cycle of power applied to the inductor(s) 443 and/or heating element(s) 442, and/or the like.

As illustrated in FIGS. 4A-4B, the vaporizer device 400 can include a vaporizer body 410 and a cartridge 420 containing a vaporizable material 402 and one or more heating element 442. The cross-section of the vaporizer device 400 illustrated in FIG. 4A is taken along the length and width of the vaporizer device (y-axis and x-axis), whereas the cross-section of the vaporizer device 400 illustrated in FIG. 4B is taken along the length and depth of the vaporizer device (y-axis and z-axis). As illustrated, the vaporizer body 410 can include a holder assembly 458 and one or more sensors 413 (which can be part of or separate from the holder assembly 458). The holder assembly 458 can include a frame 447 defining a receptacle 418. The receptacle can optionally include a plurality of ridges or other features for retaining the cartridge 420 within the receptacle, such as by applying force against a region of the heater portion 441 that does not include a heating element 442. As illustrated in FIG. 4A, external to the frame 447 and the receptacle 418, the holder assembly 458 can include or otherwise be coupled to one or more inductors 443 and/or one or more flux concentrators 448. In some implementations, each of the one or more inductors 443 can include an inductive coil configured to generate an electromagnetic field. When the one or more heating element 442 receives the electromagnetic field, they can be configured to convert the current to heat, in order to heat the vaporizable material 402. In some implementations, each of the one or more flux concentrators 448 can include a magnetic material (e.g., ferritic material) configured to control and/or direct an electromagnetic field, generated by a respective inductor 443, such as by changing magnetic properties of the field. In some implementations, each of the one or more flux concentrators 448 can include a nanocrystal material, a nanometal material, and/or the like. In some implementations the inductor(s) 443 and/or flux concentrator(s) 448 can be secured to or on the frame 447.

As illustrated, the cartridge 420 can include a mouthpiece portion 430 and a heater portion 441 within one or more layers of material (illustrated as wrapper(s) 422). The cartridge 420 can extend between a cartridge proximal end 420a and a cartridge distal end 420b, with the dimension between the two being the cartridge 420 length. Transverse to the cartridge 420 length (along the y-axis) and illustrated in FIG. 4A (from the left to the right) is the cartridge 420 depth (along the z-axis). Transverse to both the cartridge 420 length and depth, and as illustrated in FIG. 4B (from the left to the right) is the cartridge 420 width (along the x-axis).

The heater portion 441 can include one or more heating element 442 configured to heat the vaporizable material 402 of the cartridge 420 to generate a vapor. As described herein, the heat can be generated through inductive means, and apply heat to the vaporizable material 402 by conductive and/or convective heating. For example, eddy currents can be induced in the heating element(s) 442 via induction, which in turn causes the heating element(s) 442 to heat up. If the vaporizable material 402 is in direct contact with the heating element(s) 442, then the vaporizable material 402 can be heated via conductive heating at the points of direct contact. Additionally and/or alternatively, the heat produced by the heating element(s) 442 can be picked up by air passing along or near the heating element(s) 442 and distribute the heat to portions of the vaporizable material 402 that are not in physical contact with the heating element(s) 442, thereby heating the vaporizable material 402 via convective heating. The volume within which the vaporizable material 402 is held can be regarded as a heater chamber. For example, the heating element(s) 442 can define at least a portion of a perimeter of a heater chamber containing the vaporizable material 402, and in some implementations define substantially all of the perimeter. Arrows shown extending from the heating element(s) 442 can indicate a direction of heat flow and/or heat transfer from the heating element(s) 442, such as the opposing sets of horizontal arrows extending from the heating element(s) 442 and directed towards a center of the heating chamber and/or towards a center of the vaporizable material 402. As shown in FIGS. 4A-4B, arrows that are not extending from the heating element(s) 442 can indicate a direction of fluid flow (e.g., airflow, inhalable aerosol, etc.) and/or a fluid pathway (e.g., airflow pathway, inhalable aerosol pathway, etc.).

The heater portion 441 can include an end cap (e.g., the illustrated first insert(s) 424a) proximate the cartridge distal end 420b to hold the vaporizable material 402 therein and/or define a lower boundary of the volume (e.g., heater chamber). However, in some implementations, the vaporizable material 402 can be formed with sufficient rigidity (e.g., in the form of a puck or another pre-formed shape) that an end cap is not necessary. In the event first insert(s) 424a are included, they can include one or more cartridge inlets and/or an air-permeable material such that ambient air can enter the heater chamber through the material. The first insert(s) 424a be regarded as a filter end cap, and/or include material such as one or more of paper material such as cardstock, corrugated material such as cardboard or paper, tobacco paper, temperature-resistant plastic (e.g., PET), cellulose acetate, non-wood plant fibers such as flax, hemp, sisal, rice straw, and/or esparto, and/or the like. For example, the end cap can include corrugated paper material that is pressed or formed to fit within a region at the cartridge distal end 420b.

As illustrated between FIGS. 4A-4B, the mouthpiece portion 430 can include one or more second inserts 424b. The one or more second inserts 424b can include airflow outlet(s) 428, which can take the form of a cutout or other aperture (e.g., formed via laser-cutting, molding, pre-formed holes, and/or the like, as described herein). The one or more second inserts 424b can be disposed proximate the proximal end 420a of the cartridge 420.

The cartridge 420 can optionally include first and second bypass channels 438a, 438b forming a fluid connection between the second airflow outlet channel 426b and ambient air. As illustrated, the first and second bypass channels 438a, 438b can be formed through opposing long sides of the wrapper 422. In some implementations, the bypass channels 438 can be created via a laser-cutting operation through walls of the wrapper 422 during the manufacturing process. Instead of one bypass channel 438 on each of the opposing long sides of the wrapper 422, it will be appreciated that additional bypass channels 438 can be present, that the bypass channels 438 can be disposed in different locations (e.g., on one or both of the short sides of the cartridge 420), and/or different numbers of bypass channels 438 can be located on opposing sides of the cartridge 420, including only having one or more bypass channels 438 on one side of the cartridge 420.

As further illustrated, the cartridge 420 can optionally include a divider 454 that is configured to restrict movement of the vaporizable material 402. The divider 454 can include a proximal end (or upstream end), an opposing distal end (or downstream end), and a boundary that extends between the two ends (e.g., along a perimeter of the divider 454, where the perimeter can optionally be substantially the same dimensions at each end). At least a portion of the boundary of the divider 454 can be in contact with a layer of material (e.g., wrapper 422) such that the divider 454 is held in place within the cartridge 420.

The divider 454 can be proximate the intersection of the mouthpiece portion 430 and the heater portion 441. The divider 454 can be disposed closer along the cartridge 420 length to the cartridge distal end 420b or the cartridge proximal end 420a. In some implementations, the divider 454 can extend out of the distal end of the mouthpiece portion 430 such that it can couple with and/or be inserted within the heater portion 441. The divider 454 can be regarded as part of the mouthpiece portion 430 only, as part of both the mouthpiece portion 430 and the heater portion 441, or as part of an intermediate divider portion disposed between the mouthpiece portion 430 and the heater portion 441. In some implementations, at least a portion of the divider 454 or divider portion can be disposed within the receptacle 418 when the cartridge 420 is inserted into the vaporizer body 410 and/or at least a portion of the divider portion can be disposed outside of the receptacle 418 when the cartridge 420 is inserted into the vaporizer body 410.

The boundary (e.g., outer walls) of the divider 454, parallel to the longitudinal axis of the cartridge 420, are illustrated as only extending partially within the mouthpiece portion 430 (e.g., spaced apart from the second filter 424b). However, in some implementations the boundary of the divider 454 can extend along a majority of the mouthpiece portion 430 (e.g., with the second filter 424b disposed adjacent the proximal end of the divider 454 and the vaporizable material 402 disposed adjacent the distal end of the divider 454). This extended boundary of the divider 454 can increase the overall durability and rigidity of the cartridge 420, especially in the region proximate the divider 454, which can be partially inserted into the receptacle 418 and/or in contact with one or more ridges of the receptacle 418 in some implementations. However, a divider 454 that does not extend all the way from adjacent the second filter 424b to adjacent the vaporizable material 402 can provide sufficient durability and rigidity to the cartridge 420 while also saving on manufacturing costs and complexity. Accordingly, in some implementations, the divider 454 can extend less than 50% of the distance between the second filter 424b (or cartridge proximal end 420a) and the vaporizable material 402 along the longitudinal axis of the cartridge 420, less than 40% of the same distance, less than 30% of the same distance, and/or the like.

The divider 454 can include at least one first airflow outlet channel 426a, through which vaporized vaporizable material 402 and air from the heater chamber can pass and at least partially condense into an inhalable aerosol. The at least one first airflow outlet channel 426a can form or be defined by an interior perimeter of the divider 454. In some implementations the divider 454 can include a solid or partially solid volume at the upstream end of the divider 454. For example, the divider 454 can include grates, a mesh material, filter, and/or the like at the upstream end of the divider 454. In such implementations, the grates, mesh, filter, etc. can be in fluid communication with the at least one first airflow outlet channel 426a and/or form a plurality of first airflow outlet channels 426a at least partially through the divider 454. The at least one first airflow outlet channel 426a can be in fluid communication with at least one second airflow outlet channel 426b.

After exiting the least one first airflow outlet channel 426a and entering the at least one second airflow outlet channel 426b, the vaporized vaporizable material 402 and air can further condense into an inhalable aerosol. Thereby, vapor generated in the heater portion 441 can be drawn towards a user at the cartridge proximal end 420a, and ultimately out of the airflow outlet(s) 428 as an inhalable aerosol. When bypass channels 438 are present, ambient air can enter the second airflow outlet channel 426b through the bypass channels 438 to further promote nucleation. As illustrated, the second airflow outlet channel 426b includes a larger volume of space compared to the first airflow outlet channel 426a, which can promote nucleation and aerosol formation in a manner. This interior volume of the mouthpiece portion 430 can be defined as a space between the second filter 424b (or cartridge proximal end 420a) and the proximal end of the divider 454, within the interior perimeter of the wrapper 422. In some implementations, the second airflow outlet channel 426b can include a larger, open volume (e.g., condensation chamber) downstream of the first airflow outlet channel 426b and upstream of the second airflow outlet(s) 428b (e.g., proximate the cartridge proximal end 420a),

When a user draws on the mouthpiece portion 430 at the cartridge proximal end 420a, this can cause ambient air to enter the receptacle 418 of the vaporizer body 410 at the airflow inlets 434, cause the air residing in the receptacle 418 to enter one or more inlets at the cartridge distal end 420b, and cause ambient air to pass through the bypass channel(s) 438 (when present) into the second airflow outlet channel(s) 426b at the same time. The air that enters the receptacle 418 from the airflow inlets 434 can travel along the airflow inlet path 432 to the cartridge distal end 420a, where it can flow into the one or more cartridge inlets located there.

The air that enters at the cartridge distal end 420b can subsequently pass through the vaporizable material 402 as it is heated to entrain the vaporized material generated within the heater chamber. The air that entrains the vaporized material in the heater chamber can subsequently pass into the first airflow outlet channel(s) 426a. As the vapor and air from the heater portion 441 traverse the first airflow outlet channel(s) 426a, they continue to mix to form an inhalable aerosol. The vapor and air pass through the first airflow outlet channel(s) 426a and into the second airflow outlet channel(s) 426b, where they can they mix with the air present in the second airflow outlet channel(s) 426b and/or ambient air that enters through the bypass channel(s) 438 to continue forming the inhalable aerosol. Ultimately, the inhalable aerosol passes through the airflow outlet(s) 428 and/or the cartridge proximal end 420a where it is inhaled by the user. Collectively, the path of air, vapor, and inhalable aerosol through the vaporizer device 400 can be referred to as the airflow path of the vaporizer device 400.

In some implementations, the cartridge 420 can be assembled by inserting at least a portion of the components of the cartridge 420 into a pre-formed wrapper 422 and/or by wrapping a wrapper 422 around at least a portion of the components of the cartridge 420. For example, the components of the cartridge 420 can be inserted into the wrapper 422 starting from the first insert(s) 424a at the cartridge distal end 420b, the heating element(s) 442, the vaporizable material 402, then the divider 454, and ending with the second insert(s) 424b at the cartridge proximal end 420a. When the heating element(s) 442 are disposed on the outer surface of the wrapper 422, the heating element(s) 442 can be attached to and/or around the outer surface of the wrapper 422 before any component is inserted into the wrapper 422 or after the components are inserted into the wrapper 422. When the bypass channel(s) 438 are present, they can be formed in the wrapper 422 before any component is inserted into the wrapper 422 or after the components are inserted into the wrapper 422. In some implementations, the cartridge can include more than one wrapper 422, such as a primary wrapper that includes the first insert 424a, the heating element(s) 442, the vaporizable material 402, and/or the divider 454, as well as a secondary (e.g., tipping) wrapper 422 that includes the second insert 424b and/or divider 454. The primary wrapper 422 and secondary wrapper 422 can be combined to simplify the manufacture of the cartridge 420 such that the components can be inserted over shorter distances and/or in a more controlled manner.

Other implementations exist where the cartridge 420 can be heated externally by conductive and/or convective heat. For example, rather than the heater portion 441 of the cartridge including the heating element(s) 442, the heater portion 441 can instead include a container configured to hold the vaporizable material 402. The container can take the form (e.g., material and/or geometry) of the heater chambers described herein, but is instead configured to receive heat from one or more external heating element 442 (e.g., external to the cartridge 420, such as within the receptacle 418 or otherwise configured to heat the receptacle 418 itself) and redistribute the heat to the vaporizable material 402, rather than generate heat independently. In such implementations, the heating element(s) 442 can be inductively heated as described herein.

The one or more sensors 413 can include one or more pressure sensors, airflow sensors, accelerometers, temperature sensors, measurement circuitry configured to measure properties of the various components of the vaporizer body 410 and/or cartridge 420, and/or the like. When present, the pressure sensor can be configured to detect changes in pressure that occur along the airflow path of the vaporizer device 400, optionally including an absolute pressure within the airflow path and/or a differential pressure between the airflow path and ambient pressure. Additionally or alternatively, when present, the airflow sensor can be configured to detect air flowing along the airflow path of the vaporizer device 400, optionally including a measurement of a rate of airflow along the airflow path. When present, the temperature sensor(s) can be configured to detect an orientation of the vaporizer body 410, which can be referenced to determine whether or not the vaporizer body 410 is in an orientation indicative consistent with an intended use of the vaporizer device 400. When present, the temperature sensor(s) can be configured to detect a temperature of the cartridge 420, heating element(s) 442, receptacle 418, frame 447, inductor(s) 443, flux concentrator(s) 448, and/or other components of the vaporizer body 410 and/or cartridge 420. The temperature sensor(s) can be physically touching and/or in thermal proximity to any component for which a temperature is desired.

Detected pressure drops, increases in airflow, and/or other measurements can be used to determine when a user is inhaling, which can in turn be used to control the power applied to the inductor(s) and/or heating element(s) 442 to decrease, maintain, or increase the temperature of the heating element(s) 442 and/or vaporizable material 402. Additionally or alternatively, the detected pressure drops, increases in airflow, and/or other measurements can be used to count the number of puffs taken, which can in turn be used for other operations, such as stopping the application of power to the heating element(s) 442 (e.g., placing the vaporizer device 400 in a sleep or off state).

In some implementations, the one or more sensors 413 can include measurement circuitry configured to derive one or more properties of the heating element(s) 442 and/or inductor(s) 443, such as inductance, resistance, impedance, and/or temperature. In some aspects, the measurement circuitry can include circuitry configured to directly measure the one or more properties and/or circuitry configured to estimate the one or more properties based on other data (e.g., obtained via direct measurement, obtained via processed and/or filtered measurement data or signals, obtained from memory, and/or the like). The resistance and/or inductance of the heating element(s) 442, for example, can be used to estimate the temperature of the heating element(s). The inductance, resistance, impedance, and/or temperature can be used to maintain and/or alter the application of power to the heating element(s) 442, such as to achieve a target temperature. For example, altering the application of power can include increasing or decreasing the total power applied to the inductor(s) 443 and/or heating element(s) 442, increasing or decreasing the voltage applied to the inductor(s) 443 and/or heating element(s) 442, increasing or decreasing the frequency at which power is applied to the inductor(s) 443 and/or heating element(s) 442, increasing or decreasing the time during which power is applied to the inductor(s) 443 and/or heating element(s) 442, adjusting a duty cycle of power applied to the inductor(s) 443 and/or heating element(s) 442, and/or the like.

However, in some implementations, the default duty cycle can be defined to apply power during the entire cycle of time (e.g., 50 ms out of each 50 ms), with measurements being taken at predetermined intervals (e.g., at the beginning or end of each duty cycle) regardless of whether power is being applied to the heating element(s) 442. The default duty cycle can be adjusted to include a period of time during which power is not applied during the duty cycle, based on the measured or derived value(s). This can be achieved, for example, by providing separate driving circuitry (e.g., including one or more inductors 443) and measurement circuitry as described herein (e.g., including a sensor 413 and/or an inductor 443 via which one or more properties of the heating element(s) 442 and/or inductor(s) 443 can be derived). Although temperature control can be achieved based on controlling the application of power to the heating element(s) 442 according to duty cycles as described herein, additionally or alternatively temperature control can be achieved based on controlling the voltage applied to the inductor(s) 443 and/or heating element(s) 442, the frequency applied to the inductor(s) 443 and/or heating element(s) 442, and/or the like.

In some implementations, a Curie temperature of the heating element(s) 442 can be utilized to maintain heat applied to the vaporizable material 402 in a particular range. A Curie temperature of an object can be regarded as a temperature at which particles of the object are substantially non-magnetic. For example, in implementations where the heating element(s) 442 is made of a nickel and iron alloy (e.g., Invar), the heating element(s) 442 can be configured such that it does not reach higher than a known temperature (e.g., 240° C). As such, the heating element(s) 442 can be regarded as self-regulating. Otherwise, the existence of metals with a known Curie temperature can be factored into the heater control methodologies described herein. For example, in some implementations, a controller 104 and/or other circuitry can be configured to monitor the heating element(s) 442 magnetic properties as it is transitioning to its Curie temperature, and regulate the heating element(s) 442 such that it stays at or near its Curie temperature. For example, the controller 104 can be configured to decrease the application of power and/or energy to the heating element(s) 442 when it is at or near its Curie temperature such that additional power and/or energy is not wasted.

In various implementations, depending on the shape of the heating element(s) 442, multiple inductors 443 can be used to heat the heating element(s) 442. For example, one inductor 443 can be used to generate an electromagnetic field to heat each of two opposing long sides of the heating element(s) 442. In other implementations, sets of two, three, four, five, six, or more inductors 443 can be used to generate electromagnetic fields to each heat two opposing long sides of the heating element(s) 442 (see FIGS. 5A-5D for examples of the physical construction and/or locations of the inductors 443).

When multiple inductors 443 are implemented, each can be configured to operate at the same frequency and/or different frequencies. For example, in some implementations all of the inductors 443 can be configured, via their structure and/or corresponding circuitry such as a controller 104, to operate at substantially the same operating frequency, which can change over time. All of the inductors 443 can be configured to operate at a first frequency when power is not being applied to heat the heating element(s) 442 (which can be 0 Hz), at a second frequency when power is being applied to derive one or more properties of the heating element(s) 442 and/or inductor(s) 443 (e.g., during a measurement mode, a standby mode, a normal power mode, and/or the like), and/or at a third frequency when power is being applied to heat the heating element(s) 442 (e.g., in a normal power mode).

In other implementations, one or more of the inductors 443 can be configured to operate at a different frequency or frequencies from the remaining inductors 443. In accordance with these implementations, the inductors 443 can be configured to operate at substantially the same frequency during certain times or modes while also being configured to operate at different frequencies during certain other times or modes. With each of the inductors 443 being positioned near different portions of the heating element(s) 442, information derived from the inductor 443 (or coils) operating at a different frequency can be used to derive additional information about the heating element(s) 442.

Although various frequencies and modes are discussed with respect to the inductors 443 specifically, it is contemplated that other measurement circuitry, such as one or more of the sensing coils 513 discussed with respect to FIGS. 5A-5D can optionally be provided and configured to additionally or alternatively measure the heating element(s) 442. For example, the measurement circuitry can be configured to measure information about the heating element(s) 442. In implementations where such measurement circuity is present (e.g., one or more sensing coils 513), the measurement circuitry can be configured such that it measures the restiveness, inductance, temperature, and/or other properties of the heating element(s) 442, such as at one or a plurality of different frequencies, does not generate an electromagnetic field for heating the heating element(s) 442, operates while the inductors 543 are heating the heating element(s) 442, operates while the inductors 543 are not heating the heating element(s) 442, and/or the like.

In some implementations, information about the inductors 443, such as their inductance, resistance, impedance, temperature, and/or the like can be measured in one or more of the described modes and used to control the power or voltage applied, such as to heat the heating element(s) 442 at different temperatures (e.g., target temperatures), as described herein. Although reference is made to the long sides of the heating element(s) 442, other configurations are contemplated depending on the shape and/or position of the heating element(s) 442.

Other implementations exist where additional or alternative information about the inductor(s) 443 can be measured and/or used to estimate the temperature of the heating element(s) 442, such as via measuring the temperature and/or other properties of the inductor(s) 443 by using a temperature sensor 413 in close proximity to the inductor(s) 443. In some implementations, the temperature sensor can include a thermistor, a PTC circuit such as a PTC thermistor, an NTC circuit such as an NTC thermistor, a thermocouple, and/or the like. In accordance with such implementations, the controller 104 and/or other circuitry can be configured to regulate the application of power to the heating element(s) 442, based on a detected temperature of the inductor(s) 443, in addition to or alternatively from the measured inductance and resistance. For example, a specific, detected rise in temperature of the inductor(s) 443 can be correlated to a rise in temperature of the heating element(s) 442, such that the power and/or energy applied to the heating element(s) 442 can be reduced and/or maintained.

In some implementations, the inductors 443 can be configured to measure information from something other than the heating element(s) 442, such as for the purposes of calibration and/or estimation. For example, an inductor 443 that is operating in a calibration mode can be configured to operate at a plurality of different frequencies and/or frequency ranges when a heating element(s) 442 is not present. Information sensed or measured through the inductors 443 in this mode can be used to determine an expected change in inductance, resistance, impedance, and/or temperature which can be stored in a look-up table and/or for creating a best fit line for use in monitoring the inductor(s) 443 when a heating element(s) 442 is present. The sensed information can come from operation of another inductor 443, such one or more inductors 443 on an opposing side of the vaporizer device 420. For example, in some implementations, one or more of the inductors 443 (e.g., all) can be configured to heat up to a predetermined temperature (e.g., heat the inductor(s) 443 and/or heating element(s) 442 to a predetermined temperature) and/or for a predetermined amount of time, and the inductance and/or resistance can be measured and/or stored for each of the one or more inductors 443. For example, the heating element(s) 442 can be removed after it is heated (if present) and the temperature, inductance, and/or resistance of each inductor(s) 443 can be recorded as the inductor(s) 443 cool down. The data derived from this monitoring can be used to define one or more parameters of each inductor(s) 443, which can be factored into the temperature control methodologies described herein. In some implementations, this calibration mode can be implemented as part of a manufacturing process and/or periodically after the device has been sold (e.g., be a recommended user-selectable mode).

FIGS. 5A-5D illustrate different schematics and views of various implementations of a holder assembly 558a-d (collectively referred to as holder assembly 558 or holder assemblies 558) consistent with implementations of the current subject matter. These holder assemblies 558 can be implementations of one or more components of the vaporizer body 110 of FIGS. 1A-1B, the vaporizer body 210 of FIG. 2, and/or the vaporizer bodies 410 of FIGS. 4A-4B, such as the holder assembly 458.

As illustrated in FIG. 5A, the holder assembly 558, 558a can include a frame 547 defining a receptacle 518 for insertion of a cartridge (e.g., cartridge 220, 320, 420, not illustrated). The frame 547 can include two long sides and two short sides, similar to the cartridges and receptacles described herein. For example, the long sides of the frame 547 can be configured to align with the long sides of the cartridge and the short sides of the frame 547 can be configured to align with the short sides of the cartridge when the cartridge is insertably received within the receptacle 518. As described herein, a surface of the cartridge extending primarily along the cartridge width can be referred to as a long side of the cartridge and/or as being on a long side of the cartridge, which can align with the long side of the frame 547. Additionally, a surface of the cartridge extending primarily along the cartridge depth can be referred to as a short side of the cartridge and/or as being on a short side of the cartridge, which can align with the short side of the frame 547. It will be appreciated that this terminology can be applied to any implementation of a cartridge (including its subcomponents described herein) and frame 547, and this terminology is not redefined with respect to each implementation of each component for the sake of brevity.

As illustrated, the frame 547 can include an inductor 543 formed as a spiral, flattened, and/or pancake coil on a long side of the frame 547. Inductor 543 coils depicted and/or described as spiral, flattened, and/or pancake coils herein can take the form of parallel or anti-parallel pancake or Helmholtz structures, although other structures are contemplated. The electrical leads 544a that power the inductor 543 can be disposed on a short side of the frame. The electrical leads 544a that power the inductor 543 can be electrically coupled with a controller and/or driving circuit for powering the inductor 543 as described herein. As described herein, the inductor 543 can be configured to generate an electromagnetic field for generating heat in a heating element of the cartridge, which can take the form of a susceptor.

As described herein, it can be desirable to measure an inductance, resistance, and/or impedance of the heating element for use in determining and/or controlling a temperature of the heating element, such as based on a thermal coefficient of resistivity of the heating element. Various circuits can be provided for measuring the inductance, resistance, and/or impedance of the heating element, such as the sensing coil 513. In some implementations, the sensing coil 513 can be disposed in an open center region 562 of the inductor 543 and/or on a long side of the frame 547, such as illustrated in FIG. 5A. In such implementations, the sensing coil 513 can be in the form of a spiral, flattened, and/or pancake coil. As illustrated, the electrical leads 544b the power the sensing coil 513 can be disposed proximate the distal end 561 of the frame 547. In some implementations, the illustrated and described sensing coils 513 can instead be implemented as inductors 543 configured to generate an electromagnetic field for generating heat in a heating element (e.g., susceptor) of the cartridge. In accordance with these implementations, one or more (e.g., all) of the inductors 543 can be configured to measure the inductance, resistance, and/or impedance of the heating element as described herein. Additionally or alternatively, the illustrated and described sensing coils 513 can take the form of a temperature sensor, which can include a thermistor, a PTC circuit such as a PTC thermistor, an NTC circuit such as an NTC thermistor, a thermocouple, and/or the like. Such temperature sensors can be in physical and/or thermal contact with each inductor 543 or a subset of the inductors 543.

In some implementations, the open center region 562 in the middle of the inductor 543 can be increased in size, which can lead to an increased efficiency in delivering energy to the heating element of the cartridge in the receptacle 518. For example, in a circular region defined by a radius that extends from the center of the inductor 543 to the outer-most turn of the inductor 543, the open center region 562 in which turns of the inductor 543 are not present can occupy 20-50% of the surface area of the circular region. In some implementations, the open center region 562 can take up 30-40% of the circular region. In some aspects, having a larger open center region 562 can result in increased efficiency in delivering energy from the inductor 543 into the heating element to be heated via the magnetic or electromagnetic field. In implementations where the illustrated and described sensing coils 513 are additionally or alternatively configured as inductors 543, the collective set of inductors 543 can be configured to heat separate regions of the heating element. For example, a first region of the heating element adjacent the illustrated sensing coils 513 can be heated independently from a second region of the heating element adjacent the illustrated inductors 543. In this manner, greater control over aerosol production over the life of a cartridge can be provided.

As illustrated in FIGS. 5B-5D, the sensing coil 513 can be disposed within a region near a proximal end 560 of the frame 547. The sensing coil 513 can be wrapped around the frame 547 a plurality of times, so that the sensing coil 513 is capable of measuring inductance, resistance, and/or impedance of the heating element. Within this region, the sensing coil 513 can still be disposed in sufficiently close proximity to the heating element of the cartridge, which can be configured to extend up to or proximate the opening of the receptacle 518 when the cartridge is inserted within the receptacle 518. In accordance with these implementations, the inductor 543 may not include an open center region 562. Other locations and/or configurations for the sensing coil 513 are contemplated, as described herein, including selectively powering one or more of the inductors 543 off to use the inductor 543 as a sensing coil, without the presence of a separate sensing coil 513. Alternatively, the illustrated and described sensing coils 513 can be inductors 543 configured to generate an electromagnetic field for generating heat in a heating element (e.g., susceptor) of the cartridge. In accordance with these implementations, one or more (e.g., all) of the inductors 543 can be configured to measure the inductance, resistance, and/or impedance of the heating element as described herein.

As illustrated in FIG. 5C, a long side of the frame 547 can include a plurality of inductors 543a-d, which can be in the form of spiral, flattened, and/or pancake coils, and each have their own, independent sets of electrical leads 544a-d that can be coupled to a controller and/or driving circuit. As described herein, each of the plurality of inductors 543a-d can be powered off and on independently, such that different regions of a heating element can be selectively heated. For example, all of the inductors 543a-d can be powered at the same time and with the same amount of power, all or some of the inductors 543a-d can be powered at the same time and but with differing amounts of power, and/or only a portion of the inductors 543a-d can be powered at the same time and with the same or different amounts of power. As described herein, different amounts of power can include applying a higher or lower voltage, driving at a longer or shorter duty cycle, driving at a higher or lower frequency, and/or the like.

Although one set of four inductors 543a-d are illustrated and an additional set of inductors on the opposing long side are described, other numbers of inductors 534 are contemplated. For example, sets of two inductors 543 on each of the opposing long sides are contemplated, which can be spaced apart from each other along the longitudinal dimension (e.g., along the length) or transverse to the longitudinal dimension (e.g., along the width). Separately, sets of three, five, six, or more inductors 543 are contemplated, and it is not required that the same number of inductors 543 be implemented on each of the long sides. Other implementations exist in which the inductor(s) 543 do not take the shape of a spiral, flattened, and/or pancake coil, such as the inductor 543 of FIG. 5D, wrapped around the short and long sides of the frame 547 multiple times (also referred to as a helical coil or helical inductor). In some implementations, a plurality of inductors 543 can be disposed in series along the frame 547 (e.g., between and/or along the proximal end 560 and the distal end 561 of the frame 547), such as two, three, or more inductors 543. For example, the plurality of inductors 543 can be formed as solenoid coils, with a space along the frame 547 between each inductor 543.

In some implementations, the long and short side of the frame 547 that are shown can be the same or similar to the long and/or short side of the frame 547 that are not shown. For example, the long side of the frame 547 that is not shown in FIGS. 5A and 5B can also include an inductor 543, such that the receptacle 518 is between two opposing inductors 543. Such a configuration can provide benefits, such as by heating a wider surface area of the heating element, into which it is easier to generate eddy currents using less energy. The long side of the frame 547 that is not shown in FIG. 5C can similarly also include a plurality of inductors 543, such that more control can be provided over how and where heat is generated.

In some implementations, the various configurations and positions of the illustrated and described inductors 543 and/or sensing coils 513 (additionally or alternatively configured as inductors) of FIGS. 5A-5D can be at least partially combined. For example, in some implementations, the illustrated inductor 543 of FIG. 5B can be substituted with the illustrated inductor 543 and sensing coil 513 of FIG. 5A (on both opposing long sides of the frame 547). Additionally or alternatively, the illustrated sensing coil 513 in FIG. 5B can be implemented at one or both of the proximal end and the distal end of the frame 547 (and each be implemented as sensing coils and/or inductors). Accordingly, separate regions of the heating element adjacent the inductors 543 and/or sensing coils 513 can be heated independently to provide greater control over aerosol production, as described herein. It will be appreciated that the ability to heat the heating element in as many independent regions is desirable, but that the implementation of more inductors 543 and/or sensing coils 513 is more expensive and more complicated (e.g., in order to properly account for mutual inductance).

In various implementations, the inductors 543 can include two or more layers of wire, with the layers disposed on top of one another from the perspective of the vaporizer device width or depth. For example, the inductors 543 can include a first layer of turns that is closer to and/or on a holder assembly 558 of the vaporizer device, and a second layer of turns that is further from the holder assembly 558 and/or closer to the external shell of the vaporizer body that includes the holder assembly 558. If the holder assembly 558 or the vaporizer device are defined in part by a circular cross-section, the layers of wire can be regarded as being disposed on top of one another from the perspective a radius of the holder assembly 558 and/or vaporizer device.

In various implementations, the shape and/or structure of the inductors 543 can be varied to increase and/or tune their efficiency, such as based on their coupling efficiency with a heating element of a cartridge in the receptacle 518. For example, one or more of the inductors 543 can include varying numbers of cross-sections, shapes, strand counts, strand gauges, and/or the like of coils. The coils could also be bent to have the same general curvature as the heating element to improve performance, or could be straightened (e.g., along the cartridge width) to limit the coupling efficiency to a specific degree. In some implementations, a flex based coil can be used to decrease manufacturing costs of the device and the consumables, such as by only requiring relatively thin layers of material (e.g., smaller inductors 543 and/or thinner heating elements).

In some implementations, a cartridge for use with a holder assembly 558 that includes multiple inductors 543 can include regions with different susceptibilities. For example, a cartridge can be manufactured to include different materials and/or thicknesses in certain regions depending on each region's intended proximity to an inductor 543. In some implementations, a cartridge can be manufactured to include a first material and/or material of a first thickness in a first region (or set of first regions) that is disposed at or near a first inductor 543 (or set of first inductors 543), and a second material and/or material of a second thickness in a second region (or set of second regions) that is disposed away from the first inductor 543 (or set of first inductors 543). In some aspects, if multiple inductors 543 are used, the regions of the cartridge that are between the set of first regions can include the second region(s).

Although illustrated and described as singular coils, in some implementations any of the inductors 543 can instead be formed of two or more coils, which can each generally take the shape of half or less than half of the inductor 543 they replace. In accordance with these implementations, the general direction of current through one of the replacement inductors (e.g., clockwise) can be opposite the general direction of current through the other of the replacement inductors (e.g., counter-clockwise). Although first and second inductors 543 are illustrated and described at times, the first inductor 543 can instead be implemented as a first set of inductors 543 (e.g., configured to heat the first region 1559a) and/or the second inductor 543 can instead be implemented as a second set of inductors 543 (e.g., configured to heat the second region 1559b). Separately, additional inductors 543 and/or sets of inductors 543, such as a third inductor and/or third set of inductors 543 can be present and configured and/or disposed to heat a third heating element 442.

Control algorithms can be implemented that selectively power a first inductor 543 (e.g., at or near the location of any of the inductor(s) 543 of FIGS. 5A-5D) and a second inductor 543 (e.g., at or near the location of any of the sensing coil 513 of any of FIGS. 5A-5D). Such control algorithms can be configured to selectively power the first inductor 543 and the second inductor 543, and thereby the heating elements, at different times, temperatures, frequencies, voltages, duty cycles, and/or the like. In some implementations, the first inductor 543 can be selectively powered (e.g., according to a first set of operating parameters) based on detection of a user puff, such as to heat a first heating element to a first temperature, which can provide for heating a first heating element on demand. The second inductor 543, when present, can be powered (e.g., according to a second set of operating parameters) based on detection of a user puff, such as to heat a second heating element to a second temperature, which can provide for heating a second heating element on demand. However, in some implementations, the first inductor 543 can be powered for a first period of time (e.g., to maintain the first heating element at or around a first temperature) and/or the second inductor 543 can be powered for a second period of time (e.g., to maintain the second heating element at or around a second temperature), which can be independent of detection of a user puff.

In some aspects, the first temperature can be sufficient to vaporize both the humectant and the active ingredient, such as at or above the boiling point of the humectant. In some aspect, the second temperature can be sufficient to vaporize both the humectant and the active ingredient, such as at or above the boiling point of the humectant and may be the same as the first temperature. However, in other aspects, the second temperature can be lower than the first temperature but sufficient to reduce recondensation of the vaporizable material after it is vaporized and/or to increase the effectiveness of the first heating element heating at the first temperature. The first and second temperatures can change over time, such as based on a programmed profile. For example, the first temperature and/or second temperature can increase and/or decrease over time, across the duration of a session.

In some implementations, the vaporizer device can include a cartridge extending from a first cartridge end to a second cartridge end. The cartridge can include a wrapper configured to hold a vaporizable material disposed therein, a heating element can include a susceptor configured to heat the vaporizable material. In such implementations, the vaporizer body can have a receptacle configured to insertably receive at least a portion of the cartridge, and a heater to heat the heating element to cause vaporization. In some implementations, the heater includes at least one inductor (e.g., an inductive coil, such as an inductive helical coil, as described herein) proximate the receptacle, where the at least one inductor is configured to generate a magnetic and/or electromagnetic field to heat the heating element. However, other heaters that are not inductive can be appreciated.

It can be appreciated that the heating element can be disposed at different locations around, on, or within the cartridge. For example, the heating element, which can include a susceptor, can be a sheet disposed between the wrapper and the vaporizable material where the heating element wraps around the total outer surface of the vaporizable material. Varying the position of the heating element can directly affect how the vaporizable material is heated within the device. Different configurations and positions of the heating element are considered depending on the type of heater in the device. In devices with multiple inductive coils, it can be necessary to position the heating element such that consistent and controlled heating occurs.

In another implementation, the heating element can be outside a portion of the wrapper where the vaporizable material is contained. The heating element can be a sheet of metal or metal alloy wrapped around or within a portion of the device. Alternatively, or additionally, the heating element can be printed metal or metal alloy directly onto the wrapper or another structured substrate. The heating element can also be made of one or more metals or metal alloys, such as but not limited to gold, chrome, aluminum, silver, nickel, copper, or any combination thereof.

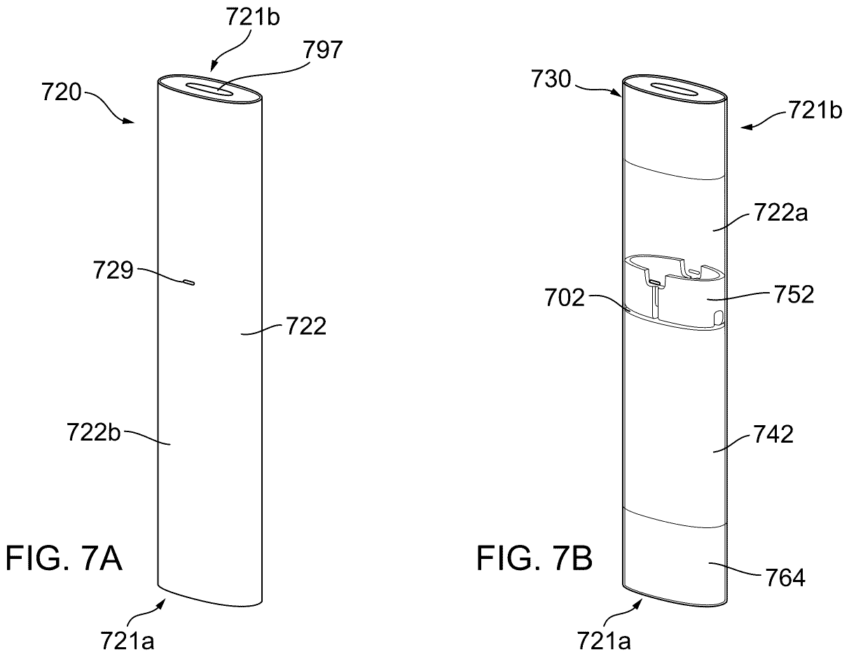

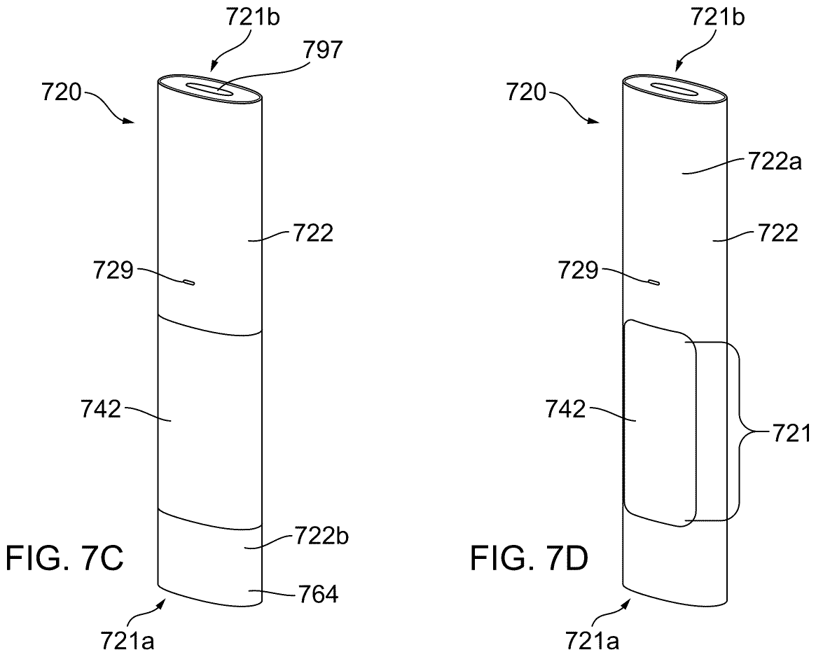

As shown in FIG. 7A and FIG. 7B, which is a transparent view of FIG. 7A, an exemplary cartridge 720 can include a wrapper 722, a heating element 742, and vaporizable material 702 disposed within the wrapper 722. In other words, in this illustrated implementation, the heating element 742, is interposed between the vaporizable material 702 and the wrapper 722, as previously described. As such, the heating element 742, and thus the susceptor, abuts at least a portion of an inner surface 722a of the wrapper 722, and wraps around where the vaporizable material 702 is positioned. The cartridge 720 extends from a first cartridge end 721a (e.g., a proximal end) to a second cartridge end 721b (e.g., a distal end). As further shown, one or more inserts 724 can be wrapped within the wrapper 722 to form the mouthpiece portion 730 of the cartridge 720, where the mouthpiece portion 730 is disposed towards the second cartridge end 721b, e.g., at or proximate the second cartridge end 721b. The one or more inserts 724 can be formed of a vapor-permeable material configured to allow the inhalable aerosol to pass through the material. Alternatively, the one or more inserts 724 can have one or more channels 797 that can serve as an airflow path for the inhalable aerosol generated in the cartridge 720. Alternatively, or in addition, the cartridge 720 can include an end cap 764 (e.g., filter) positioned at or proximate to the first cartridge end 721a. In this illustrated implementation, the end cap 764 is positioned at the first cartridge end 721a and extends upward towards the second cartridge end 721b. The cartridge 720 can also include bypass air inlets 729 that allow ambient air to enter the cartridge 720 and a divider 754.

In another implementation, FIG. 7C illustrates a cartridge 720 with the heating element 742 around the outer surface 722b of the wrapper 722. As in FIG. 7B, the heating element 742 in FIG. 7C is positioned around where the vaporizable material (not shown) is contained within the wrapper 722. As illustrated, the heating element 742 wraps entirely around the wrapper 722.

In another implementation, such as in FIG. 7D, the heating element 742 can be applied to one or more portions 721 of the outer surface 722b of the wrapper 722 only in the area about the vaporizable material (not shown). That is, the heating element 742 can be positioned on the outer surface 722b of the wrapper 722 so as to surround at least a portion of the vaporizable material. In implementations with the heating element 742 on the outer surface 722b of the wrapper 722, the heating element 742 is thick enough to ensure coupling with the electromagnetic field generated by at one inductor of the vaporizer body. Applying the heating element 742 to specific portions of the wrapper can require that two or more heating elements are used.

In an implementation, the cartridge may not have a wrapper and the heating element can be structured to contain the vaporizable material.

To effect a satisfying smoking experience, consistent and uniform heating of the vaporizable material is desired. In many devices, especially those with multiple inductor(s) (e.g., inductor coil(s)), the vaporizable material heats across multiple zones. Although the inductor(s) are designed to specifically couple with the heating element, unwanted coupling can occur between different zones. Moreover, defects, folds, welding patterns, or other inconsistencies in the structure of the heating element can create a significant thermal bridge within the substrate and decrease control in multi-zoned systems.

In an effort to reduce the effects of a thermal bridge, large openings can be cut into the heating element to reduce zone to zone coupling while maintaining a single heating element structure for ease of manufacturing. However, the material between the large openings creates significant paths for heat to flow uncontrolled.

In some implementations, it may be desirable to heat certain regions of the vaporizable material earlier or hotter than others. Alternatively, or additionally, heating all the vaporizable material at once and uniformly may be desired. One manner in which the heating of the vaporizable material can be regulated while reducing effects of a thermal bridge is through controlling the thermal and/or electrical current paths moving through the heating element. More specifically, altering the structure of the heating element can result in different heating profiles for localized heat generation and/or cross-zone conduction. By increasing or minimizing the thermal path length and/or current path length and creating a defined or predetermined path for each to travel, more control over separation of the zones can be achieved. Consequently, altering the structure of the heating element allows for controlling heating of the vaporizable material without modifying or removing other components within the device and/or without adding new components to the device.

As described herein, specific portions of the heating element can be modified (e.g., during manufacture, during use, etc.) to provide particular electrical properties that allow for more control over the current, and therefore the heat, flowing through the heating element. For example, a heating element can include a first region and a second region, with one or more break structures between the first region and the second region. As described herein, current can be induced within the first region and/or the second region via induction. For example, current can be induced within the first region via an electromagnetic field generated from one or more inductors adjacent to the first region and current can be inducted within the second region via an electromagnetic field generated from one or more inductors adjacent to the second region. In certain implementations, it can be beneficial to heat the first region and the second region at different times, temperatures, frequencies, and/or the like. As such, it can be beneficial to provide a heating element that is made of a minimal number of materials (e.g., a single sheet of metal or a single sheet of paper-backed metal, with or without welding or gluing the opposing ends of the sheet together) and easy to manufacture, while still providing at least two regions that can be independently controlled.

In certain implementations of the heating element, a first plurality of break structures a central, third region can reduce or otherwise alter the flow of electrical current and/or thermal path between or among regions of the heating element. For example, when current is induced in the first region of the heating element, the alteration or absence of material in the third region can keep the majority of the induced current and/or heat produced within the first region, and/or substantially reduce the amount of current induced and/or heat produced in the first region from flowing or passing to the second region. Similarly, when current is induced in the second region of the heating element, the first plurality of break structures can keep the majority of the induced current and/or heat produced within the second region, and/or substantially reduce the amount of current induced and/or heat produced in the second region from flowing or passing to the first region. In some aspects, keeping the majority of induced current within a particular region can be regarded as less than 50% of the induced current passing through another region (or collective set of all other regions present) 1052, 1053, less than 40%, less than 30%, less than 20%, less than 10%, less than 5%, less than 2%, less than 1%, or the like. In some aspects, keeping the majority of heat produced within a particular region can be regarded as less than 50% of the heat produced passing to another region (or collective set of all other regions present) less than 40%, less than 30%, less than 20%, less than 10%, less than 5%, less than 2%, less than 1%, or the like.

In general, heating elements are disclosed herein that include a plurality of break structures that allow for a more controlled heating profile that would not otherwise be affected with conventional heating elements. Implementing a plurality of break structures can create a specific path through which the electrical current and thermal energy travels. As used throughout the description, the predetermined path of the electrical current and/or the thermal energy refers to the path through the heating element resulting from implementing break structures. The heating elements described herein include a substrate having a first region, a second region, and a third region disposed between the first region and the second region, in which at least the third includes a first plurality of break structures configured to direct a thermal path, an electric current path, or both across the third region in a predetermined direction. These plurality of break structures (e.g., laser kerf cuts, perforations, etc.) can be added to increase the effective thermal path length between regions of the heating element. Modifying the break structures in pattern, number, location, shape, depth, and other structural characteristics allows for a highly tailored thermal behavior. Additionally, the break structures on the heating element may advantageously allow for more passive session management during smoking, for example by creating a single zone that is structured such that both time and temperature are highly controlled. Further, the break structures can be designed (e.g., in a specific pattern and/or orientation) such that thermal and/or or electrical current can be concentrated to a specific area of the heating element and/or vaporizable material. In other implementations, the break structures can be designed (e.g., in a specific pattern and/or orientation) such that uniform heating can be achieved, which can allow for flavor tuning during smoking. Implementation of break structures can also reduce time to first puff by concentrating heat in certain areas.

Various configurations of the heating elements disclosed herein can be appreciated. For example, heating elements can have a first plurality of break structures including one or more cuts where at least one of the one or more cuts can extend completely through the substrate. Alternatively, or additionally, at least one cut of the one or more cuts can extend partially through the substrate.

In some implementations, the substrate of the heating element can include a first longitudinal end and an opposing, second longitudinal end and a first lateral end and an opposing, second lateral end. Each of the first plurality of break structures can at least partially extend between the first longitudinal end and the second longitudinal end of the substrate.

In some implementations, a first break structure of the first plurality of break structures can include a first end, an opposing, second end and a first length extending from the first end to the second end. A second break structure of the first plurality of break structures can include a third end and a fourth, opposing end and a second length extending therebetween. In certain implementations, the second length can be different than the first length, whereas in other implementations, the second length can be equal to the first length.

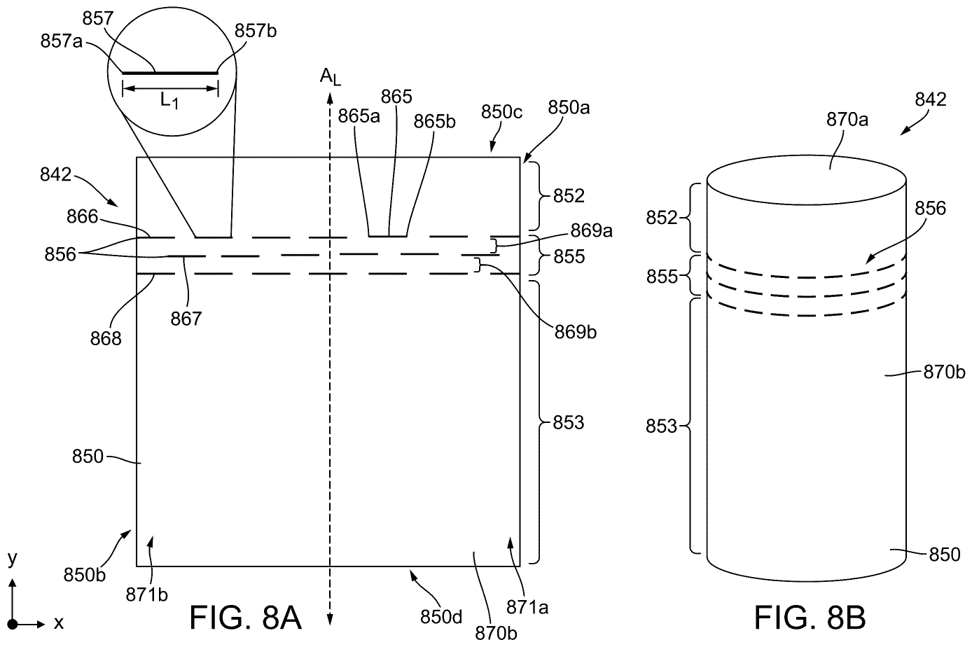

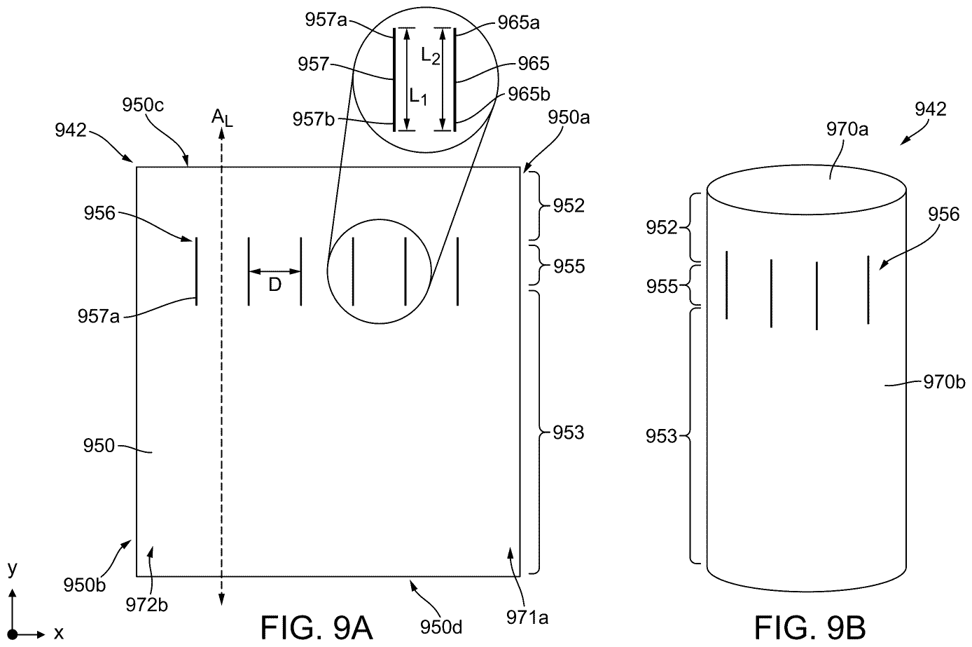

The break structures can be oriented differently across the substrate of the heating element. For example, in some implementations, at least one break structure of the first plurality of break structures can extend at an angle (e.g., at or below 90 degrees, 45 degrees, 30 degrees, etc.) relative to a longitudinal end of the substrate when the substrate is in a flat configuration (see e.g., FIG. 8A). In other implementations, at least one break structure of the first plurality of break structures can extend at an angle (e.g., at or below 90 degrees, 45 degrees, 30 degrees, etc.) relative to a lateral end of the substrate when the substrate is in a flat configuration (see e.g., FIG. 9A). Alternatively, or additionally, at least one break structure of the first plurality of break structures can have a curved shape when the substrate is in a flat configuration.

In some implementations, at least one break structure of the first plurality of break structures can extend in a direction that is nonparallel with a longitudinal axis of the substrate, where the longitudinal axis extends from the first lateral end to the second lateral end. In some implementations, at least one break structure of the first plurality of break structures can extend in a direction that is parallel with a longitudinal axis of the substrate, the longitudinal axis extending from the first lateral end to the second lateral end.

Alternatively, or in addition, the break structures can be arranged in one or more patterns. For example, in some implementations, the first plurality of break structures can be arranged in a chevron pattern.

It is appreciated that break structures can be arranged into specific shapes within the heating element. For example, at least one break structure of the first plurality of break structures can be a polygram. Further, in some implementations, the polygram can be a triangle.

In some implementations, the first plurality of break structures can be arranged in a plurality of rows, the plurality of rows can include a first row and a second row positioned adjacent to and offset from each other.

In some implementations, the first row, the second row, or both can extend in a direction that is nonparallel with a longitudinal axis of the substrate, the longitudinal axis extending from a first lateral end to a second lateral end of the substrate.

In some implementations, the plurality of rows can include a first row and a second row positioned adjacent to and offset from each other. In some implementations, the first row, the second row, or both can extend in a direction that is parallel with a longitudinal axis of the substrate, the longitudinal axis extending from a first lateral end to a second lateral end of the substrate.

In certain implementations, each row of the plurality of rows can be equally spaced apart from a respective adjacent row of the plurality of rows. In some implementations, each row of the plurality of rows cannot be equally spaced apart from a respective adjacent row of the plurality of rows.

Heating elements can be designed with a first plurality of break structures and a second plurality of break structures. In some implementations, the heating element can include a second plurality of break structures at least partially extending between the first longitudinal end and the second longitudinal end of the substrate. If a substrate includes both a first plurality of break structures and a second plurality of break structures, the first plurality of break structures can be different than the second plurality of break structures.

In implementations with a first plurality of break structures and a second plurality of break structures, the break structures can be aligned in different configurations across the substrate. For example, the third region can have the first plurality of break structures and the second plurality of break structures. In some implementations, the first plurality of break structures can have one or more cut-out regions and the second plurality of break structures can have one or more cuts laterally aligned with each other relative to a longitudinal axis of the substrate. In some implementations, the first region can include the second plurality of break structures.

In implementations with a first plurality of break structures and a second plurality of break structures, the first plurality of break structures can be the same as the second plurality of break structures, the heating element can include a channel between the first plurality of break structures and the second plurality of break structures. Further, the heating element can include a third plurality of break structures at least partially extending between the first longitudinal end and the second longitudinal end of the substrate.

In some implementations, the second region can include the third plurality of break structures. In some implementations, the first region, the second region, or both may not comprise the first plurality of break structures, the second plurality of break structures, or both.

Heating elements can be rolled to fit into a cartridge and/or around a vaporizable material. In some implementations, a first portion of the heating element proximate the first longitudinal end of the heating element can at least partially overlap with a second portion of the heating element proximate the second longitudinal end of the heating element. The first portion can be on an exterior face of the heating element and the second portion can be on an interior face of the heating element. In some implementations, the first portion and the second portion can be on an interior face of the heating element.

In some implementations, the first portion and the second portion can be connected. In some implementations, the first portion and the second portion can be welded together, glued together, crimped together, interlocked together, pressed together, knurled, and/or folded over one another. The substrate can have a tubular and/or an oblong configuration.

Any of the implementations of the heating element identified and discussed herein can be combined into any of the cartridges and/or vaporizer devices described with respect to FIGS. 1A-4B, 7A-7D, and/or 11, except as noted or where impractical.

One implementation of a heating element with break structures is illustrated in FIG. 8A. As shown, the heating element 842 is a substrate 850 with a first longitudinal end 850a and an opposing, second longitudinal end 850b and a first lateral 850c end with an opposing, second lateral end 850d. The substrate 850 has a first region 852, a second region 853, and a third region 855 positioned between the first region 852 and second region 853. Within the third region 855, a first plurality of break structures 856 is configured to direct a thermal path, an electric current path, or both across the third region 855 in a predetermined direction.

While the first plurality of break structures 856 can have a variety of configurations, as shown in FIG. 8A, the first plurality of break structures 856 are cuts of uniform length extending across the substrate 850 between the first longitudinal end 850a and the second longitudinal end 850b, and such cuts extend completely through the substrate 850. In other implementations, the cuts can be inconsistent in length relative to each other and/or extend only partially through the substrate 850. Generally, the substrate 850 is a square or rectangle as shown, however, other shapes of substrate can be implemented to change the heating profile (e.g., circles, triangles, abstract, etc.).

Although many configurations of break structures can be appreciated, as shown in FIG. 8A, a first break structure 857 of the first plurality of break structures 856 in the substrate 850 has a first end 857a, an opposing, second end 857b and a first length L₁ extending from the first end 857a to the second end 857b (see magnified portion of FIG. 8A). The first plurality of break structures 856 includes a second break structure 865 having a third end 865a and a fourth, opposing end 865b and a second length L₂ extending therebetween. Since the cuts are of uniform length, the second length L₂ is equal to the first length L₁ of the first break structure 857. As shown, each of the break structures is straight and extend a length between the longitudinal ends of the substrate 850 (e.g., a length extending in the x-direction). In other words, each of the break structures is a 180-degree line when the substrate 850 is laid flat.

The substrate 850 in FIG. 8A has longitudinal axis A_{L} extending from the first lateral end 850c to the second lateral end 850d. Each of the break structures extend in a direction that is nonparallel with the longitudinal axis A_{L} (e.g., the longitudinal axis extending in the y-direction) of the substrate 850. Moreover, each of the break structures is perpendicular (e.g., extending in the x-direction) to the longitudinal axis A_{L}. As further illustrated, the first plurality of break structures 856 is arranged in a plurality of rows. More specifically, in this implementation, a first row 866, a second row 867, and a third row 868 of break structures is illustrated. The first row 866 and the second row 867 are adjacent to each other and laterally offset from each other relative to the longitudinal axis A_{L}. That is, as illustrated in FIGS. 8A and 8B, each of the break structures in the first row 866 and in the second row 867 extend in the x-direction relative to longitudinal axis A_{L} which extends in the y-direction, and each of the break structures in the first row 866 are centered over the space between each of the break structures of the second row 867 such that the ends of the break structures 856 of the first row 866 are positioned over the centers of break structures in the second row 867. Similarly, the second row 867 and the third row 868 are adjacent to each other and laterally offset from each other relative to the longitudinal axis A_{L}.

As further shown, the break structures of the first row 866 and the break structures of the third row 868 are longitudinally aligned with each other relative to the longitudinal axis A_{L}. Each of the first row 866, the second row 867, and the third row 868 extend in a direction that is nonparallel with the longitudinal axis A_{L}, and moreover, each of the rows extend in a direction perpendicular (e.g., extending in the x-direction) to the longitudinal axis A_{L} of the substrate 850.

As illustrated in FIG. 8A, each row of the plurality of rows (i.e., the first row 866, second row 867, and third row 868) is equally spaced apart from a respective, adjacent row. In other words, the first distance 869a between the first row 866 and the second row 867 is equivalent to the second distance 869b between the second row 867 and the third row 868. In implementations with a plurality of rows, the first row 866, the second row 867, or both can extend in a direction that is nonparallel with the longitudinal axis A_{L} of the substrate 850.

As explained above, each of the break structures in the first row 866, in the second row 867, and in the third row 868 extend in the x-direction relative to longitudinal axis A_{L} which extends in the y-direction As a result, since the thermal path extends from the first lateral end 850c to the second lateral end 850d of the substrate 850, the thermal path along the substrate 850 is therefore lengthened compared to a substrate without any of the break structures. This is because the rows of break structures 866, 867, 868 create a tortious path for the heat to travel along the substrate 850 (e.g., generally in the y-direction). For example, when the heating element is heated, heat travels from the first lateral end 850c to the second lateral end 850d of the substrate 850, and around each of the break structures, thereby creating a snaking thermal path through the third region 855. As such, this snaking path therefore lengthens the thermal path and as a result, heat flow is reduced, and greater control is exhibited when heating the different regions (i.e. zones) of vaporizable material. As previously described herein, increasing control between zones allows the vaporizable material to be precisely heated such that an optimal smokable material is generated.

The electrical path of the substrate 850 generally travels from the first longitudinal end 850a to the second longitudinal end 850b (e.g., generally travels in the x-direction). As such, since the break structures extend at a 90-degree angle relative to the lateral ends 850c, 850d of the substrate 850, the electrical current traveling through the substrate 850 is largely unaffected.

In some implementations, the substrate 850 can be rolled (e.g., into a tubular configuration) during manufacturing to fit into a cartridge and around vaporizable material. If the heating element 842 is to be rolled, break structures can be added to the substrate 850 either before or after the rolling (e.g., before or after forming the tubular configuration), depending on the method used to create the break structures. Whether the substrate 850 is rolled will depend on the position of the heating element within the cartridge and the thermal profile desired. The heating element of FIG. 8A is illustrated in a rolled configuration in FIG. 8B. As illustrated, the heating element 842 has an interior face 870a and an opposing, exterior face 870b. As such, the first plurality of break structures 856 are cuts extending completely through the substrate 850 such that they extend from the exterior face 870b to the interior face 870a.

As illustrated in FIG. 8A, the substrate 850 has a first portion 871a proximate to the first longitudinal end 850a of the heating element 850 and a second portion 871b proximate to the second longitudinal end 850b of the heating element. The first portion 871a and the second portion 871b are on the exterior face 870b of the heating element 842, however, in other implementations, the first portion 871a can be on the exterior face 870b and the second portion 871b can be on the interior face 870a. In other words, the first portion 871a and the second portion 871b can be on opposing faces. As such, different rolling configurations are possible. While not now shown in FIG. 8B, the first portion 871a at least partially overlaps with the second portion 871b creating the rolled structure. Further, the first portion 871a and the second portion 871b are connected. For example, the first portion 871a and the second portion 871b can be welded together, glued together, crimped together, interlocked together, pressed together, knurled, and/or folded over one another.

Because different configurations of the cartridge and vaporizable material are possible, the heating element 842 can be rolled or shaped to match the configuration of the cartridge. As illustrated in FIG. 8B, the heating element 842 has a circular shape. However, in other implementations, the heating element 842 can be oblong and/or oval, as well as other shapes that can be appreciated. In some implementations, the heating element may not be rolled such that it remains unfolded rolled configuration (e.g., in a sheet-like configuration).

While the electrical path of the heating element 842 in FIGS. 8A-8B is largely unaffected, the break structures can be designed such that alternatively or in addition to the thermal path, the electrical path can be lengthened. In a manner similar to the thermal path, the electrical path can be lengthened with cuts so that current traveling through the substrate is slowed. Consequently, the electrical current (which creates the thermal heat) is better controlled and better separation can occur between zones of the vaporizable material thereby generating a more optimal smokable material.

In FIG. 9A, a heating element 942 that includes a substrate 950 with a plurality of break structures 956 configured to affect the electrical current path moving through the heating element is shown. As the electrical current travels through the substrate 950 from the first longitudinal end 950a to the second longitudinal end 950b of FIG. 9A during use, the electrical path travels around each of the first plurality of break structures 956 thereby lengthening and slowing the path compared to a substrate with no break structures. As a result of the large spaces between each of the break structures in FIG. 9A, the thermal energy travels through the substrate 950 largely unaffected between the lateral ends 950c, 950d compared to the path resulting from the break structures of FIG. 8A.

As illustrated, the heating element 942 is made of a substrate 950 with a first region 952, a second region 953, and a third region 955 disposed between the first region 952 and the second region 953. The third region 955 has a first plurality of break structures 956 that are cuts of uniform length extending across the substrate 950 between the first longitudinal end 950a and the second longitudinal end 950b, and the cuts extend completely through the substrate 950. In other implementations, the cuts can be inconsistent in length relative to each other and/or extend only partially through the substrate 950. The substrate 950 of FIG. 9A has longitudinal axis A_{L} extending from the first lateral end 950c to the second lateral end 950d. Each one of the first plurality of break structures 956 extend in a direction that is parallel with the longitudinal axis A_{L} (e.g., the longitudinal axis extending in the y-direction) of the substrate 950, Moreover, each of the break structures is parallel (e.g., extending in the y-direction) to the longitudinal axis A_{L}. In other words, the third region includes a single row of vertically extending break structures 956 that are spaced apart from each other at a distance D. In this implementation, at least one cut of the one or more cuts of the break structures extends completely through the substrate 950. Alternatively, or in addition, at least one cut only extends partially through the substrate 950.

Similar to the break structures described in FIG. 8A, a first break structure 957 of the first plurality of break structures 956 in the substrate 950 of FIG. 9A has a first end 957a, an opposing, second end 957b and a first length L₁ extending from the first end 957a to the second end 957b. Within the first plurality of break structures 956, a second break structure 965 has a third end 965a and a fourth, opposing end 965b and a second length L₂ extending therebetween, the second length L₂ is equal to the first length L₁ of the first break structure 957. As shown, each of the break structures is straight and extending in a pattern between the longitudinal ends of the substrate. In other words, each of the break structures of FIGS. 9A and 9B extend in the y-direction relative and parallel to longitudinal axis A_{L} which also extends in the y-direction.

As illustrated, each break structure of the first plurality of break structures 956 is equally spaced apart from a respective, adjacent break structure at a distance D. As such, the space, and thus distance D, between each of the break structures is equivalent.

As previously described with respect to FIGS. 8A and 8B, the substrate of FIG. 9A can be rolled into a similar configuration, as shown in FIG. 9B. As illustrated, the heating element 942 has an interior face 970a and an exterior face 970b. The first plurality of break structures 956 are each cuts extending completely through the substrate 950 such that they continue from the exterior face 970b to the interior face 970a. The substrate 950 can be rolled such that the first longitudinal end 950a and the second longitudinal end 950b are joined and connected.

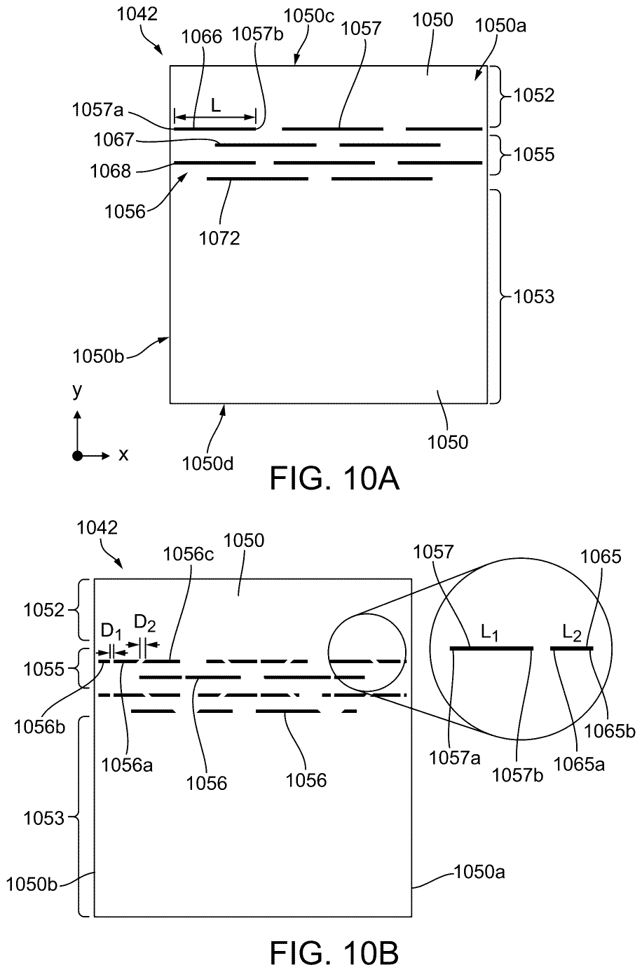

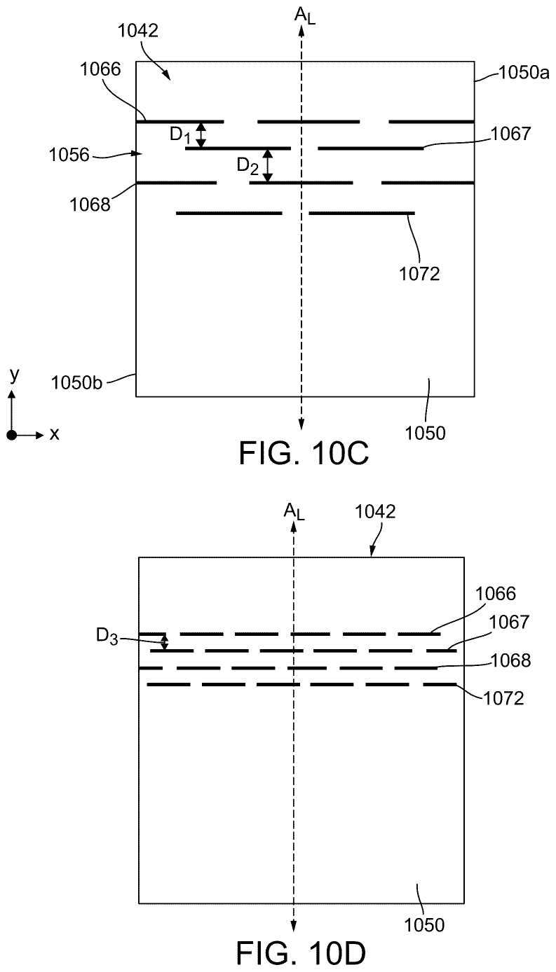

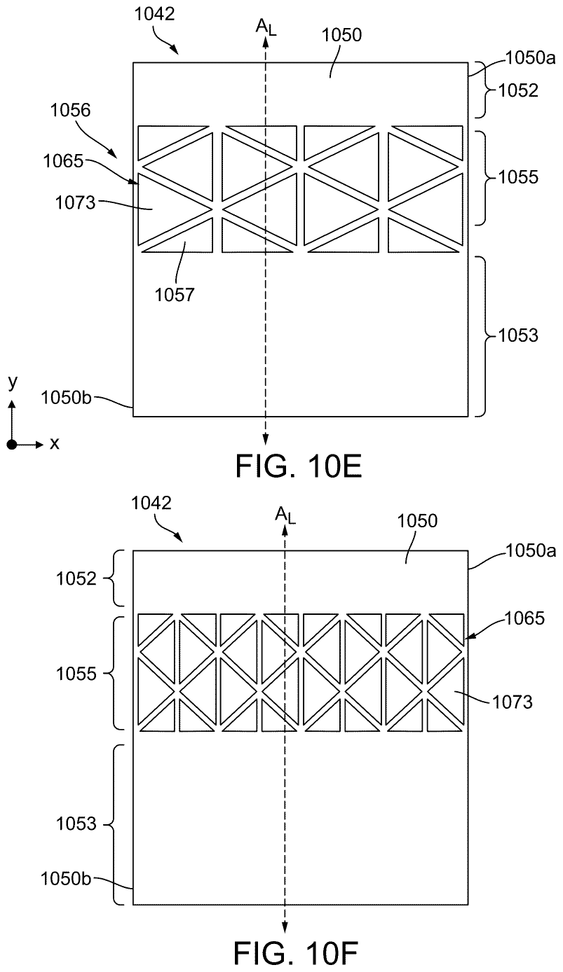

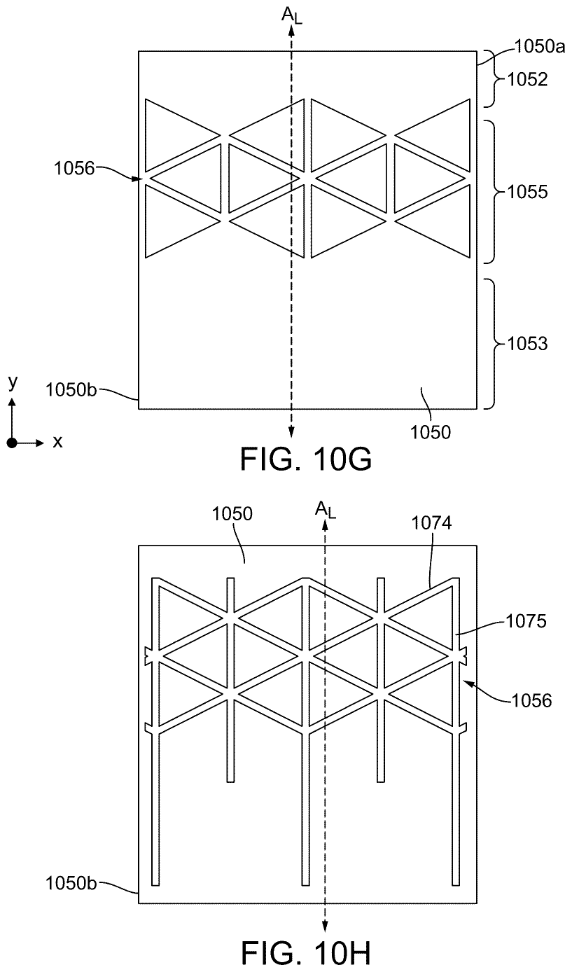

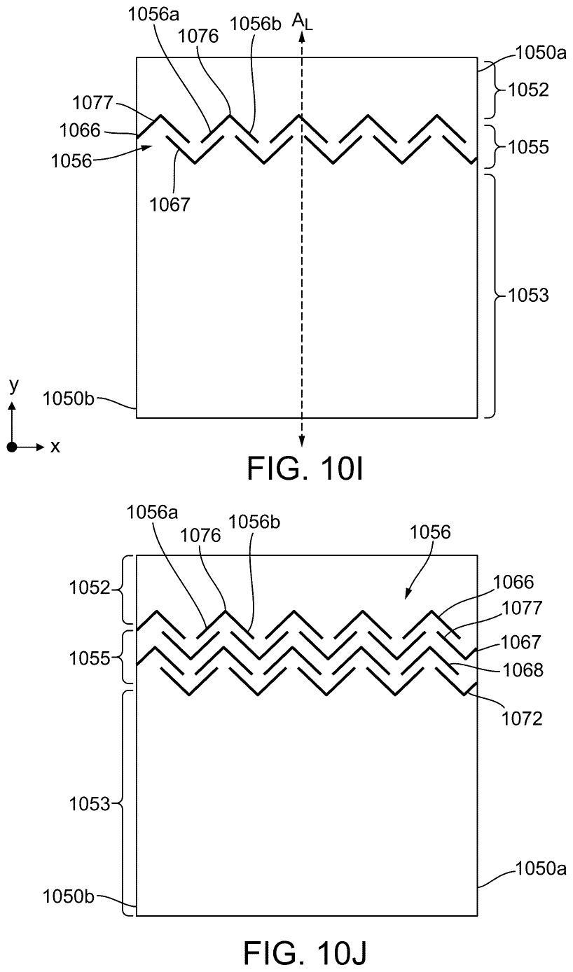

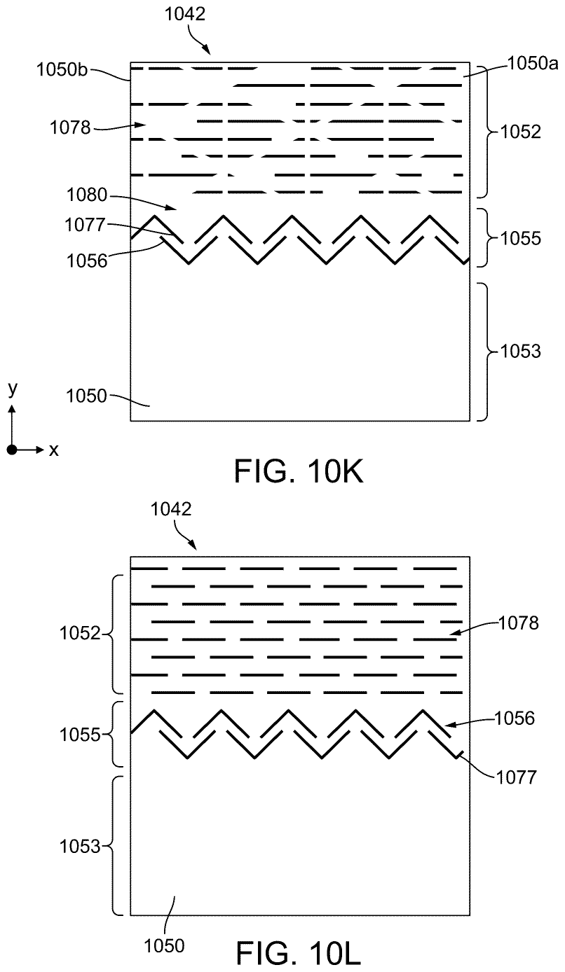

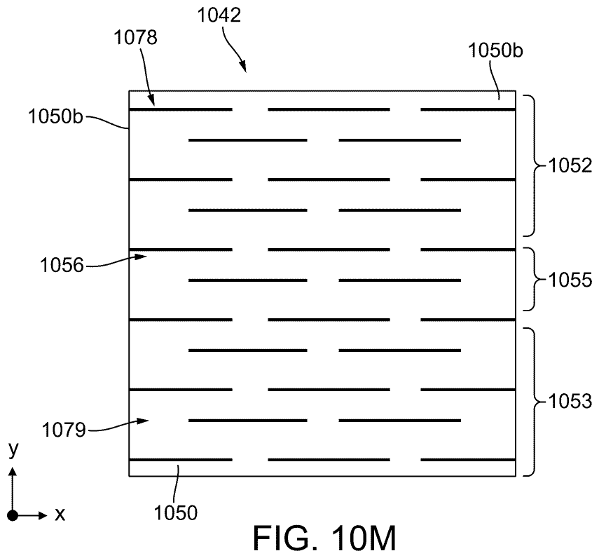

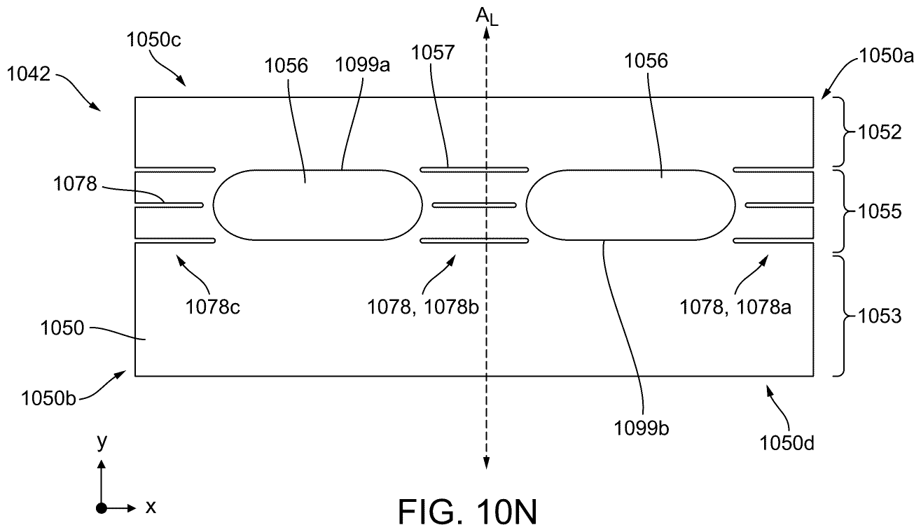

As previously described, the break structures of the heating element can be implemented to achieve specific and precise thermal and electrical current control. Further, there are many configurations that may be advantageously implemented to affect the heating profile. FIGS. 10A to 10O illustrate exemplary implementations of heating elements with various break structures which can each affect the thermal and electrical current paths along the substrate. Aside from the differences discussed with respect to the break structures across the different regions of the heating element of FIGS. 10A to 10O below, the heating elements can be similar to the heating element in FIG. 8A and therefore common features are not described in detail herein. As shown in FIG. 10A, a heating element 1042 is formed from a substrate 1050. The heating element 1042 has a first region 1052, a second region 1053, and a third region 1055 disposed between the first region 1052 and the second region 1053. Similar to FIG. 8A, a first plurality of break structures 1056 extends in the third region 1055 between the first longitudinal end 1050a and the second longitudinal end 1050b of the substrate 1050. The first plurality of break structures 1056 has a first row 1066, a second row 1067, a third row 1068, and a fourth row 1072 spaced equidistant apart. In other words, the distance between the first row 1066 and the second row 1067 is the same as the distance between the second row 1067 and third row 1068 and the distance between the third row 1068 and the fourth row 1072 (further illustrated and described in FIGS. 10C and 10D). Each break structure of the first plurality of break structures 1056 is the same length, and each break structure extends at a 90-degree angle relative to the longitudinal ends 1050a, 1050b of the substrate 1050. As such, each break structure extends in a direction (e.g., extending in the x-direction) that is parallel with the first lateral end 1050c and the second lateral end 1050d. Further, each break structure of the first plurality of break structures 1056 has a first end 1057a, an opposing, second end 1057b and a first length L extending from the first end 1057a to the second end 1057b, and the length L of each break structure 1057 is the same. The distance between adjacent break structures is the same throughout the third region 1055.

Similar to FIG. 8A, the first row 1066 and the third row 1068 can be aligned laterally, but both the first row 1066 and the third row 1068 can be laterally offset from the second row 1067 and the fourth row 1072. Although four rows are illustrated in FIG. 10A, heating elements with one, two, three, five, six, or more rows can be appreciated.

As shown in FIG. 10B, a heating element 1042 is formed from a substrate 1050 with a first plurality of break structures 1056 through the third region 1055. The first plurality of break structures 1056 are one or more cuts. Unlike the break structures illustrated and described in FIG. 10A, the cuts in the first plurality of break structures 1056 have different lengths. For example, a first break structure 1057 of the first plurality of break structures 1056 has a first end 1057a, an opposing, second end 1057b and a first length L₁ extending from the first end 1057a to the second end 1057b, and a second break structure 1065 of the first plurality of break structures 1056 has a third end 1065a and a fourth, opposing end 1065b and a second length L₂ extending therebetween. As depicted in the magnified region of FIG. 10B, the second length L₂ of the second break structure 1065 is different than the first length L₁ of the first break structure 1057. Further, each break structure may have a different length.

As illustrated, the distance between break structures can vary as well. For example, one break structure 1056a can be a first distance D₁ from an adjacent break structure 1056b and a second, different distance D₂ from another adjacent break structure 1056c. The lengths of each break structure and the distances between each break structure can vary across the plurality of break structures such that a random design is created.

Although four rows are illustrated in FIG. 10B, heating elements with one, two, three, five, six, or more rows can be appreciated.

In implementations, it may be advantageous to vary the length of the break structures (see e.g., FIG. 10B), the distance between rows, or other characteristics of the break structures. For example, as shown in FIG. 10C and FIG. 10D, a heating element 1042 can have a first plurality of break structures 1056 in four rows from the first longitudinal end 1050a to the second longitudinal end 1050b. In FIG. 10C, the first row 1066 is a first distance D₁ from the second row 1067, and the second row 1067 is a second distance D₂ from the third row 1068. In the present embodiment, D₁ and D₂ are equal. As such, the distance between each of the rows is the same. In another implementation, such as in FIG. 10D, the distance D₃ between the first row 1066 and the second row 1067 is different than D₁ and D₂ of FIG. 10C. The each of the rows is equal distance apart in both FIGS. 10C and 10D, but the rows in FIG. 10C have a greater distance D₁ between than the distance D₃ in FIG. 10D.

It can be appreciated in other implementations that the distance between rows can be variable. For example, D₁ can be greater than or less than D₂. Alternatively, or in addition, the distance between subsequent rows can be greater than, less than, or equal to D₁ and/or D₂.

As mentioned above, the plurality of break structures can have a variety of configurations. For example, the plurality of break structures can take the form of other shapes rather than single lines. In some implementations, entire areas of a specific shape can be cut out of the substrate to affect thermal and current paths differently. As shown in FIG. 10E and FIG. 10F, a first plurality of break structures 1056 extends across the third region 1055 between the first longitudinal end 1050a and the second longitudinal end 1050b. At least one break structure of the first plurality of break structures 1056 is a polygram 1073. More specifically, as illustrated in FIG. 10E and FIG. 10F, the polygram 1073 is a triangle, however other shapes can be appreciated. For example, squares, circles, other polygons, or a combination thereof can be used to create the first plurality of break structures.

As shown in FIG. 10E, a first break structure 1057 is a triangle with a first set of dimensions that are different from a second break structure 1065 that is a triangle with a second set of dimensions. Although the first break structure 1057 and the second break structure 1065 are both triangles, the triangles may be different sizes or types. For example, the first break structure 1057 is a right-angled triangle, and the second break structure 1065 is an isosceles triangle. Although the first plurality of break structures 1056 illustrated in FIG. 10E is a repeating pattern of triangles, some implementations may have a random assortment of triangles without a discernable pattern.

In FIG. 10F, a different pattern of polygrams 1073, specifically triangles, makes up the first plurality of break structures 1056. Compared to FIG. 10E, the triangles have different dimensions and are generally smaller. Other sizes and dimensions of polygrams 1073 can be appreciated and may be implemented depending on the desired thermal effects of the heating element 1042.

One implementation, as illustrated in FIG. 10G, has a first plurality of break structures 1056 within the third region 1055 extending between the first longitudinal end 1050a and the second longitudinal end 1050b. Each of the break structures is a cut extending through the substrate 1050, and each break structure is a triangle. Each of the break structures is arranged so that the first plurality of break structures 1056 creates a repeating pattern. Although triangles are illustrated, different sizes, shapes, or combinations thereof can be appreciated to achieve different effects on the thermal and electrical current paths.

Implementing break structures in both parallel and nonparallel orientations can achieve specific electrical and thermal effects. In one such implementation illustrated in FIG. 10H, the plurality of break structures are shown as individual cuts extending in various directions through the substrate. For example, at least one break structure of the first plurality of break structures 1056 can extend in a nonparallel direction 1074 with respect to the longitudinal axis A_{L} of the substrate 1050 (e.g., the nonparallel direction can be any angle less than 180 degrees with respect to the longitudinal axis). Alternatively, or additionally, at least one break structure of the first plurality of break structures 1056 can extend in a parallel direction 1075 with respect to the longitudinal axis A_{L} of the substrate 1050 (e.g., the at least one break can extend in the y-direction.) When the substrate 1050 has break structures extending both parallel and nonparallel to the longitudinal axis A_{L}, both the thermal and the electrical current paths can be elongated for finer control.

Various designs and patterns of the plurality of break structures can be appreciated. For example, as illustrated in FIG. 10I, a first plurality of break structures 1056 within the third region 1055 extends between the first longitudinal end 1050a and the second longitudinal end 1050b. The first plurality of break structures 1056 is arranged in a plurality of rows, with a first row 1066 and a second row 1067. Each one of the break structures include two angled lines 1056a, 1056b that intersect at a point 1076. Arranging the first row 1066 laterally offset from the second row 1067 creates a chevron pattern 1077 across the first plurality of break structures 1056. That is, each of the break structures in the first row 1066 and in the second row 1067 extend in the y-direction relative to longitudinal axis A_{L} which extends in the y-direction, and each of the break structures in the first row 1066 are centered over the space between each of the break structures of the second row 1067 such that the ends of the break structures 1056 of the first row 1066 are positioned near the centers of break structures in the second row 1067. In implementations with a plurality of rows, the first row, the second row, or both can extend in a direction that is nonparallel and/or parallel with the longitudinal axis A_{L} of the substrate.

Variations of the pattern illustrated in FIG. 10I are possible to create longer thermal and electrical current paths. For example, FIG. 10J illustrates a first plurality of break structures 1056 with a first row 1066, second row 1067, third row 1068, and fourth row 1072. Each one of the break structures includes two angled lines 1056a, 1056b that intersect at a point 1076. The first row 1066 is laterally aligned with the third row 1068, and the second row 1067 is laterally aligned with the fourth row 1072. However, the first row 1066 and third row 1068 are laterally offset from the second row 1067 and fourth row 1072 to create a chevron pattern 1077 that fills more of the substrate 1050 compared to FIG. 10I. More specifically in this implementation, each of the break structures in all the rows 1066, 1067, 1068, 1072 extend in the y-direction relative to longitudinal axis A_{L} which extends in the y-direction, and each of the break structures in the first row 1066 and the third row 1068 are centered over the space between each of the break structures of the second row 1067 and the fourth row 1072 such that the ends of the break structures 1056 of the first row 1066 and third row 1068 are positioned near the centers of break structures in the second row 1067 and fourth row 1072. Although only four rows are illustrated, five, six, seven, or more rows can be appreciated depending on the needs of the heating element.

In some implementations, a second plurality or a third plurality of break structures can be added. The break structures can extend within the first, second, and/or third regions. More break structures, or different break structures, allows for a specific heating profile within the heating element.

For example, FIG. 10K illustrates a heating element 1042 with a first plurality of break structures 1056 in the third region 1055 and a second plurality of break structures 1078 in the first region 1052. Although the shape of each break structure in the first plurality of break structures 1056 is different than the shape of those in the second plurality of break structures 1078, the same shape or pattern can be implemented for both the first plurality of break structures 1056 and the second plurality of break structures 1078. As illustrated, the first plurality of break structures 1056 resembles a chevron pattern 1077 with a first row and a second row, as previously described with respect to FIG. 10I. The second plurality of break structures 1078 is similar to the cuts as discussed in FIG. 10B, however, the second plurality of break structures 1078 extends across the first region 1052 from the first longitudinal end 1050a to the second longitudinal end 1050b.

As explained above, it can be advantageous to focus the thermal and/or electrical current paths to specific areas on the substrate 1050, depending on the desired heating profile of the heating element. As such, break structures can be arranged to focus the paths. For example, in FIG. 10K, a channel 1080 can exist between the first plurality of break structures 1056 and the second plurality of break structures 1078 where no break structures exist. The channel 1080 can be an area of the substrate 1050 between break structures that heats more and/or faster than regions where break structures are present. It can be appreciated that the channel 1080 can be disposed anywhere on the heating element 1042 between break structures, and the channel 1080 can be various sizes and shapes depending on the desired needs of the heating element 1042.

In another implementation, FIG. 10L illustrates a substrate with a first plurality of break structures and a second plurality of break structures. The first plurality of break structures across the third region 1055 resembles a chevron pattern with a first row and a second row, as previously described with respect to FIG. 10I. The second plurality of break structures is similar to the cuts as discussed in FIG. 8A, however, the second plurality of break structures extend across the first region from the first longitudinal end to the second longitudinal end.

In some implementations, it can be advantageous to have a plurality of break structures in all regions to effect a desired heating profile across the entire heating element. For example, as shown in FIG. 10M, a heating element 1042 includes a substrate 1050 having a first region 1052, a second region 1053, and a third region 1055 disposed between the first region 1052 and the second region 1053. A first plurality of break structures 1056 is disposed in the third region 1055 from the first longitudinal end 1050a to the second longitudinal end 1050b. A second plurality of break structures 1078 is disposed in the first region 1052 from the first longitudinal end 1050a to the second longitudinal end 1050b and a third plurality of break structures 1079 is disposed in the second region 1053 from the first longitudinal end 1050a to the second longitudinal end 1050b. Although the break structures in each of the regions are lines of equal length, any type or combination of break structure as previously described herein can be disposed throughout each of the regions. The area of the entire substrate, specifically the first, second, and third regions, can be cut with break structures to achieve a specific heating profile.

As shown in FIG. 10N, a heating element 1042 includes a substrate 1050 having a first region 1052, a second region 1053, and a third region 1055 disposed between the first region 1052 and the second region 1053. The third region includes a first plurality of break structures 1056 that includes two cuts 1099a, 1099b, each having an oblong configuration. It can be appreciated by a person of ordinary skill in the art that there can be more than two cuts 1099a and 1099b, e.g., three, four, or more cuts, and that the first plurality of break structures can have the same size and/or shape or varying sizes/shapes depending on the design of the heating element and/or the desired heating profile for the heating element.

As further illustrated in FIG. 10N, the heating element 1042 has a second plurality of break structures 1078 disposed within the third region 1055 that is different than the first plurality of break structures 1056. As illustrated, the second plurality of break structures 1078 include three cuts each extending in a direction that is perpendicular to a longitudinal axis A_{L} (e.g., longitudinal axis A_{L} extending in the y-direction) of the substrate 1050. Further, the second plurality of breaks structures 1078 include three sets of cuts, where each set include cuts that are aligned with each other within the third region 1055. More specifically, each cut of the second plurality of break structures is parallel to an adjacent cut of the second plurality of break structures 1078, and each cut extends in a direction that is parallel to the lateral ends 1050c, 1050d of the substrate 1050. Further, the cuts of the second plurality of break structures 1078 are provided in the third region such that each cut is equally distanced from an adjacent cut of the second plurality of break structures 1078. As further shown, the three sets of cuts are aligned with each other, where the first set extend from the first longitudinal end 1050d toward second cut 1099b, the second set extends between the first and second cuts 1099a, 1099b, and the third set extends from the second longitudinal end towards the first cut 1099b.

In some embodiments, as illustrated in FIG. 10O, the substrate 1050 from FIG. 10N can be rolled and welded to form the heating element 1042. The rolled substrate 1050 can be shaped into a circular shape, but in some implementations, such as shown in FIG. 10O, the substate 1050 is rolled into an oblong shape. As shown, the first plurality of break structures 1056 are positioned on a longer side of the oblong heating element 1042 and the second plurality of break structures 1078 are positioned on the shorter side of the oblong heating element 1042.

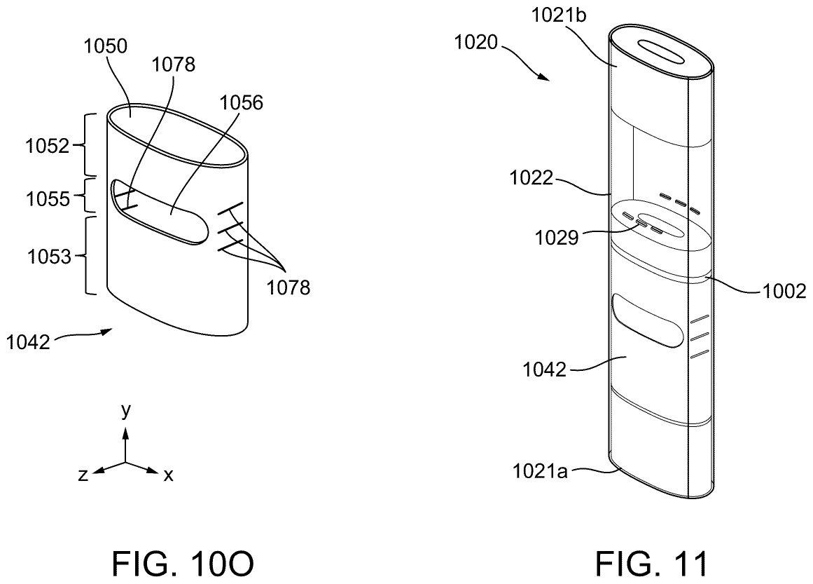

FIG. 11 shows the rolled heating element 1042 from FIG. 10O within a vaporizer cartridge 1020 having a first cartridge end 1021a and a second cartridge end 1021b. The heating element 1042 is disposed within the wrapper 1022. The wrapper also includes a vaporizable material 1002 which is disposed within the heating element 1042. As such, the heating element 1042 at least partially surrounds the vaporizable material 1002. The vaporizable material 1002 can include a tobacco material. The tobacco material can be cut, shredded, and/or the like. For example, in some implementations, the vaporizable material 1002 can be cut rag tobacco, such that it has a better ability to absorb a carrier. The vaporizer cartridge 1020 has one of more bypass air inlets 1029 extending through at least the wrapper 1022 to allow ambient air to pass through.

In another implementation, at least one break structure of the plurality of break structures can be a curved shape (not shown) when the substrate is in a flat configuration. More specifically, the at least one curved break structure may not be a line of 180 degrees, nor an angled structure. A curved break structure may have a bend, for example like a parabola. The plurality of break structures can be straight (e.g., a 180-degree line with respect to the longitudinal axis A_{L}), angled, or curved, or any combination thereof. Additionally, or alternatively, the break structures can be perforations, or holes, through the substrate which may be round or circular.

In any of the prior implementations of FIGS. 10A to 10O, the break structures may be cuts. One or more of the cuts may extend completely through the substrate. Alternatively, or additionally, one or more of the cuts may extend only partially through the substrate. Additionally, the break structures may extend at least partially between the first longitudinal end and the second longitudinal end of the substrate. The break structures may also extend completely from the first longitudinal end to the second longitudinal end of the substrate.

Any of the heating elements as described and illustrated in FIG. 8A to FIG. 10O, and the variations as described above, can be implemented as a heating element in a cartridge. The cartridge could be any one of the cartridges described herein, for example FIGS. 1A to 1C, 2, 3, 4A to 4B, 7A to 7D, and/or 11. The cartridges disclosed herein could include any of the heating elements as previously described, where applicable, a wrapper holding a vaporizable material disposed therein, at least one airflow inlet configured to allow external air to enter the wrapper and entrain the vapor, and at least one airflow outlet in fluid communication with the at least one airflow inlet and configured to allow egress of aerosol from the wrapper for inhalation by a user.

In one implementation the heating element is disposed on an outer surface of the wrapper and wraps at least partially around the outer surface. One or more adhesives may be disposed between the heating element and the wrapper such that the heating element stays in the desired location within the cartridge. In implementations where adhesive is not used, the heating element may be printed directly onto at least a portion of the wrapper. The wrapper can be made of paper.

In many implementations, the cartridge, the wrapper, the heating element, and other components within the cartridge may be oblong or oval shaped. Other components of the cartridge can include a divider and/or one or more inserts.

In some implementations, a vaporizer device can be configured to receive at least a portion of the cartridge to generate an inhalable aerosol. The vaporizer device can have a vaporizer body with a heater that is configured to heat the heating element. For example, the heater can be at least one inductor configured to generate a magnetic and/or electromagnetic field. In some implementations, there can be a first inductor and a second that are inductive coils.

Other components of the vaporizer device can include a flux concentrator configured to direct the magnetic and/or electromagnetic field toward the vaporizable material, one or more sensors configured to detect an external magnetic field relative to the vaporizer device, and/or a receptacle configured to insertably receive at least a portion of the cartridge.

Various manufacturing methods can be used for creating any of the heating elements as previously described herein. For example, a substrate can be cut across a central region between a first longitudinal end and a second longitudinal end to create a plurality of break structure and the first longitudinal end to the second longitudinal end can be attached to create a heating element. The heating element can be made of a substrate formed by applying a metal layer to a base substrate and as previously discussed, the metals can be printed onto one or more portions of the substrate. Break structures can be formed in the substrate by various methods such as cutting or lasering.

In implementations where the heating element is rolled into a tube configuration, the first longitudinal can be glued and/or welded to the second longitudinal end. For example, attaching the first longitudinal end to the second longitudinal end can include welding the first longitudinal end to the second longitudinal end, and folding and gluing the welded first longitudinal end and second longitudinal end onto an exterior surface of the heating element.

Additional implementations exist where additional or alternative structures can be present that provide a more simplified vaporizer cartridge, e.g., a vaporizer cartridge without a divider. Further, such vaporizer cartridges can be formed using a more simplified manufacturing process.

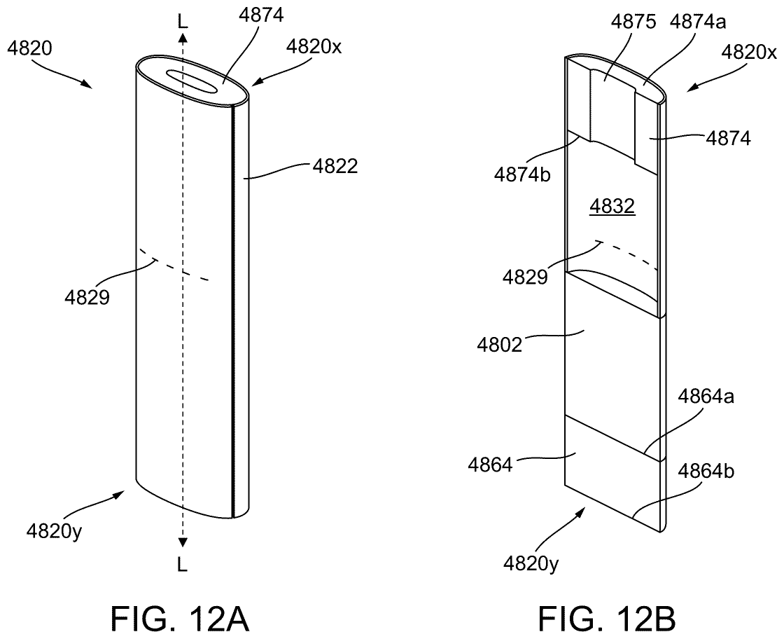

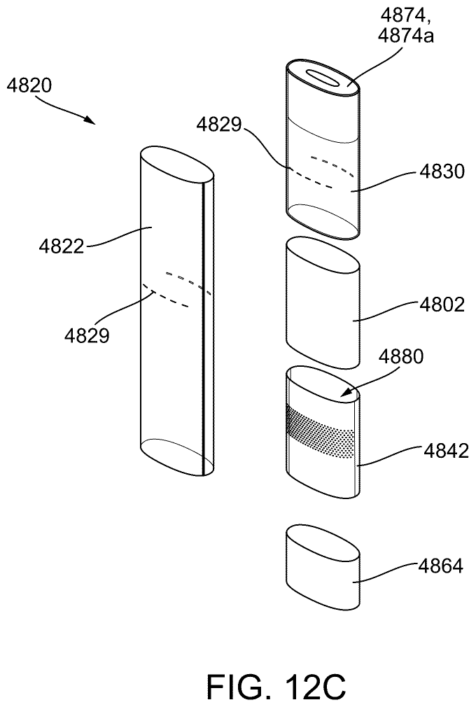

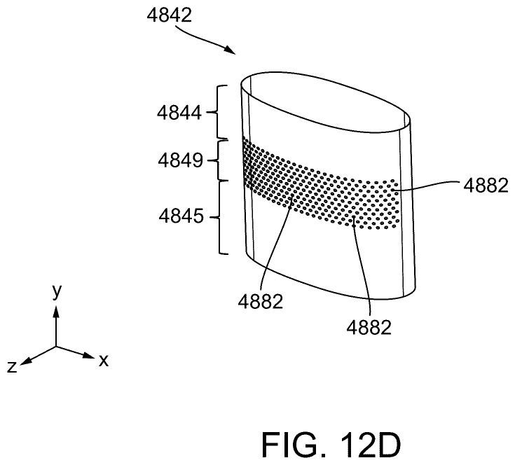

FIGS. 12A-12C illustrate an exemplary vaporizer cartridge 4820 for a vaporizer device that does include a divider. The vaporizer cartridge 4820 disclosed herein can include similar components to, and otherwise operate in the same manner as the other vaporizer cartridges discussed. Separately, the components of vaporizer cartridge 4820 identified and discussed herein can be combined with any of the components of the other vaporizer cartridges described previously except as noted or where impractical. Further, while not shown, in use the vaporizer cartridge 4820 is at least partially inserted into a vaporizer body as disclosed herein. The vaporizer body can include at least one inductor configured to generate a magnetic and/or electromagnetic field to heat the heating element of the vaporizer cartridge as discussed herein.

With reference to FIGS. 12A-12C, the vaporizer cartridge 4820 can extend from a first cartridge end 4820x to a second cartridge end 4820y. The vaporizer cartridge 4820 can include a wrapper 4822 configured to hold a vaporizable material 4802 disposed therein. The vaporizable material 4802 can include a tobacco material. The tobacco material can be cut, shredded, and/or the like. For example, in some implementations, the vaporizable material 4802 can be cut rag tobacco, such that it has a better ability to absorb the carrier.

The wrapper can have a variety of configurations. In some implementations, the wrapper can have a thickness in the range of about 0.02 mm to about 0.07 mm, about 0.03 mm to about 0.06 mm. In certain implementations, the wrapper can have a thickness of about 0.05 mm. The wrapper can be formed of a variety of suitable materials. In some implementations, the wrapper includes paper that is formed into a tubular configuration. The paper can have an overlap region that is attached together, e.g., by PVA glue. In certain implementations, the wrapper can have a basis weight from about 25 gsm to about 75 gsm or from about 30 gsm to about 50 gsm.

In some implementations, the wrapper 4822 can extend from the first cartridge end 4820x to the second cartridge end 4820y. The vaporizer cartridge 4820 can include a mouthpiece insert 4874 positioned proximate to the first cartridge end 4820x. In some implementations, the mouthpiece insert 4874, once inserted, can extend from the first cartridge end 4820x towards the second cartridge end 4820y. In other words, a first end 4874a of the mouthpiece insert 4874 can be flush with the first cartridge end 4820x, whereas in other implementations, the first end 4874a of the mouthpiece insert 4874 can be spaced a distance away from the first cartridge end 4820x.

The mouthpiece insert 4874 can have a variety of configurations. In some implementations, the mouthpiece insert 4874 can be formed of a vapor-permeable material (e.g., cellulose acetate) that is configured to allow the inhalable aerosol to pass therethrough. In some implementations, the mouthpiece insert can have a height in the range from about 5 mm to about 10 mm or from about 7 mm to about 9 mm. In one implementation, the mouthpiece insert can have a heigh of about 8 mm. In some implementations, the density of the mouthpiece insert 4874 can be at least about 150 g/100 rod or higher. In certain limitations, the density of the mouthpiece insert 4874 can be from about 150 g/100 rod to about 300 g/100 rod or from about 150 g/100 rod to about 200 g/100 rod. In one implementation, the density of the mouthpiece insert 4874 can be about 184 g/100 rod.

In some implementations, the mouthpiece insert 4874 can have one or more channels defined therein that can serve as an airflow path for the inhalable aerosol generated in the cartridge. For example, as shown in FIG. 12B, the mouthpiece insert 4874 can include an outlet channel 4875 through which the inhalable aerosol formed in the condensation chamber can exit and be inhaled by a user. While the outlet channel can have a variety of configurations, as shown in FIG. 12B, the outlet channel 4875 extends from a first end 4874a of the mouthpiece insert 4874 to a second end 4874b of the mouthpiece insert 4874. In other implementations, the mouthpiece insert can include two or more outlet channels.

In some implementations, the vaporizer cartridge 4820 can include a support structure 4830 configured to receive the mouthpiece insert 4874. In certain implementations, the support structure 4830 can have a height in a range from about 20 mm to about 30 mm or from about 22 mm to about 28 mm. In one implementation, the support structure 4830 can have a height of about 24 mm. In some implementations, the support structure 4830 can have a thickness from about 0.1 mm to about 1 mm, from about 0.1 mm to about 0.5 mm, or from about 0.2 mm to about 0.3 mm. The support structure can be formed of a variety of materials. In some implementations, the support structure includes paper that is formed into a tubular configuration. The paper can have an overlap region that is attached together, e.g., by PVA glue.

At least a portion of the support structure 4830 can define a condensation chamber 4832 that extends between the mouthpiece insert 4874 and the vaporizable material 4802 for a vapor generated from the vaporizable material 4802 to condense and form an inhalable aerosol. In instances where no mouthpiece insert or other element is resented within the support structure, the entire support structure can define condensation chamber. The support structure 4830 can have a variety of configurations. For example, as shown in FIG. 12C, the support structure 4830 has a tubular configuration. In other implementations, the support structure can have other suitable configurations and therefore the support structure is not limited to the structural configuration illustrated in the figures.

The vaporizable cartridge 4820 can include one or more bypass air inlets 4829 that are configured to allow ambient air to enter the cartridge. As shown, the one or more bypass air inlets 4829 extend through at least the wrapper 4822 to allow ambient air to pass through the one or more bypass air inlets 4829 and into the condensation chamber 4832. In other words, condensation chamber is in fluidic communication with ambient air through the one or more bypass air inlets. In some implementations, the one or more bypass air inlets 4829 can extend through both the wrapper 4822 and the support structure 4830. In some implementations, the vaporizer cartridge can include one bypass air inlet, whereas in other implementations, the vaporizer cartridge can include two or more bypass air inlets. For example, as shown in FIGS. 12A-12C, the vaporizer cartridge 4820 includes two sets of 5 bypass air inlets. A person skilled in the art will appreciate that the number and position of the one or more bypass air inlets can be changed to effect desired airflow characteristics (e.g., the amount of air, air flow speed, and the like) into the condensation chamber to thereby tailor the condensation environment to generate an inhalable aerosol.

In some implementations, the vaporizer cartridge 4820 can include an insert 4864 positioned proximate to the second cartridge end 4820y. In some implementations, the insert 4864, once inserted, can extend from the second cartridge end 4820y towards the first cartridge end 4820y. In other words, a first end 4864a of the insert 4864 can be flush with the second cartridge end 4820y, whereas in other implementations, the first end 4864a of the insert 4874 can be spaced a distance away from the second cartridge end 4820y.

The insert 4864 can include one or more air inlets (not shown) that allow ambient air to enter a heater chamber 4880 defined by the heating element 4842. In some implementations, the insert 4864 can be formed of a vapor-permeable material (e.g., cellulose acetate) that is configured to allow ambient air to pass therethrough. In some implementations, the insert can have a height in the range from about 5 mm to about 10 mm or from about 7 mm to about 10 mm. In one implementation, the insert can have a height of about 8 mm. In some implementations, the density of the insert 4864 can be from about 100 g/100 rod to about 200 g/100 rod or from about 150 g/100 rod to about 200 g/100 rod. In one implementation, the density of the insert 4864 can be about 150 g/100 rod to about 184 g/100 rod. In some implementations, the insert 4864 can have one or more channels (not shown) that can serve as one or more airflow paths for ambient air to pass into the cartridge, and consequently into at least the heating chamber 4880.

In some implementations, the vaporizer cartridge 4820 can include a heating element 4842 configured to heat the vaporizable material 4802. The heating element 4842 can be disposed within the wrapper (e.g., the wrapper can be wrapped about the heating element or inserted into a preformed wrapper during manufacturing of the vaporizer cartridge.) Depending on the configuration of the heating element, the two opposing sides can be longitudinal sides or lateral sides. In the illustrated implementation shown in FIGS. 12A-12D, the two opposing sides of the heating element 4842 are longitudinal sides (e.g., extending along a y-axis).

In some implementations, the heating element 4842 can include an infrared reflective material configured to heat the vaporizable material and reflect heat towards the vaporizable material to generate a vapor. In some implementations, the heating element 4842 can include one or more metals, such as aluminum, an aluminum alloy, copper, brass, zirconium, stainless steel (ferritic or non-ferritic), nickel, the like, or any combination thereof.

As described herein, aluminum is beneficial for spreading heat and stainless steel is better for localized heat. For an inductive heating approach, use of a non-magnetic material, such as aluminum, allows the creation of eddy currents in the heating element, while a magnetic material, such as ferritic stainless steel, is inductively heated by a hysteresis mechanism.

Different inductor coil arrangements are generally needed for these two heating approaches, which can have different requirements such as an amount of power required to generate an electromagnetic field. However, in some implementations, the heating element 4842 is non-ferritic and non-magnetically permeable, which can simplify the design of the vaporizer cartridge 4820 and allow for tighter control in heating of the heating element 4842. In some implementations, the vaporizer cartridge 4820 can be configured to couple to a vaporizer body which includes inductor. The at least one inductor can be configured to generate a magnetic and/or electromagnetic field to heat the heating element 4842 such that heat is conducting from the heating element to the vaporizable material 4802 to thereby heat the vaporizable material 4802 to generate vapor.

The at least one inductor described herein can be driven at a variety of frequencies. For example, in some aspects, one or more inductors of a vaporizer device can be driven at a frequency less than 1 megahertz (MHz) (e.g., at a low frequency). In such instances, the frequency can be in a range of 100 kilohertz (kHz) to 600 kilohertz (kHz), 200 kHz to 600 kHz, 200 kHz to 500 kHz, 200 kHz to 400 kHz, or 200 kHz to 300 kHz. By contrast, in other aspects, the one or more inductors of a vaporizer device can be driven at a frequency that is equal to or greater than 1 megahertz (MHz) (e.g., at a high frequency). In such instances, the frequency can be in a range of 1 MHz to 50 MHz or 1 MHz to 30 MHz.

In some implementations, the heating element 4842 includes a first sheet. For example, the heating element 4842 can be in the form of a foil sheet (e.g., 1000 or 8000 series aluminum sheet). The heating element 4842, and thus the sheet, can have a thickness in the range from about 10 μm to about 35 μm, or from about 10 μm to about 35 μm, or from about 12 μm to about 20 μm. In certain implementations, the heating element 4842 can also include one or more additional sheets (e.g., such as a paper). In such implementations, the first sheet of the heating element 4842 can be positioned adjacent or disposed on at least a portion of a surface of the first sheet of the heating element 4842.

In some implementations, the heating element 4842 can define at least a portion of a perimeter of the heater chamber 4880 for containing the vaporizable material 4802. In some implementations, during manufacturing of the vaporizer cartridge 4820 the heating element 4842 can be wrapped around the vaporizable material 4802 or the vaporizable material 4802 can be inserted into the heater chamber 4880 of a partially formed or completely formed heating element.

While the heating element 4842 can have a variety of configurations, the heating element 4842, as shown in greater detail in FIG. 12D, can include a first region 4844, a second region 4845, and a third region 4849, in which the second region 4845 is spaced apart from the first region 4844 by the third region 4849. The first region 4844, the second region 4845, the third region 4849, or any combination thereof, can each extend around at least a portion of the perimeter of the vaporizable material 4802.

In this illustrated implementation, the first region 4844, the second region 4845, the third region 4849 each extend around the entire perimeter of the vaporizable material. As a result, the first region 4844, the second region 4845, and the third region 4949 each form a continuous loop to create an electrically conductive path around the heating element 4842. Each of the first region 4844, the second region 4845, the third region 4849 can form a continuous loop extending in a lateral direction, perpendicular to a longitudinal axis L (see FIG. 12A) of the vaporizer cartridge 4820. In some implementations, the third region 4849 can include perforations 4882 such that current flows through the heating element 1542 in an identifiable manner. In other words, the perforations 4882 can enable the current passing within the first region of the heating element to remain (at least primarily) within the first region and the current passing within the second region of the heating element to remain (at least primarily) within the second region. The number and pattern of the perforations 4882 can vary and therefore are not limited to what is illustrated in the figures.

### Terminology

It will be appreciated that the terms “proximal” and “distal” are used herein to refer to relative locations of the referenced devices and/or components. Although “proximal” is generally used to refer to a location that is at or near a user when the device and/or component is in use, and “distal” is generally used to refer to a location that is away from a user when the device and/or component is in use, these terms are not intended to be absolute. For example, a “proximal” end and/or a “distal” end of a component need not be the absolute furthest points on the referenced ends, and can instead refer to a general region at or near the referenced end. Further, opposing “proximal” ends and “distal” ends of a component need not be completely and/or perfectly opposite each other, as the shapes of each end can differ and/or the component may not be perfectly linear (e.g., one or more longitudinal dimensions of the component can be of different lengths).

When a feature or element is herein referred to as being “on” another feature or element, it can be directly on the other feature or element or intervening features and/or elements can also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements can be present. In contrast, when a feature or element is referred to as being “directly connected”, “directly attached” or “directly coupled” to another feature or element, there are no intervening features or elements present.

Although described or shown with respect to one implementation, the features and elements so described or shown can apply to other implementations. It will also be appreciated by those of skill in the art that references to a structure or feature that is disposed “adjacent” another feature can have portions that overlap or underlie the adjacent feature.

Terminology used herein is for the purpose of describing particular implementations and implementations only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and can be abbreviated as “/”.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device can be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” can be used herein to describe various features/elements (including steps), these features/elements should not be limited by these terms, unless the context indicates otherwise. These terms can be used to distinguish one feature/element from another feature/element. Thus, a first feature/element discussed below could be termed a second feature/element, and similarly, a second feature/element discussed below could be termed a first feature/element without departing from the teachings provided herein.

As used herein in the specification and claims, including as used in the examples and unless otherwise expressly specified, all numbers can be read as if prefaced by the word “about” or “approximately,” even if the term does not expressly appear. The phrase “about” or “approximately” can be used when describing magnitude and/or position to indicate that the value and/or position described is within a reasonable expected range of values and/or positions. For example, a numeric value can have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative implementations are described above, any of a number of changes can be made to various implementations without departing from the teachings herein. For example, the order in which various described method steps are performed can often be changed in alternative implementations, and in other alternative implementations one or more method steps can be skipped altogether. Optional features of various device and system implementations can be included in some implementations and not in others. Therefore, the foregoing description is provided primarily for exemplary purposes and should not be interpreted to limit the scope of the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The examples and illustrations included herein show, by way of illustration and not of limitation, specific implementations in which the subject matter can be practiced. As mentioned, other implementations can be utilized and derived there from, such that structural and logical substitutions and changes can be made without departing from the scope of this disclosure. Such implementations of the inventive subject matter can be referred to herein individually or collectively by the term “invention” merely for convenience and without intending to voluntarily limit the scope of this application to any single invention or inventive concept, if more than one is, in fact, disclosed. Thus, although specific implementations have been illustrated and described herein, any arrangement calculated to achieve the same purpose can be substituted for the specific implementations shown. This disclosure is intended to cover any and all adaptations or variations of various implementations. Combinations of the above implementations, and other implementations not specifically described herein, will be apparent to those of skill in the art upon reviewing the above description.

1. A heating element comprising:
a substrate configured to heat a vaporizable material, the substrate comprising:
a first region;
a second region; and
a third region disposed between the first region and the second region, wherein the third region comprises a first plurality of break structures configured to direct a thermal path, an electric current path, or both across the third region in a predetermined direction.

2. The heating element of claim 1, wherein the first plurality of break structures comprises one or more cuts.

3. The heating element of claim 2, wherein at least one cut of the one or more cuts extends completely through the substrate.

4. The heating element of claim 2, wherein at least one cut of the one or more cuts extends partially through the substrate.

5-21. (canceled)

22. The heating element of claim 1, further comprising a second plurality of break structures, wherein each of the second plurality of break structures at least partially extends between the first longitudinal end and the second longitudinal end of the substrate.

23. The heating element of claim 22, wherein the first plurality of break structures is different than the second plurality of break structures.

24. The heating element of claim 22, wherein the first region comprises the second plurality of break structures.

25. The heating element of claims 22, wherein the third region comprises the first plurality of break structures and the second plurality of break structures.

26. The heating element of claim 22, wherein the second plurality of break structures comprises cuts aligned with each other relative to a longitudinal axis of the substrate, the longitudinal axis extending from a first lateral end to a second lateral end of the substrate.

27-28. (canceled)

29. The heating element of claim 22, further comprising a channel between the first plurality of break structures and the second plurality of break structures.

30. The heating element of claim 1, further comprising a third plurality of break structures, wherein each of the third plurality of break structures at least partially extends between the first longitudinal end and the second longitudinal end of the substrate.

31. The heating element of claim 30, wherein the second region comprises the third plurality of break structures.

32. The heating element of claim 1, wherein the substrate is configured to generate heat via eddy currents.

33. The heating element of claim 1, wherein the substrate comprises one or more metals.

34-35. (canceled)

36. The heating element of claim 1, wherein a first portion of the heating element proximate the first longitudinal end of the heating element at least partially overlaps with a second portion of the heating element proximate the second longitudinal end of the heating element.

37-42. (canceled)

43. A cartridge for use with a vaporizer device for generating an inhalable aerosol, the cartridge comprising:
the heating element of claim 1;
a wrapper holding a vaporizable material disposed therein, the wrapper comprising an inner surface facing the vaporizable material and an outer surface;
at least one airflow inlet configured to allow external air to enter the wrapper and entrain the vapor; and
at least one airflow outlet in fluid communication with the at least one airflow inlet and configured to allow egress of aerosol from the wrapper for inhalation by a user.

44-45. (canceled)

46. The cartridge of claim 43, further comprising a vaporizable material contained within the heating element, and wherein the heating element is disposed between the inner surface of the wrapper and the vaporizable material.

47-54. (canceled)

55. A vaporizer device for generating an inhalable aerosol, the vaporizer device comprising:
the cartridge of claim 43; and
a vaporizer body configured to receive at least a portion of the cartridge, the vaporizer body comprising a heater configured to heat the heating element.

56. The vaporizer device of claim 55, wherein the heating element comprises at least one inductor configured to generate a magnetic and/or electromagnetic field.

57-61. (canceled)

62. A method for creating a heating element for use in a vaporizer device, the method comprising:
cutting a substrate across a central region between a first longitudinal end and a second longitudinal end to create a plurality of break structures, wherein the plurality of break structures is configured to direct a thermal path, an electric current path, or both across the central region in a predetermined direction; and
attaching the first longitudinal end to the second longitudinal end to create the heating element.

63-68. (canceled)
